(19) United States
(12) Patent Application Publication
(10) Pub. No.: US 2025/0338136 A1
(43) Pub. Date: Oct. 30, 2025

(54) SYSTEMS, METHODS, AND APPARATUSES FOR NETWORK MANAGEMENT

(71) Applicant: Comcast Cable Communications, LLC, Philadelphia, PA (US)

(72) Inventors: Suresh Parathi, Philadelphia, PA (US); Arun Ravisankar, Philadelphia, PA (US); Dinesh Devotta, Philadelphia, PA (US)

(21) Appl. No.: 18/649,138

(22) Filed: Apr. 29, 2024

(51) Int. Cl. H04W 16/14; H04W 28/18; H04W 84/12

(52) U.S. Cl. CPC H04W 16/14; H04W 28/18; H04W 84/12

(57) ABSTRACT

Methods, systems, and apparatuses are provided for managing network devices. For example, network communications may be evaluated to determine if a BSS color collision is detected with regard to one or more network devices. A determination may be made as to whether the one or more of the network devices make modifications to one or more network settings to alleviate the BSS color collision.

### BACKGROUND

With the rapid increase in the number of Institute of Electrical and Electronics Engineers (IEEE) 802.11 devices (e.g., user devices, client stations (STAs)) and/or access points (APs)) being added to wireless local area network (WLAN) based networks, dense WLAN deployments have become commonplace. Such dense WLAN deployments face significant performance issues due to factors including, for example, interference, congestion, low throughput, etc.

For example, high levels of interference brought about by large numbers of users threatens to degrade the levels of network performance that users have come to expect. The IEEE 802.11 networks have continued to evolve in an attempt to address these challenges. These challenges have been addressed to some extent by introducing Dynamic Sensitivity Control (DSC) and Basic Service Sets (BSS) color schemes in IEEE 802.11ax and IEEE 802.11ah implementations, respectively. These schemes are intended to improve network throughput and spectrum efficiency in dense environments.

Particularly, BSS Coloring was introduced in 802.11ah to increase the network capacity in dense environments by improving the ability to reuse frequencies. BSS color may be used to differentiate between intra-BSS frames and Overlapping BSS (OBSS) frames, and to determine which Clear Channel Assessment (CCA) threshold to use while accessing the shared channel resource in the same frequency range.

However, such techniques reuse frequencies within the same communication channel. No WLAN features exist that utilize BSS color to resolve interference via alternate communication channels, adjusted transmit power levels, and/or selective Spatial Reuse (SR) transmissions.

### SUMMARY

It is to be understood that both the following general description and the following detailed description are exemplary and explanatory only and are not restrictive, as claimed. Methods, systems, and apparatuses for managing network devices are disclosed. For example, one or more network devices and/or the devices operating within those networks may evaluate communications to determine if a Basic Service Set (BSS) color collision has occurred between two or more network devices. An evaluation may determine if a network device of the one or more network devices should change the BSS color identifier associated with the particular network device of the one or more network devices in an effort to reduce or eliminate the BSS color collision.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, serve to explain the principles of the apparatuses, methods, and systems described herein:

FIG. 1 shows an example system;

FIG. 2 shows an example packet header;

FIG. 3 shows an example system;

FIG. 4 shows an example method;

FIG. 5 shows an example system;

FIG. 6 shows an example method;

FIG. 7 shows an example method;

FIG. 8 shows an example method;

FIG. 9 shows an example method;

FIG. 10 shows an example method;

FIG. 11 shows an example method;

FIG. 12 shows an example method;

FIG. 13 shows an example method; and

FIG. 14 shows an example system.

### DETAILED DESCRIPTION

Before the present methods and systems are described, it is to be understood that the methods and systems are not limited to specific methods, specific components, or to particular implementations. It is also to be understood that the terminology used herein is for the purpose of describing particular examples only and is not intended to be limiting.

As used in the specification and the appended claims, the singular forms “a,” “an,” and “the” include plural referents unless the context clearly dictates otherwise.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment and/or example. “Such as” is not used in a restrictive sense, but for explanatory purposes.

Described are components that can be used to perform the described methods and systems. These and other components are described herein, and it is understood that when combinations, subsets, interactions, groups, etc. of these components are described that while specific reference of each various individual and collective combinations and permutation of these may not be explicitly described, each is specifically contemplated and described herein, for all methods and systems. This applies to all aspects of this application including, but not limited to, steps in the described methods. Thus, if there are a variety of additional steps that can be performed it is understood that each of these additional steps can be performed with any specific example or combination of examples of the described methods.

The present methods and systems may be understood more readily by reference to the following detailed description and the examples included therein and to the Figures and their previous and following description. As will be appreciated by one skilled in the art, the methods and systems may take the form of an entirely hardware embodiment and/or an entirely software embodiment and/or an embodiment combining software and hardware aspects. Furthermore, the methods and systems may take the form of a computer program product on a computer-readable storage medium (e.g., non-transitory) having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, flash memory internal or removable storage devices, or magnetic storage devices.

Examples of the apparatuses, methods, and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory (e.g., non-transitory) that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions, and program instruction means for performing the specified functions. It will also be understood that each block of the block diagrams and flowchart illustrations, and combinations of blocks in the block diagrams and flowchart illustrations, can be implemented by special purpose, hardware-based computer systems that perform the specified functions or steps, or combinations of special purpose hardware and computer instructions.

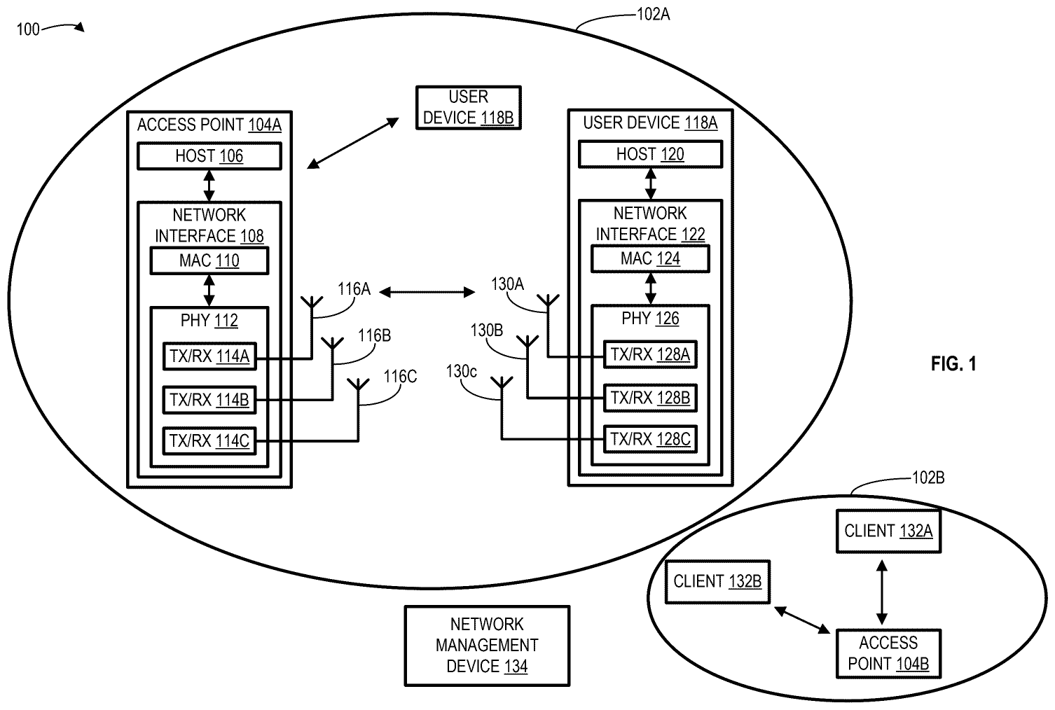

FIG. 1 is a block diagram of an example communication system 100 that may include, for example, multiple wireless local area networks (WLANs) 102A-B. A first WLAN 102A may include a first network device, (e.g., an access point (AP) 104A) that comprises a host processor 106 coupled to a network interface 108. The network interface 108 may include a medium access control layer (MAC) processor 110 and a physical layer (PHY) processor 112. The PHY processor 112 may include one or more transceivers, such as a plurality of transceivers 114A-C. The transceivers 114A-C may be coupled to a plurality of antennas 116A-C. Although three transceivers 114A-C and three antennas 116A-C are illustrated in FIG. 1, this is for example purposes only as the AP 104A may include other suitable numbers (e.g., 1, 2, 4, 5, etc.) of transceivers 114A-C and antennas 116A-C in other examples. For example, the AP 104A may include a higher number of antennas 116A-C than transceivers 114A-C, and antenna switching techniques may be utilized.

The network interface 108 may be implemented using one or more integrated circuits (ICs) configured to operate as discussed below. For example, the MAC processor 110 may be implemented, at least partially, on a first IC, and the PHY processor 112 may be implemented, at least partially, on a second IC. As another example, at least a portion of the MAC processor 110 and at least a portion of the PHY processor 112 may be implemented on a single IC. For instance, the network interface 108 may be implemented using a system on a chip (SoC), where the SoC includes at least a portion of the MAC processor 110 and at least a portion of the PHY processor 112.

For example, the MAC processor 110 and/or the PHY processor 112 of the first network device (e.g., the AP 104A) may be configured to generate data units, and process received data units, that conform to a WLAN communication protocol such as a communication protocol conforming to the IEEE 802.11 Standard or another suitable wireless communication protocol. For example, the MAC processor 110 may be configured to implement MAC layer functions, including MAC layer functions of the WLAN communication protocol, and the PHY processor 112 may be configured to implement PHY functions, including PHY functions of the WLAN communication protocol. For instance, the MAC processor 110 may be configured to generate MAC data units, such as MAC service data units (MSDUs), MAC protocol data units (MPDUs), etc., and provide the MAC data units to the PHY processor 112. The PHY processor 112 may be configured to receive MAC data units from the MAC processor 110 and encapsulate the MAC data units to generate PHY data units such as PHY protocol data units (PPDUs) for transmission via the antennas 116A-C. Similarly, the PHY processor 112 may be configured to receive PHY data units that were received via the antennas 116A-C, and extract MAC data units encapsulated within the PHY data units. The PHY processor 112 may provide the extracted MAC data units to the MAC processor 110, which processes the MAC data units.

The first WLAN 102A may include one or more user device, such as user devices 118A-B. Although two user devices 118A-B are illustrated in FIG. 1, the first WLAN 102A may include other suitable numbers (e.g., 1, 3, 4, 5, 6, etc.) of user devices 118A-B in other examples. The user devices 118A-B may be any suitable communication device operable to compute, classify, process, transmit, receive, retrieve, originate, switch, store, display, manifest, detect, record, reproduce, handle, or utilize any form of information, intelligence, or data for business, scientific, control, entertainment, or other purposes. For example, a user device 118A-B may be a personal computer, a PDA, a smartphone, a laptop computer, a tablet computer, a smart watch, a wearable smart device, a consumer electronic device, a storage device, or any other suitable device and may vary in size, shape, performance, and functionality. The user device 118A-B may include memory, one or more processing resources, such as a central processing unit (CPU), or hardware or software control logic. Additional components of the user device 118A-B may include one or more storage devices, one or more communications ports for communicating with external devices, as well as various other I/O devices, such as a keyboard, a mouse, and a video display. The user device 118A-B may also include one or more busses operable to transmit communications between the various hardware components. The user device 118A-B may include a set of instructions that may be executed to cause the user device 118 to perform any one or more of the methods or computer-based functions disclosed herein.

The user device 118A may comprise a host processor 120 coupled to a network interface 122. The network interface 122 may comprise a MAC processor 124 and a PHY processor 126. The PHY processor 126 may comprise one or more transceivers 128A-C. The one or more transceivers 128A-C may be coupled to one or more antennas 130A-C.

Although three transceivers 128A-C and three antennas 130A-C are illustrated in FIG. 1, this is for example purposes only as the user device 118A may include other suitable numbers (e.g., 1, 2, 4, 5, etc.) of transceivers 128A-C and/or antennas 130A-C in other examples. For example, the user device 118A may include a higher number of antennas 130A-C than transceivers 128A-C, and antenna switching techniques may be utilized.

The network interface 122 may be implemented using one or more ICs configured to operate as discussed below. For example, the MAC processor 124 may be implemented on at least a first IC, and the PHY processor 126 may be implemented on at least a second IC. As another example, at least a portion of the MAC processor 124 and at least a portion of the PHY processor 126 may be implemented on a single IC. For instance, the network interface 122 may be implemented using a system on a chip (SoC), where the SoC includes at least a portion of the MAC processor 124 and at least a portion of the PHY processor 126.

For example, the MAC processor 124 and the PHY processor 126 of the user device 118A may be configured to generate data units, and process received data units, that conform to the WLAN communications protocol or another suitable communications protocol. For example, the MAC processor 124 may be configured to implement MAC functions, including MAC functions of the WLAN communications protocol, and the PHY processor 126 may be configured to implement PHY functions, including PHY functions of the WLAN communications protocol. The MAC processor 124 may be configured to generate MAC data units, such as MSDUs, MPDUs, etc., and provide the MAC data units to the PHY processor 126. The PHY processor 126 may be configured to receive MAC layer data units from the MAC processor 124 and encapsulate the MAC data units to generate PHY data units such as PPDUs for transmission via one or more of the antennas 130A-C. Similarly, the PHY processor 126 may be configured to receive PHY data units that were received via one or more of the antennas 130A-C, and extract MAC data units encapsulated within the PHY data units. The PHY processor 126 may provide the extracted MAC data units to the MAC processor 124, which processes the MAC data units.

For example, the user device 118B may include a structure that is the same as or similar to the user device 118A. The user device 118B structured the same as or similar to the user device 118A may include the same or a different number of transceivers and antennas. For example, the user device 118B may only have two transceivers and two antennas.

The system 100 may also include a second WLAN 102B. The second WLAN 102B may include an AP 104B and one or more user devices 132A-B. For example, the AP 104B may have a structure that is the same as or similar to the AP 104A. The AP 104B, structured the same as or similar to the AP 104A, may have the same or a different number of transceivers and antennas. For example, the AP 104B may only have two transceivers and two antennas.

For example, the one or more user devices 132A-B may each have a respective structure that is the same as or similar to the user device 118A. Each of the one or more user devices 132A-B, structured the same as or similar to the user device 118A, may have the same or a different number of transceivers and antennas. For example, the user device 132A may only have two transceivers and two antennas. Although two user devices 132A-B are illustrated in FIG. 1, the second WLAN 102B may include other suitable numbers (e.g., 1, 3, 4, 5, 6, etc.) of user devices 132A-B in various examples.

Wireless networks such as the WLANs 102A-B may be referred to as basic service sets (BSSs). When one or more transmissions from one BSS are received by devices in another BSS, and vice-versa, the BSSs may be referred to as overlapping BSSs (OBSSs). For example, in one scenario, the second WLAN 102B may be an OBSS with respect to the first WLAN 102A, and vice-versa.

For example, the APs 104 and the user devices 118A-B/132A-B may contend for a communication medium using carrier sense multiple access with a collision avoidance (CSMA/CA) protocol or another suitable medium access protocol. The 802.11 Wi-Fi standard minimizes the chance of multiple devices interfering with one-another by transmitting at the same time. CSMA/CA protocols are based on static thresholds that allow Wi-Fi devices to avoid interfering with each other on air. However, with an increase in the density and the number of Wi-Fi devices, these static thresholds often lead to CSMA/CA causing devices to defer transmissions unnecessarily.

Conventional client stations must demodulate packets to examine the MAC header in order to determine whether or not a received packet belongs to their own BSS. This process of demodulation consumes power, which can be saved if devices can quickly identify the BSS by looking at the PHY header alone, and subsequently drop packets that are from a different BSS.

The 802.11ax (Wi-Fi 6) standard addresses the issues discussed above, through the BSS Coloring mechanism. BSS Coloring is a provision that allows devices operating in the same frequency space to quickly distinguish between packets from their own BSS and packets from an OBSS, by looking at the BSS color identifier contained in the PHY header. For example, 64 unique BSS color identifiers may be provided. In other examples, the number of unique BSS color identifiers may be greater or less than 64. By associating each WLAN or AP with a different BSS color identifier when an OBSS occurs, APs and user devices may more quickly determine or identify communications within their particular WLAN and that information can be leveraged to increase power savings by dropping packets earlier.

In order for a communication device (e.g., client stations 118A-B and/or AP 104) that is compliant with a communication protocol (e.g., the IEEE 802.11ax protocol, or another suitable wireless communication protocol) to determine whether a given transmission corresponds to a same-BSS or to an OBSS, the device may obtain a BSS color identifier from a PHY header (e.g., within a high efficiency signal field A (HE-SIGA)) in the transmission, and may compare the BSS color identifier in the PHY header to a BSS color identifier of the BSS to which the device (e.g., client stations 118A-B and/or AP 104) belongs.

The BSS color identifier may comprise a numerical identifier of the BSS (e.g., a BSS color may be an identifier of a wireless network or AP, such as the first WLAN 102A or the second WLAN 102B or the AP 104A or the AP 104B). 802.11ax radios may be configured to differentiate between BSSs using BSS color identifiers when other radios transmit on the same channel. If the BSS color identifier is the same, this is considered to be an intra-BSS frame transmission because the transmitting radio is believed to belong to the same BSS as the receiver. If the detected frame has a different BSS color identifier from its own, then the user device considers that frame as an inter-BSS frame from an overlapping BSS (e.g., the second WLAN 102B with respect to the first WLAN 102A or the AP 104B with respect to the AP 104A). One or more APs may be configured to select a BSS color identifier. For example, AP 104A may select a BSS color identifier (e.g., for the first WLAN 102A) and communicate the chosen BSS color identifier to the user devices 118A-B within the first WLAN 102A (e.g., via beacon frames, control frames, etc.).

For example, each AP 104A-B may be configured to select and assign a BSS color identifier for that particular AP 104A-B or network 102A-B. For example, a network management device 134 may be configured to select and/or assign BSS color identifiers to each of the one or more APs 104A-B. For example, each AP 104A-B may be configured to select and/or assign channels used for communication at that particular AP 104A-B with the user devices (e.g., user devices 118A-B, 132A-B). For example, the network management device 134 may be configured to select and/or assign channels to the one or more APs 104A-B for communications with user devices (e.g., user devices 118A-B, 132A-B). For example, the network management device 134 may be implemented as an instance of an access point (e.g., APs 104A-B). For example, the network management device 134 may be a network device, such as a network server or other suitable computing device.

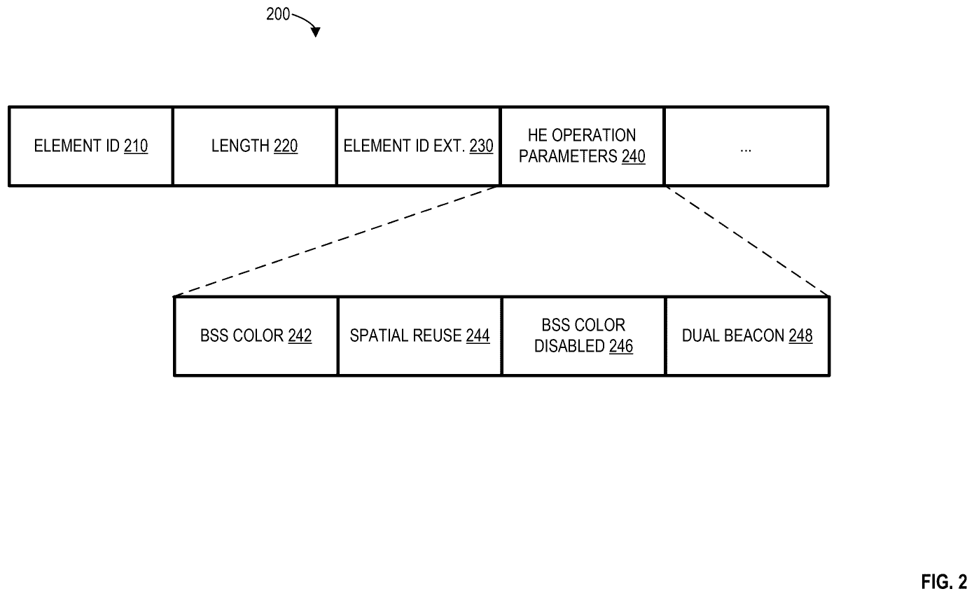

BSS color identifier may be communicated at both the PHY layer and the MAC sublayer. For example, in the preamble of an 802.11ax PHY header, the SIG-A field contains a 6-bit BSS color field. As shown in FIG. 2, the BSS color identifier may be present in 802.11 management frames. The HE operation information element contains a subfield of BSS color information. Six bits can be used to identify as many as 64 different colors and represent 64 different BSSs.

In accordance with the 802.11ax (Wi-Fi 6) standard described above, a communication device (e.g., user device 118A-B and/or 132A-B) may detect or receive packets from or associated with both the WLAN 102A and the WLAN 102B (e.g., an OBSS of WLANs 102A-B). The communication device (e.g., user device 118A-B and/or 132A-B) may determine from the PHY header the BSS color identifier associated with the WLAN 102A and the AP 104A and a second BSS color identifier associated with the WLAN 102B and the AP 104B. The communication device (e.g., user device 118A-B and/or 132A-B) may determine that both the BSS color identifier and the second BSS color identifier are the same. This may be known as a BSS color collision.

In response to determining the BSS color collision, the communication device (e.g., user device 118A-B and/or 132A-B) may inform their respective APs (e.g., APs 104A-B) of the BSS color collision. For example, the communication device may send a message to its associated AP indicating the BSS color collision. For example, the message may be or comprise an autonomous report that is sent by the communication device to its associated AP indicating the BSS color collision. For example, the autonomous report may comprise BSS color identifiers for all OBSS's (e.g., networks/network coverage areas) from which the communication device is able to detect frames in order to assist or help the associated AP to determine a new BSS color identifier when the AP determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other OBSS's that the communication device is able to detect, for example through communication with another communication device (e.g., user device 118A-B and/or 132A-B).

In accordance with the 802.11ax (Wi-Fi 6) standard, when the APs (e.g., APs 104A-B) having the same BSS color identifier are informed of the BSS color collision, each AP (e.g., APs 104A-B) will change their respective BSS color identifier from the current BSS color identifier to a new BSS color identifier in an effort to achieve the result of the OBSS APs having different BSS color identifiers after the change. However, having both APs (or in situations where 3 or more APs have the same BSS color identifier, having all APs) that share the same BSS color identifier change to a new BSS color identifier can waste unnecessary time and energy resources, as not all of the APs need to change their BSS color identifier for the APs of the OBSS to have different BSS color identifiers.

FIG. 2 shows an example HE Operation element 200 that may be provided in beacon (or other management) frames transmitted by the APs 104A-B. The HE Operation element 200 may include an “Element ID” field 210, a “Length” field 220, an “Element ID Extension” field 230, an “HE Operation Parameters” field 240, and one or more additional fields for optional sub-elements (not shown for simplicity). The Element ID field 210 may store 1 byte of information identifying the element 200 as an HE Operation element. The Length field 220 may store 1 byte of information indicating the length of the HE Operation element 200. The Element ID Extension field 230 may store an additional byte of information as an extension to the Element ID field 210. The HE Operation Parameters field 240 may store up to 4 bytes of information indicating one or more HE operations or parameters supported by the AP or BSS associated with the HE Operation element 200.

The HE Operation Parameters field 240 may include a “BSS Color” subfield 242, “Spatial Reuse” subfield 244, a “BSS Color Disabled” subfield 246, and a “Dual Beacon” subfield 248. The BSS Color subfield 242 may store up to 6 bits of information indicating a BSS color identifier associated with the AP (e.g., APs 104A-B) or BSS. For example, the BSS color identifier may be used to differentiate communications intended for a particular BSS from communications intended for an overlapping BSS or any other BSSs in the vicinity. The Spatial Reuse subfield 244 may indicate whether an AP and/or a client station supports spatial reuse transmissions. If an AP and/or client stations supports spatial reuse transmissions, the field may also indicate the limit on the transmission power to be used during the spatial reuse transmission opportunities that can potentially be detected. The BSS Color Disabled subfield 246 may store 1 bit of data indicating whether a BSS color check procedure should be disabled (or enabled) for the corresponding AP or BSS. The Dual Beacon subfield 248 may store at least 1 bit of data indicating whether the originating AP transmits beacon frames in multiple PHY formats.

The network management device 134, and/or one or more APs (e.g., AP 104A and/or AP 104B) may be configured to determine a channel for use by the one or more APs based at least in part on BSS color identifier.

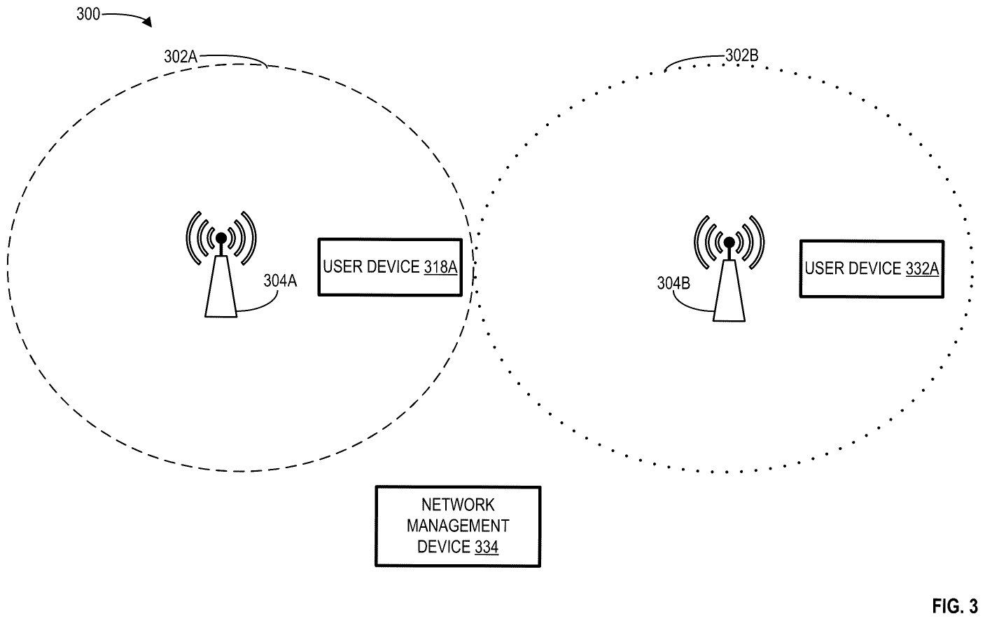

FIG. 3 shows an example system 300 having a first access point 304A, a second access point 304B, a user device 318A, and a user device 332A. While only two access points and two user devices are shown in FIG. 3, this is for example purposes only. In other examples, the system 300 may include other suitable numbers of access points and other suitable numbers of user devices. For example, the first access point 304A and the second access point 304B may be implemented as instances of the access points 104A and/or 104B described above with reference to FIG. 1. For example, the user devices 318A, and 332A may be implemented as an instance of the respective user devices 118A, and 132A described above with reference to FIG. 1. The first access point 304A and the second access point 304B may communicate with a user device by transmitting/sending and/or receiving data units and/or frames, for example, orthogonal frequency division multiplexing (OFDM) data units. For example, the OFDM data units may include an MPDU having a reduced header length using a BSS color identifier or other suitable non-unique identifier for the corresponding access point. For example, the data units may include scheduling frames for uplink orthogonal frequency division multiple access (OFDMA). For example, the data units may include the BSS color identifier of the particular access point 304A-B in a PHY field, for example, the BSS color field 242 of the frame, as shown in FIG. 2.

The first access point 304A and the second access point 304B may provide wireless network coverage (e.g., WLAN service coverage) area 302A and coverage area 302B, respectively. The network coverage area 302A and the network coverage area 302B may each represent respective physical regions within which a user device may receive and decode transmissions from the corresponding access point, for example, broadcast management frames or downlink data frames provided by the access point. For example, as shown in FIG. 3, the wireless network coverage area 302A does not overlap with the wireless network coverage area 302B. The user device 318A is associated with the wireless network coverage area 302A provided by the first access point 304A. The user device 332A is associated with the wireless network coverage area 302B provided by the second access point 304B.

As shown in FIG. 3, the user device 318A may receive communications (e.g., a data unit) from and/or send communications to only the AP 304A. The user device 332A, positioned at a first location, may receive communications (e.g., a data unit) from and/or send communications to only the AP 304B. Either one or both of the user devices 318A, 332A may be mobile user devices, such that they can be moved from a location to another location. For example, both the location and the another location may be within communication range for the same wireless network (e.g., networks 302A-B respectively). For example, the location may be within communication range of a first wireless network (e.g., network 302B) and the another location may be within communication range of a second wireless network (e.g., network 302A) but not the first wireless network. For example, the location may be within communication range of the first wireless network and the another location may be within communication range of both the first wireless network and the second wireless network. For example, the location may be within communication range of both the first wireless network and the second wireless network and the another location may be in communication range of the second wireless network but not the first wireless network.

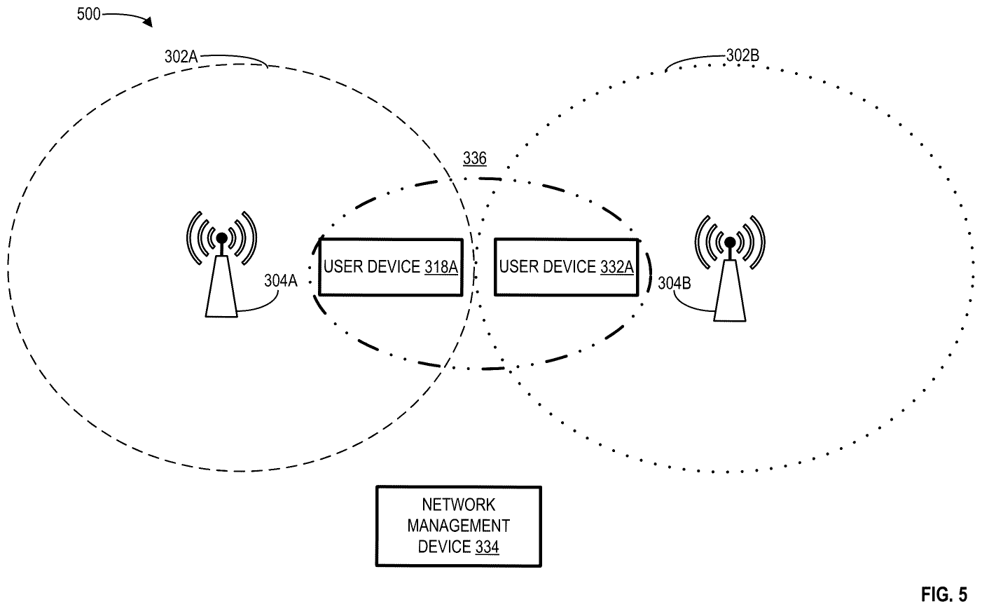

For example, as shown in FIG. 3, the user device 318A may not be able to detect or receive communications from user device 332A and the user device 332A is not able to detect or receive communications from the user device 318A. For example, in certain examples where the user devices 318A, 332A are close enough to one-another (see FIG. 5) the user devices 318A, 332A may receive or detect communications that are transmitted by the other user device 318A, 332A even if those communications are not intended for the particular user device 318A, 332A. For example, when the user devices 318A, 332A are close enough to one-another and based on the received or detected communications from one user device 318A by the other user device 332A (or vice-versa), the user device 332A may determine the BSS color identifier for the access point 304A and/or wireless network 302A. Similarly, when the user devices 318A, 332A are close enough to one-another and based on the received or detected communications from one user device 332A by the other user device 318A (or vice-versa), the user device 318A may determine the BSS color identifier for the access point 304B and/or wireless network 302B. As such, the user device 318A may determine the BSS color identifier for the access point 304B and/or wireless network 302B even when the user device 318A is not within the communication range of the wireless network 302B. Similarly, the user device 332A may determine the BSS color identifier for the access point 304A and/or wireless network 302A even when the user device 332A is not within the communication range of the wireless network 302A. For example, the user devices 318A, 332A may be configured for determining the BSS color identifiers of incoming communications (e.g., data units) that indicate the transmitter of the data unit, and may report the determined BSS color identifier to their respective APs and/or to a network management device 334.

For example, the system 300 may comprise the network management device 334. For example, the network management device 334 may be implemented as an instance of one or more of the access points 104A and/or 104B or the network management device 134 described above with reference to FIG. 1. The network management device 334, when present in the system 300, may manage the allocation of channels and/or BSS color identifiers to access points within the system 300. For example, the first access point 304A may send an indication of amount of BSS color identifiers detected to the network management device 334. The network management device 334 may be configured to determine a value for the BSS color identifier for the first access point 304A and/or for the second access point 304B. The network management device 334 may be configured to transmit an instruction to the first access point 304A and/or to the second access point 304B to change the BSS color identifier to the newly determined BSS color identifier.

The network management device 334 and/or one or more of the access points 304A and/or 304B may be configured to execute a channel selection method to identify and/or assign a channel for use by one or more of the access points 304A and/or 304B. The channel may be identified and/or assigned as part of initial setup of an access point, periodically, substantially in real-time, based on detection of different BSS color identifiers, based on a color collision, based on a quantity of color collisions, based on an amount of interference, combinations thereof, and the like.

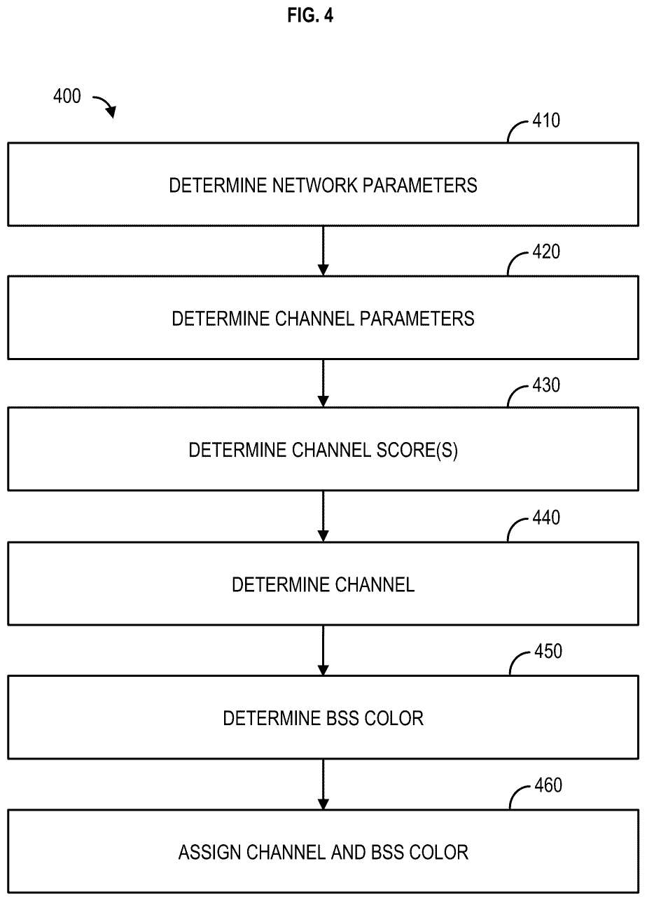

The channel selection method may utilize BSS color identifiers to reduce co-channel interference (e.g., same channel) by causing one or more APs (e.g., one of APs 304A-B) to change to a different channel. FIG. 4 shows an example channel selection method 400. The channel selection method 400 may be completed by any one or more of the computing devices of FIGS. 1 and 3. At 410, one or more network parameters may be determined (e.g., collected) for surrounding networks. One or more channels may be scanned to determine the network parameters. The network parameters may comprise, for example, one or more of BSSIDs, SSIDs, IP addresses, MAC addresses, power levels, BSS color parameters, channel identifiers, signal strength (e.g., RSSI), combinations thereof, and the like.

At 420, one or more channel parameters may be determined (e.g., collected). The one or more channels may be scanned to determine the channel parameters. The channel parameters may comprise, for example, one or more of a channel utilization measurement, a number of networks operating on a channel, a number of unique BSS color identifiers used on a channel, a signal strength(s) of a network(s) operating on a channel, combinations thereof, and the like.

At 430, one or more channel scores may be determined. A channel score may be determined based on one or more of the network parameters and/or the channel parameters. Channel score determination may take into account utilization percentages to prioritize channels with lower levels of overall network activity. Channel score determination may take into account the number of networks operating on a channel to prioritize channels with the lowest number of networks operating on them (e.g., counting BSSIDs/SSIDs), avoiding congested channels. Channel score determination may take into account the number of unique BSS color identifiers for each channel to prioritize channels with a higher number of unique (e.g., unused) BSS color identifiers, reducing co-channel interference by selecting channels where different networks are already using different BSS color identifiers. Channel score determination may take into account the signal strength (e.g. received signal strength indicator (RSSI)) of networks operating on each channel to prioritize channels with lower average RSSI values, reducing the potential for interference from nearby networks with strong signals.

The one or more channel scores may be determined by selecting the least utilized channels and then determining the least used channels among the least utilized channels. Signal strength of the resulting channels may be multiplied with the inverse of a channel utilization percentage. Channels with higher signal strength and lower utilization will have higher sub-scores. The channel with the highest number of unique BSS color identifiers and the highest average signal strength*inverse channel utilization value may have the highest channel score and may be selected. For example, the RSSI (e.g., absolute value: a number between 30 and 100) may be multiplied by the (channel utilization percentage subtracted from 100 (to obtain the inverse value)). This result may be added to the number of available BSS color identifiers (0-63) to obtain the channel score.

At 440, a channel may be determined based on the one or more channel scores. The channel may be determined based on being associated with a highest channel score, relative to other channels. The determined channel may represent one or more of, a least utilized channel based on the channel utilization measurements, a least used channel associated with a lowest number of networks operating on the channel, a channel with a higher number of unique (e.g. unused) BSS color identifiers available, a channel with lower average RSSI values of operating networks operating on the channel, combinations thereof, and the like.

At 450, a BSS color identifier may be determined based on available BSS color identifiers for the determined channel. The BSS color identifiers may be determined based on a random selection of unused BSS color identifiers associated with the determined channel. Continuous (e.g., regular, periodic) monitoring of BSS color identifier usage may be used to determine available BSS color identifiers.

At 460, an AP (e.g., one or more of APs 304A-B) may be assigned the determined channel and the BSS color identifier for use in communications with user devices. For example, the network management device 334 may be configured to transmit an instruction to the first access point 304A and/or to the second access point 304B to change channels to the determined channel or initially use the determined channel and to use the determined BSS color identifier, in an effort to reduce interference in any overlapping region that may exist. The instruction may be, for example, a channel switch announcement in a beacon or a management action frame. In other examples, the AP may determine the channel and BSS color identifier for itself. An AP can inform all of its associated user devices about a BSS color identifier change in an action frame referred to as a BSS color change announcement frame. The BSS color change information can optionally also be included in beacons, probe responses, and reassociation response frames.

The channel selection method provides a robust and intelligent channel selection mechanism, particularly suited for dense Wi-Fi environments. By combining network parameters and channel parameters, including BSS color parameters, interference is minimized, improving overall network performance, user experience, and more efficient use of an available Wi-Fi spectrum. Network and/or channel performance may be monitored to determine if performance and/or stability deviates from a threshold and the channel selection method may be re-executed.

FIG. 5 shows an example system 500 having the first access point 304A, the second access point 304B, the user device 318A, and the user device 332A. While only two access points and two user devices are shown in FIG. 5, this is for example purposes only. In other examples, the system 500 may include other suitable numbers of access points and other suitable numbers of user devices. For example, the first access point 304A and the second access point 304B may be implemented as instances of the access points 104A and/or 104B described above with reference to FIG. 1. For example, the user devices 318A, and 332A may be implemented as an instance of the respective user devices 118A and 132A described above with reference to FIG. 1 and the user devices 318A and 332A described above with reference to FIG. 3.

The first access point 304A and the second access point 304B may provide wireless network coverage (e.g., WLAN service coverage) area 302A and coverage area 302B, respectively. The network coverage area 302A and the network coverage area 302B may each represent respective physical regions within which a user device may receive and decode transmissions from the corresponding access point, for example, broadcast management frames or downlink data frames provided by the access point. For example, as shown in FIG. 5, the wireless network coverage area 302A does not overlap with the wireless network coverage area 302B. The user device 318A is associated with the wireless network coverage area 302A provided by the first access point 304A. The user device 332A is associated with the wireless network coverage area 302B provided by the second access point 304B. However, the system 500 of FIG. 5 differs from that of FIG. 3 in that the user device 332A has moved from the first location, as shown in FIG. 3, to a second location, as shown in FIG. 5. This movement may occur based on a user associated with the user device 332A moving the user device 332A (e.g., picking it up and carrying it) from the first location to the second location. In other examples, movement of the user device 332A from the first location to the second location may be caused by other users, by the user device itself, by another device, or the like.

As shown in FIG. 5, the user device 318A may receive communications (e.g., a data unit) from and/or send communications to only the AP 304A. The user device 332A, positioned at the second location, may receive communications (e.g., a data unit) from and/or send communications to only the AP 304B. Either one or both of the user devices 318A, 332A may be mobile user devices, such that they can be moved from a location to another location. For example, both the location and the another location may be within communication range for the same wireless network (e.g., networks 302A-B respectively).

For example, as shown in FIG. 5, the user device 318A and the user device 332A may be in an overlapping region 336. When within the overlapping region, the user device 318A may be able to detect or receive communications from user device 332A even when that communication is not intended for the user device 318A (e.g., when intended for the access point 304B). Similarly, the user device 332A may be able to detect or receive communications from the user device 318A even when that communication is not intended for the user device 332A (e.g., when intended for the access point 304A). For example, when the user devices 318A, 332A are close enough to one-another (e.g., within the overlapping region 336) and based on the received or detected communications from one user device 318A by the other user device 332A (or vice-versa), the user device 332A may determine the BSS color identifier for the access point 304A and/or wireless network 302A. Similarly, when the user devices 318A, 332A are close enough to one-another (e.g., within the overlapping region 336) and based on the received or detected communications from one user device 332A by the other user device 318A (or vice-versa), the user device 318A may determine the BSS color identifier for the access point 304B and/or wireless network 302B. As such, the user device 318A may determine the BSS color identifier for the access point 304B and/or wireless network 302B even when the user device 318A is not within the communication range of the wireless network 302B. Similarly, the user device 332A may determine the BSS color identifier for the access point 304A and/or wireless network 302A even when the user device 332A is not within the communication range of the wireless network 302A. For example, the user devices 318A, 332A may be configured for determining the BSS color identifiers of incoming communications (e.g., data units) that indicate the transmitter of the data unit, and may report the determined BSS color identifier to their respective APs and/or to a network management device 334.

For example, the user device 318A may detect or receive a communication (e.g., a data unit) originating from the user device 332A. The user device 318A may determine the BSS color identifier (e.g., the second BSS color identifier) indicated in the received communication and associated with the access point 304B and/or the network 302B. The user device 318A, which already knows the BSS color identifier (e.g., the first BSS color identifier) associated with the access point 304A and/or the network 302A, may compare the second BSS color identifier to the first BSS color identifier. The user device 318A may determine that the first BSS color identifier and the second BSS color identifier are the same. In addition, the user device 318A may determine that the access point 304A, via the network 302A, and the access point 304B, via the network 302B, are communicating, sending and/or transmitting on the same wireless channel.

The user device 318A may determine that a color collision has occurred. For example, the user device 318A may determine that a color collision has occurred based on the first BSS color identifier and the second BSS color identifier being the same or equal. For example, the user device 318A may determine that the color collision has occurred based on the access point 304A, via the network 302A, and the access point 304B, via the network 302B, communicating, sending and/or transmitting on the same wireless channel and based on the first BSS color identifier and the second BSS color identifier being the same or equal. The user device 318A may send an indication (e.g., a message, signal, communication, or the like) to the access point 304A indicating that the user device 318A has detected a BSS color collision with the access point 304B and/or the network 302B.

The access point 304A may receive the indication of the color collision from the user device 318A. The indication may include one or more of an identifier of the user device 332A (e.g., a MAC address), an identifier of the access point 304B (e.g., a MAC address), an identifier of the network 304B (e.g., a service set identifier (SSID)), an indicator of the first BSS color identifier, an indicator of the second BSS color identifier, and/or one or more current network parameters associated with the user device 318A (e.g., a current signal strength (e.g., RSSI) of communication between the user device 318A and the access point 304A, a current signal-to-noise ratio (SNR) for the communication between the user device 318A and the access point 304A, and/or one or more forms of current channel state information. The access point 304A may compare the second BSS color identifier to the first BSS color identifier associated with the access point 304A and/or the network 302A. The access point 304A may determine that the first BSS color identifier and the second BSS color identifier are the same or may rely on the comparison done by the user device 318A.

The access point 304A may determine if the access point 304A needs to change the BSS color identifier associated with the access point 304A and/or the network 302A. For example, this determination may be based on the indication of the color collision from the user device 318A and/or the determination that the first BSS color identifier is the same as the second BSS color identifier. For example, the access point 304A may determine that the access point 304A needs to change the first BSS color identifier to a third BSS color identifier that is different from the second BSS color identifier based on the user device 318A having moved from a first location to a second location prior to the user device 318A sending the indication of the BSS color collision to the access point 304A. For example, the access point 304A may determine that the access point 304A does not need to change the first BSS color identifier based on the user device 318A having not moved from the first location prior to the user device 318A sending the indication of the BSS color collision to the access point 304A.

For example, the access point 304A may determine if the user device 318A moved from a first location to a second location prior to the user device 318A sending the indication of the BSS color collision to the access point 304A by evaluating one or more network parameters associated with the user device 318A. For example, the one or more network parameters may comprise one or more of a signal strength (e.g., RSSI) of communication between the user device 318A and the access point 304A, a signal-to-noise ratio (SNR) for the communication between the user device 318A and the access point 304A, and/or one or more forms of channel state information (e.g., amplitude attenuation). For example, the access point 304A may determine a prior or historical value for the one or more network parameters for the user device 318A. The prior or historical value for the one or more network parameters for the user device 318A may be accessed or received from a database or memory local or remote from the access point 304A. For example, the prior or historical value for the one or more network parameters may be associated with a communication between the access point 304A and the user device 318A prior to the user device 318A sending the indication of the color collision (e.g., the most recent communication from the user device 318A to the access point 304A prior to the indication of the color collision being sent). For example, the access point 304A may determine a current value for the one or more network parameters for the user device 318A. For example, the current value for the one or more network parameters may be determined from the indication of the color collision or another recent communication from the user device 318A.

The access point 304A may compare the one of the one or more current network parameters for the user device 318A to a corresponding one of the one or more historical network parameters for the user device to determine a difference between the current network parameter and the historical network parameter. The access point 304A may compare the difference between the current network parameter and the historical network parameter to a first parameter threshold to determine if the difference between the current network parameter and the historical network parameter satisfies the first parameter threshold (e.g., is greater than or greater than or equal to the first parameter threshold). The access point 304A may compare the difference between the current network parameter and the historical network parameter to a second parameter threshold to determine if the difference between the current network parameter and the historical network parameter satisfies the second parameter threshold (e.g., is less than or less than or equal to the second parameter threshold). For example, the access point 304A may determine the user device 318A moved prior to the user device sending the indication of the color collision if the difference between the current network parameter and the historical network parameter satisfies the first parameter threshold. For example, the access point 304A may determine the user device 318A did not move prior to the user device 318A sending the indication of the color collision if the difference between the current network parameter and the historical network parameter does not satisfy the first parameter threshold. For example, the access point 304A may determine the user device 318A did not move prior to the user device 318A sending the indication of the color collision if the difference between the current network parameter and the historical network parameter does not satisfy the first parameter threshold and the difference between the current network parameter and the historical network parameter does satisfy the second parameter threshold. For example, each of the one or more network parameters may have a first parameter threshold that is the same or different from the first parameter threshold for other network parameters. For example, each of the one or more network parameters may also have a second parameter threshold that is the same or different from the second parameter threshold for the other network parameters. As shown in FIG. 5, the access point 304A may determine at least the difference between the current network parameter and the historical network parameter does not satisfy the first parameter threshold and optionally does satisfy the second parameter threshold.

Based on the difference between the current network parameter and the historical network parameter not satisfying the first parameter threshold and optionally satisfying the second parameter threshold, the access point 304A may determine the user device 318A did not move from one location to another location prior (e.g., within the previous 1, 3, 5, 10, 20 minutes) to the user device 318A sending the indication of the color collision. The access point 304A may determine that the access point 304A will not change the BSS color identifier (e.g., the first BSS color identifier) associated with the access point 304A and/or the network 302A. For example, the access point 304A may determine to not change the first BSS color identifier based on the difference between the current network parameter and the historical network parameter not satisfying the first parameter threshold and optionally satisfying the second parameter threshold. For example, the access point 304A may determine if the user device 318 did or did not move prior to sending the indication of the color collision based on a plurality of network parameters (e.g., 2, 3, 4, or more) of the one or more network parameters associated with the user device 318A having differences (as described above) between current and historical values that do satisfy a corresponding first parameter threshold or that satisfy a corresponding second parameter threshold and/or don't satisfy the corresponding first parameter threshold for each of those particular network parameters.

For example, the one or more network parameters may comprise a signal strength (e.g., RSSI) associated with a communication between the user device 318A and the access point 304A. For example, the access point 304A may determine a prior or historical value for the signal strength for the user device 318A. The prior or historical value for the signal strength for the user device 318A may be accessed or received from a database or memory local or remote from the access point 304A. For example, the prior or historical value for the signal strength may be associated with a communication between the access point 304A and the user device 318A prior to the user device 318A sending the indication of the color collision (e.g., the most recent communication from the user device 318A to the access point 304A prior to the indication of the color collision being sent). For example, the access point 304A may determine a current value for the signal strength for the user device 318A. For example, the current value for the signal strength may be determined from the indication of the color collision or another recent communication from the user device 318A.

The access point 304A may compare the current signal strength for the user device 318A to the historical signal strength for the user device 318A to determine a difference between the current signal strength and the historical signal strength (e.g., a signal strength difference). The access point 304A may compare the difference between the current signal strength and the historical signal strength to a first signal strength threshold to determine if the difference satisfies the first signal strength threshold (e.g., is greater than or greater than or equal to the first signal strength threshold). For example, the first signal strength threshold may be 5 decibels (dB) of the measured power referenced to one milliWatt (dBm). The first signal strength threshold may be any other amount greater or less than 5 dBm in other examples. The access point 304A may compare the difference between the current signal strength and the historical signal strength to a second signal strength threshold to determine if the difference satisfies the second signal strength threshold (e.g., is less than or less than or equal to the second signal strength threshold). For example, the second signal strength threshold may be 2 dBm. The second signal strength threshold may be any other amount greater or less than 2 dBm in other examples. For example, the access point 304A may determine the user device 318A moved prior to the user device 318A sending the indication of the color collision if the difference between the current signal strength and the historical signal strength satisfies the first signal strength threshold. For example, the access point 304A may determine the user device 318A did not move prior to the user device 318A sending the indication of the color collision if the difference between the current signal strength and the historical signal strength does not satisfy the first signal strength threshold. For example, the access point 304A may determine the user device 318A did not move prior to the user device 318A sending the indication of the color collision if the difference between the current signal strength and the historical signal strength does not satisfy the first signal strength threshold and the difference between the current signal strength and the historical signal strength does satisfy the second signal strength threshold.

As shown in FIG. 5, the access point 304A may determine at least the difference between the current signal strength and the historical signal strength does not satisfy the first signal strength threshold and optionally does satisfy the second signal strength threshold. Based on the difference between the current signal strength and the historical signal strength not satisfying the first signal strength threshold and optionally satisfying the second signal strength threshold, the access point 304A may determine the user device 318A did not move from one location to another location prior (e.g., within the previous 1, 3, 5, 10, 20 minutes) to the user device 318A sending the indication of the color collision. The access point 304A may determine that the access point 304A will not change the BSS color identifier (e.g., the first BSS color identifier) associated with the access point 304A and/or the network 302A based on the difference between the current signal strength and the historical signal strength not satisfying the first signal strength threshold and optionally satisfying the second signal strength threshold.

For example, the one or more network parameters may comprise a signal-to-noise ratio (SNR) associated with a communication between the user device 318A and the access point 304A. For example, the access point 304A may determine a prior or historical value for the SNR for the user device 318A. The prior or historical value for the SNR for the user device 318A may be accessed or received from a database or memory local or remote from the access point 304A. For example, the prior or historical value for the SNR may be associated with a communication between the access point 304A and the user device 318A prior to the user device 318A sending the indication of the color collision (e.g., the most recent communication from the user device 318A to the access point 304A prior to the indication of the color collision being sent). For example, the access point 304A may determine a current value for the SNR for the user device 318A. For example, the current value for the SNR may be determined from the indication of the color collision or another recent communication from the user device 318A.

The access point 304A may compare the current SNR for the user device 318A to the historical SNR for the user device 318A to determine a difference between the current SNR and the historical SNR (e.g., a SNR difference). The access point 304A may compare the difference between the current SNR and the historical SNR to a first SNR threshold to determine if the difference satisfies the first SNR threshold (e.g., is greater than or greater than or equal to the first SNR threshold). For example, the first SNR threshold may be 5 decibels (dB) (e.g., a 5 dB decrease in SNR). The first SNR threshold may be any other amount greater or less than 5 dB in other examples. The access point 304A may compare the difference between the current SNR and the historical SNR to a second SNR threshold to determine if the difference satisfies the second SNR threshold (e.g., is less than or less than or equal to the second SNR threshold). For example, the second SNR threshold may be 2 dB. The second SNR threshold may be any other amount greater or less than 2 dB in other examples. For example, the access point 304A may determine the user device 318A moved prior to the user device 318A sending the indication of the color collision if the difference between the current SNR and the historical SNR satisfies the first SNR threshold. For example, the access point 304A may determine the user device 318A did not move prior to the user device 318A sending the indication of the color collision if the difference between the current SNR and the historical SNR does not satisfy the first SNR threshold. For example, the access point 304A may determine the user device 318A did not move prior to the user device 318A sending the indication of the color collision if the difference between the current SNR and the historical SNR does not satisfy the first SNR threshold and the difference between the current SNR and the historical SNR does satisfy the second SNR threshold. As shown in FIG. 5, the access point 304A may determine at least the difference between the current SNR and the historical SNR does not satisfy the first SNR threshold and optionally does satisfy the second SNR threshold. Based on the difference between the current SNR and the historical SNR not satisfying the first SNR threshold and optionally satisfying the second SNR threshold, the access point 304A may determine the user device 318A did not move from one location to another location prior (e.g., within the previous 1, 3, 5, 10, 20 minutes) to the user device 318A sending the indication of the color collision. The access point 304A may determine that the access point 304A will not change the BSS color identifier (e.g., the first BSS color identifier) associated with the access point 304A and/or the network 302A based on the difference between the current SNR and the historical SNR not satisfying the first SNR threshold and optionally satisfying the second SNR threshold.

As shown in FIG. 5, the access point 304A may determine one or both of at least the difference between the current SNR and the historical SNR does not satisfy the first SNR threshold and optionally does satisfy the second SNR threshold, and at least the difference between the current signal strength and the historical signal strength does not satisfy the first signal strength threshold and optionally does satisfy the second signal strength threshold. Based on one or both of the difference between the current SNR and the historical SNR not satisfying the first SNR threshold and optionally satisfying the second SNR threshold, and at least the difference between the current signal strength and the historical signal strength not satisfying the first signal strength threshold and optionally satisfying the second signal strength threshold, the access point 304A may determine the user device 318A did not move from one location to another location prior (e.g., within the previous 1, 3, 5, 10, 20 minutes) to the user device 318A sending the indication of the color collision. The access point 304A may determine that the access point 304A will not change the BSS color identifier (e.g., the first BSS color identifier) associated with the access point 304A and/or the network 302A based on one or both of the difference between the current signal strength and the historical signal strength not satisfying the first signal strength threshold and optionally satisfying the second signal strength threshold, and the difference between the current SNR and the historical SNR not satisfying the first SNR threshold and optionally satisfying the second SNR threshold.

For example, the one or more network parameters may comprise amplitude attenuation or other channel state information associated with a communication between the user device 318A and the access point 304A. For example, the access point 304A may determine a prior or historical value for the amplitude attenuation for the user device 318A. The prior or historical value for the amplitude attenuation for the user device 318A may be accessed or received from a database or memory local or remote from the access point 304A. For example, the prior or historical value for the amplitude attenuation may be associated with a communication between the access point 304A and the user device 318A prior to the user device 318A sending the indication of the color collision (e.g., the most recent communication from the user device 318A to the access point 304A prior to the indication of the color collision being sent). For example, the access point 304A may determine a current value for the amplitude attenuation for the user device 318A. For example, the current value for the amplitude attenuation may be determined from the indication of the color collision or another recent communication from the user device 318A.

The access point 304A may compare the current amplitude attenuation for the user device 318A to the historical amplitude attenuation for the user device 318A to determine a difference between the current amplitude attenuation and the historical amplitude attenuation (e.g., an attenuation difference). The access point 304A may compare the difference between the current amplitude attenuation and the historical amplitude attenuation to a first amplitude attenuation threshold to determine if the difference satisfies the first amplitude attenuation threshold (e.g., is greater than or greater than or equal to the first amplitude attenuation threshold). For example, the first amplitude attenuation threshold may be 3 decibels (dB). The first amplitude attenuation threshold may be any other amount greater or less than 3 dB in other examples. The access point 304A may compare the difference between the current amplitude attenuation and the historical amplitude attenuation to a second amplitude attenuation threshold to determine if the difference satisfies the second amplitude attenuation threshold (e.g., is less than or less than or equal to the second amplitude attenuation threshold). For example, the second amplitude attenuation threshold may be 1 dB. The second amplitude attenuation threshold may be any other amount greater or less than 1 dB in other examples. For example, the access point 304A may determine the user device 318A moved prior to the user device 318A sending the indication of the color collision if the difference between the current amplitude attenuation and the historical amplitude attenuation satisfies the first amplitude attenuation threshold. For example, the access point 304A may determine the user device 318A did not move prior to the user device 318A sending the indication of the color collision if the difference between the current amplitude attenuation and the historical amplitude attenuation does not satisfy the first amplitude attenuation threshold. For example, the access point 304A may determine the user device 318A did not move prior to the user device 318A sending the indication of the color collision if the difference between the current amplitude attenuation and the historical amplitude attenuation does not satisfy the first amplitude attenuation threshold and the difference between the current amplitude attenuation and the historical amplitude attenuation does satisfy the second amplitude attenuation threshold.

As shown in FIG. 5, the access point 304A may determine one or more of at least the difference between the current SNR and the historical SNR does not satisfy the first SNR threshold and optionally does satisfy the second SNR threshold, at least the difference between the current signal strength and the historical signal strength does not satisfy the first signal strength threshold and optionally does satisfy the second signal strength threshold, and at least the difference between the current amplitude attenuation and the historical amplitude attenuation does not satisfy the first amplitude attenuation threshold and optionally does satisfy the second amplitude attenuation threshold. Based on one or more of the difference between the current SNR and the historical SNR not satisfying the first SNR threshold and optionally satisfying the second SNR threshold, at least the difference between the current signal strength and the historical signal strength not satisfying the first signal strength threshold and optionally satisfying the second signal strength threshold, and the difference between the current amplitude attenuation and the historical amplitude attenuation not satisfying the first amplitude attenuation threshold and optionally satisfying the second amplitude attenuation threshold, the access point 304A may determine the user device 318A did not move from one location to another location prior (e.g., within the previous 1, 3, 5, 10, 20 minutes) to the user device 318A sending the indication of the color collision. The access point 304A may determine that the access point 304A will not change the BSS color identifier (e.g., the first BSS color identifier) associated with the access point 304A and/or the network 302A based on one or more of the difference between the current signal strength and the historical signal strength not satisfying the first signal strength threshold and optionally satisfying the second signal strength threshold, the difference between the current SNR and the historical SNR not satisfying the first SNR threshold and optionally satisfying the second SNR threshold, and the difference between the current amplitude attenuation and the historical amplitude attenuation not satisfying the first signal strength threshold and optionally satisfying the second amplitude attenuation threshold.

For example, the user device 332A may detect or receive a communication (e.g., a data unit) originating from the user device 318A. The user device 332A may determine the BSS color identifier (e.g., the first BSS color identifier) indicated in the received communication and associated with the access point 304A and/or the network 302A. The user device 332A, which already knows the BSS color identifier (e.g., the second BSS color identifier) associated with the access point 304B and/or the network 302B, may compare the second BSS color identifier to the first BSS color identifier. The user device 332A may determine that the first BSS color identifier and the second BSS color identifier are the same. In addition, the user device 332A may determine that the access point 304A, via the network 302A, and the access point 304B, via the network 302B, are communicating, sending and/or transmitting on the same wireless channel.

The user device 332A may determine that a color collision has occurred. For example, the user device 332A may determine that a color collision has occurred based on the first BSS color identifier and the second BSS color identifier being the same or equal. For example, the user device 332A may determine that the color collision has occurred based on the access point 304A, via the network 302A, and the access point 304B, via the network 302B, communicating, sending and/or transmitting on the same wireless channel and based on the first BSS color identifier and the second BSS color identifier being the same or equal. The user device 332A may send an indication (e.g., a message, signal, communication, or the like) to the access point 304B indicating that the user device 332A has detected a BSS color collision with the access point 304A and/or the network 302A.

The access point 304B may receive the indication of the color collision from the user device 332A. The indication may include one or more of an identifier of the user device 318A (e.g., a MAC address), an identifier of the access point 304A (e.g., a MAC address), an identifier of the network 302A (e.g., a service set identifier (SSID)), an indicator of the first BSS color identifier, an indicator of the second BSS color identifier, and/or one or more current network parameters associated with the user device 332A (e.g., a current signal strength (e.g., RSSI) of communication between the user device 332A and the access point 304B, a current signal-to-noise ratio (SNR) for the communication between the user device 332A and the access point 304B, and/or one or more forms of current channel state information (e.g., a current amplitude attenuation for a communication between the user device 332A and the access point 304B). The access point 304B may compare the first BSS color identifier to the second BSS color identifier associated with the access point 304B and/or the network 302B. The access point 304B may determine that the first BSS color identifier and the second BSS color identifier are the same or may rely on the comparison done by the user device 332A.

The access point 304B may determine if the access point 304B needs to change the BSS color identifier associated with the access point 304B and/or the network 302B. For example, this determination may be based on the indication of the color collision from the user device 332A and/or the determination that the first BSS color identifier is the same as the second BSS color identifier. For example, the access point 304B may determine that the access point 304B needs to change the second BSS color identifier to a third BSS color identifier that is different from the first BSS color identifier based on the user device 332A having moved from a first location to a second location prior to the user device 332A sending the indication of the BSS color collision to the access point 304B. For example, the access point 304B may determine that the access point 304B does not need to change the second BSS color identifier based on the user device 332A having not moved from the first location prior to the user device 332A sending the indication of the BSS color collision to the access point 304B.

For example, the access point 304B may determine if the user device 332A moved from a first location to a second location prior to the user device 332A sending the indication of the BSS color collision to the access point 304B by evaluating one or more network parameters associated with the user device 332A. For example, the one or more network parameters may be the same or substantially similar to those described above with reference to the user device 318A. For example, the access point 304B may determine a prior or historical value for the one or more network parameters for the user device 332A. The prior or historical value for the one or more network parameters for the user device 332A may be accessed or received from a database or memory local or remote from the access point 304B. For example, the prior or historical value for the one or more network parameters may be associated with a communication between the access point 304B and the user device 332A prior to the user device 332A sending the indication of the color collision (e.g., the most recent communication from the user device 332A to the access point 304B prior to the indication of the color collision being sent). For example, the access point 304B may determine a current value for the one or more network parameters for the user device 332A. For example, the current value for the one or more network parameters may be determined from the indication of the color collision or another recent communication from the user device 332A to the access point 304B.

The access point 304B may compare the one of the one or more current network parameters for the user device 332A to a corresponding one of the one or more historical network parameters for the user device 332A to determine a difference between the current network parameter and the historical network parameter. The access point 304B may compare the difference between the current network parameter and the historical network parameter to a first parameter threshold to determine if the difference between the current network parameter and the historical network parameter satisfies the first parameter threshold (e.g., is greater than or greater than or equal to the first parameter threshold). The access point 304B may compare the difference between the current network parameter and the historical network parameter to a second parameter threshold to determine if the difference between the current network parameter and the historical network parameter satisfies the second parameter threshold (e.g., is less than or less than or equal to the second parameter threshold). For example, the access point 304B may determine the user device 332A moved prior to the user device 332A sending the indication of the color collision if the difference between the current network parameter and the historical network parameter satisfies the first parameter threshold. For example, the access point 304B may determine the user device 332A did not move prior to the user device 332A sending the indication of the color collision if the difference between the current network parameter and the historical network parameter does not satisfy the first parameter threshold. For example, the access point 304B may determine the user device 332A did not move prior to the user device 332A sending the indication of the color collision if the difference between the current network parameter and the historical network parameter does not satisfy the first parameter threshold and the difference between the current network parameter and the historical network parameter does satisfy the second parameter threshold. As shown in FIG. 5, the access point 304B may determine at least the difference between the current network parameter and the historical network parameter satisfies the first parameter threshold.

Based on the difference between the current network parameter and the historical network parameter satisfying the first parameter threshold, the access point 304B may determine the user device 332A moved from the first location (as shown in FIG. 3) to a second location (as shown in FIG. 5) prior (e.g., within the previous 1, 3, 5, 10, 20 minutes) to the user device 332A sending the indication of the color collision to the access point 304B. The access point 304B may determine that the access point 304B will change the BSS color identifier (e.g., the second BSS color identifier) associated with the access point 304B and/or the network 302B. For example, the access point 304B may determine to change the second BSS color identifier to a third BSS color identifier different from the first and second BSS color identifiers based on the difference between the current network parameter and the historical network parameter satisfying the first parameter threshold. For example, the access point 304B may determine if the user device 332A did or did not move prior to sending the indication of the color collision based on a plurality of network parameters (e.g., 2, 3, 4, or more) of the one or more network parameters associated with the user device 332A having differences (as described above) between current and historical values that do satisfy a corresponding first parameter threshold or that satisfy a corresponding second parameter threshold and/or don't satisfy the corresponding first parameter threshold for each of those particular network parameters.

For example, the one or more network parameters may comprise a signal strength (e.g., RSSI) associated with a communication between the user device 332A and the access point 304B. For example, the access point 304B may determine a prior or historical value for the signal strength for the user device 332A. The prior or historical value for the signal strength for the user device 332A may be accessed or received from a database or memory local or remote from the access point 304B. For example, the prior or historical value for the signal strength may be associated with a communication between the access point 304B and the user device 332A prior to the user device 332A sending the indication of the color collision (e.g., the most recent communication from the user device 332A to the access point 304B prior to the indication of the color collision being sent). For example, the access point 304B may determine a current value for the signal strength for the user device 332A. For example, the current value for the signal strength may be determined from the indication of the color collision or another recent communication from the user device 332A.

The access point 304B may compare the current signal strength for the user device 332A to the historical signal strength for the user device 332A to determine a difference between the current signal strength and the historical signal strength (e.g., a signal strength difference). The access point 304B may compare the difference between the current signal strength and the historical signal strength to the first signal strength threshold to determine if the difference satisfies the first signal strength threshold (e.g., is greater than or greater than or equal to the first signal strength threshold). For example, the first signal strength threshold may be 5 dBm. The first signal strength threshold may be any other amount greater or less than 5 dBm in other examples. The access point 304B may compare the difference between the current signal strength and the historical signal strength to a second signal strength threshold to determine if the difference satisfies the second signal strength threshold (e.g., is less than or less than or equal to the second signal strength threshold). For example, the second signal strength threshold may be 2 dBm. The second signal strength threshold may be any other amount greater or less than 2 dBm in other examples. For example, the access point 304B may determine the user device 332A moved prior to the user device 332A sending the indication of the color collision if the difference between the current signal strength and the historical signal strength satisfies the first signal strength threshold. For example, the access point 304B may determine the user device 332A did not move prior to the user device 332A sending the indication of the color collision if the difference between the current signal strength and the historical signal strength does not satisfy the first signal strength threshold.

For example, the access point 304B may determine the user device 332A did not move prior to the user device 332A sending the indication of the color collision if the difference between the current signal strength and the historical signal strength does not satisfy the first signal strength threshold and the difference between the current signal strength and the historical signal strength does satisfy the second signal strength threshold.

As shown in FIG. 5, the access point 304B may determine at least the difference between the current signal strength and the historical signal strength satisfies the first signal strength threshold. Based on the difference between the current signal strength and the historical signal strength satisfying the first signal strength threshold, the access point 304B may determine the user device 332A moved from the first location to the second location prior (e.g., within the previous 1, 3, 5, 10, 20 minutes) to the user device 332A sending the indication of the color collision. The access point 304B may determine that the access point 304B will change the BSS color identifier (e.g., the second BSS color identifier) associated with the access point 304B and/or the network 302B from the second BSS color identifier to a third BSS color identifier different from the first and second BSS color identifiers based on the difference between the current signal strength and the historical signal strength satisfying the first signal strength threshold.

For example, the one or more network parameters may comprise a signal-to-noise ratio (SNR) associated with a communication between the user device 332A and the access point 304B. For example, the access point 304B may determine a prior or historical value for the SNR for the user device 332A. The prior or historical value for the SNR for the user device 332A may be accessed or received from a database or memory local or remote from the access point 304B. For example, the prior or historical value for the SNR may be associated with a communication between the access point 304B and the user device 332A prior to the user device 332A sending the indication of the color collision (e.g., the most recent communication from the user device 332A to the access point 304B prior to the indication of the color collision being sent). For example, the access point 304B may determine a current value for the SNR for the user device 332A. For example, the current value for the SNR may be determined from the indication of the color collision or another recent communication from the user device 332A.

The access point 304B may compare the current SNR for the user device 332A to the historical SNR for the user device 332A to determine a difference between the current SNR and the historical SNR (e.g., a SNR difference). The access point 304B may compare the difference between the current SNR and the historical SNR to a first SNR threshold to determine if the difference satisfies the first SNR threshold (e.g., is greater than or greater than or equal to the first SNR threshold). For example, the first SNR threshold may be 5 dB (e.g., a 5 dB decrease in SNR). The first SNR threshold may be any other amount greater or less than 5 dB in other examples. The access point 304B may compare the difference between the current SNR and the historical SNR to a second SNR threshold to determine if the difference satisfies the second SNR threshold (e.g., is less than or less than or equal to the second SNR threshold). For example, the second SNR threshold may be 2 dB. The second SNR threshold may be any other amount greater or less than 2 dB in other examples. For example, the access point 304B may determine the user device 332A moved prior to the user device 332A sending the indication of the color collision if the difference between the current SNR and the historical SNR satisfies the first SNR threshold. For example, the access point 304B may determine the user device 332A did not move prior to the user device 332A sending the indication of the color collision if the difference between the current SNR and the historical SNR does not satisfy the first SNR threshold. For example, the access point 304B may determine the user device 332A did not move prior to the user device 332A sending the indication of the color collision if the difference between the current SNR and the historical SNR does not satisfy the first SNR threshold and the difference between the current SNR and the historical SNR does satisfy the second SNR threshold.

As shown in FIG. 5, the access point 304B may determine at least the difference between the current SNR and the historical SNR satisfies the first SNR threshold. Based on the difference between the current SNR and the historical SNR satisfying the first SNR threshold, the access point 304B may determine the user device 332A moved from the first location to the second location prior (e.g., within the previous 1, 3, 5, 10, 20 minutes) to the user device 332A sending the indication of the color collision. The access point 304B may determine that the access point 304B will change the BSS color identifier (e.g., the second BSS color identifier) associated with the access point 304B and/or the network 302B from the second BSS color identifier to a third BSS color identifier different from the first and second BSS color identifiers based on the difference between the current SNR and the historical SNR satisfying the first SNR threshold.

As shown in FIG. 5, the access point 304B may determine one or both of at least the difference between the current SNR and the historical SNR satisfies the first SNR threshold, and at least the difference between the current signal strength and the historical signal strength satisfies the first signal strength threshold. Based on one or both of the difference between the current SNR and the historical SNR satisfying the first SNR threshold, and at least the difference between the current signal strength and the historical signal strength satisfying the first signal strength threshold, the access point 304B may determine the user device 332A moved from the first location to the second location prior (e.g., within the previous 1, 3, 5, 10, 20 minutes) to the user device 332A sending the indication of the color collision. The access point 304B may determine that the access point 304B will change the BSS color identifier (e.g., the second BSS color identifier) associated with the access point 304B and/or the network 302B from the second BSS color identifier to a third BSS color identifier different from the first and second BSS color identifiers based on one or both of the difference between the current signal strength and the historical signal strength satisfying the first signal strength threshold, and the difference between the current SNR and the historical SNR satisfying the first SNR threshold.

For example, the one or more network parameters may comprise amplitude attenuation or other channel state information associated with a communication between the user device 332A and the access point 304B. For example, the access point 304B may determine a prior or historical value for the amplitude attenuation for the user device 332A. The prior or historical value for the amplitude attenuation for the user device 332A may be accessed or received from a database or memory local or remote from the access point 304B. For example, the prior or historical value for the amplitude attenuation may be associated with a communication between the access point 304B and the user device 332A prior to the user device 332A sending the indication of the color collision (e.g., the most recent communication from the user device 332A to the access point 304B prior to the indication of the color collision being sent). For example, the access point 304B may determine a current value for the amplitude attenuation for the user device 332A. For example, the current value for the amplitude attenuation may be determined from the indication of the color collision or another recent communication from the user device 332A.

The access point 304B may compare the current amplitude attenuation for the user device 332A to the historical amplitude attenuation for the user device 332A to determine a difference between the current amplitude attenuation and the historical amplitude attenuation (e.g., an attenuation difference). The access point 304B may compare the difference between the current amplitude attenuation and the historical amplitude attenuation to a first amplitude attenuation threshold to determine if the difference satisfies the first amplitude attenuation threshold (e.g., is greater than or greater than or equal to the first amplitude attenuation threshold). For example, the first amplitude attenuation threshold may be 3 decibels (dB). The first amplitude attenuation threshold may be any other amount greater or less than 3 dB in other examples. The access point 304B may compare the difference between the current amplitude attenuation and the historical amplitude attenuation to a second amplitude attenuation threshold to determine if the difference satisfies the second amplitude attenuation threshold (e.g., is less than or less than or equal to the second amplitude attenuation threshold). For example, the second amplitude attenuation threshold may be 1 dB. The second amplitude attenuation threshold may be any other amount greater or less than 1 dB in other examples. For example, the access point 304B may determine the user device 332A moved prior to the user device 318A sending the indication of the color collision if the difference between the current amplitude attenuation and the historical amplitude attenuation satisfies the first amplitude attenuation threshold. For example, the access point 304B may determine the user device 332A did not move prior to the user device 332A sending the indication of the color collision if the difference between the current amplitude attenuation and the historical amplitude attenuation does not satisfy the first amplitude attenuation threshold. For example, the access point 304B may determine the user device 332A did not move prior to the user device 332A sending the indication of the color collision if the difference between the current amplitude attenuation and the historical amplitude attenuation does not satisfy the first amplitude attenuation threshold and the difference between the current amplitude attenuation and the historical amplitude attenuation does satisfy the second amplitude attenuation threshold.

As shown in FIG. 5, the access point 304B may determine one or more of at least the difference between the current SNR and the historical SNR satisfies the first SNR threshold, at least the difference between the current signal strength and the historical signal strength satisfies the first signal strength threshold, and at least the difference between the current amplitude attenuation and the historical amplitude attenuation satisfies the first amplitude attenuation threshold. Based on one or more of the difference between the current SNR and the historical SNR satisfying the first SNR threshold, at least the difference between the current signal strength and the historical signal strength satisfying the first signal strength threshold, and the difference between the current amplitude attenuation and the historical amplitude attenuation satisfying the first amplitude attenuation threshold, the access point 304B may determine the user device 332A moved from the first location to the second location prior (e.g., within the previous 1, 3, 5, 10, 20 minutes) to the user device 332A sending the indication of the color collision. The access point 304B may determine that the access point 304B will change the BSS color identifier (e.g., the second BSS color identifier) associated with the access point 304B and/or the network 302B from the second BSS color identifier to a third BSS color identifier different from the first and second BSS color identifiers based on one or more of the difference between the current signal strength and the historical signal strength satisfying the first signal strength threshold, the difference between the current SNR and the historical SNR satisfying the first SNR threshold, and the difference between the current amplitude attenuation and the historical amplitude attenuation satisfying the first signal strength threshold.

The access point 304B may change the BSS color identifier associated with the access point 304B and/or network 302B from the second BSS color identifier to a third BSS color identifier. For example, prior to changing the BSS color identifier, the access point 304B may once again scan the area to determine other access points or networks and their associated BSS color identifiers in the area in an effort to select a third BSS color identifier that is not being used by any other access point or network within its communication range. Based on changing the BSS color identifier from the second BSS color identifier to the third BSS color identifier, the access point 304B may send an indication, message, signal, or the like to the user device 332A that informs the user device 332A of the change to the third BSS color identifier for future communications with the access point 304B. Once the access point 304B switches from the second BSS color identifier to the third BSS color identifier, when the user device 332A receives or detects communications from the user device 318A the user device 332A will not detect a color collision because the first BSS color identifier is now different than the third BSS color identifier. Similarly, once the access point 304B switches to the third BSS color identifier, when the user device 318A receives or detects communications from the user device 332A the user device 318A will not detect a color collision because the first BSS color identifier is now different than the third BSS color identifier.

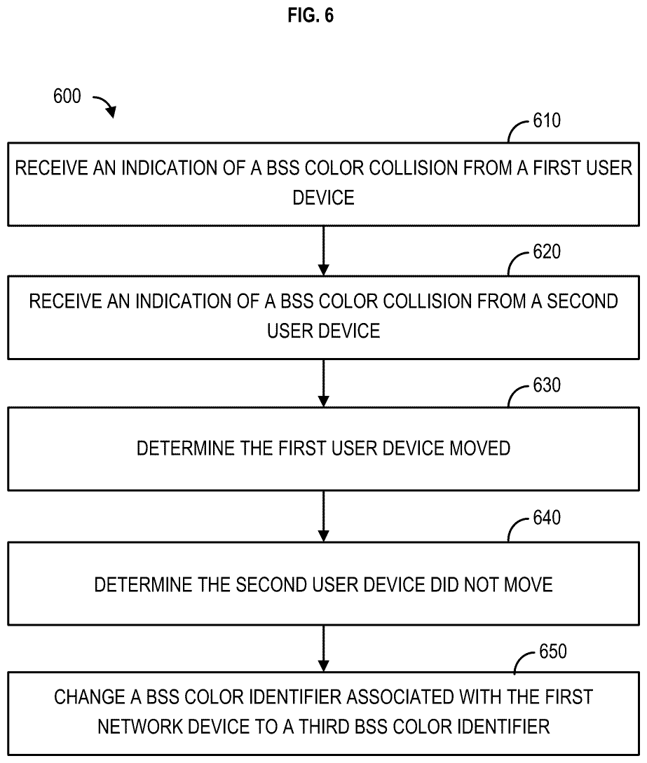

FIG. 6 shows an example method 600 for determining actions to take during a BSS color collision. The method 600 may be completed by any of the computing devices of FIGS. 1, 3, and 5. For example, the method 600 may be completed by one or more network devices, such as the access points 304A-B. For example, each of the first network device 304B and the second network device 304A may determine each network device's initial BSS color identifier in the manner described in FIG. 4 above.

At 610, an indication of a BSS color collision may be received from a first user device. For example, the indication may be sent by the first user device 332A and may be received by a first network device (e.g., the first access point 304B). For example, the first network device 304B may provide wireless network coverage area 302B and the first user device 332A may be within the wireless network coverage area 302B. For example, the first user device 332A may receive or detect communication from another user device (e.g., a second user device 318A). The communication may or may not have been intended for the first user device 332A. For example, the second user device 318A may be communicating with a second network device (e.g., the second access point 304A) and be within a second wireless network coverage area 302A. However, the first user device 332A and the second user device 318A may be in an overlapping region (e.g., overlapping region 336) with one another, such that each user device 318A, 332A may receive or detect communications from the other user device 318A, 332A. Based on receiving or detecting the communication from the second user device 318A, the first user device 332A may determine the second BSS color identifier within that communication and associated with the second network device 304A and/or the second network 302A. The first user device 332A may know the first BSS color identifier associated with the first network device 304B and/or the first network 302B.

The first user device 332A may determine the first BSS color identifier and the second BSS color identifier are the same BSS color identifier and send an indication of the BSS color collision to the first network device 304B. For example, the indication sent by the first user device 332A to the first network device 304B may comprise a message indicating the BSS color collision. For example, the message may be or comprise an autonomous report that is sent by the first user device 332A to the first network device 304B indicating the BSS color collision. For example, the autonomous report may comprise BSS color identifiers for one or more (e.g., all) other network devices and/or networks (e.g., the second network device 304A) from which the first user device 332A is able to detect frames in order to assist or help the first network device 304B to determine a new BSS color identifier when the first network device 304B determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the second network device 304A) that the first user device 332A is able to detect, for example through communication with the second user device 318A. The autonomous report or another message sent by the first user device 332A to the first network device 304B may include one or more of an identifier of the second user device 318A (e.g., a MAC address), an identifier of the second network device 304A (e.g., a MAC address), an identifier of the second network 302A (e.g., a service set identifier (SSID)), an indicator of the first BSS color identifier, an indicator of the second BSS color identifier, and/or one or more current network parameters associated with the first user device 332A (e.g., a current signal strength (e.g., RSSI) of communication between the first user device 332A and the first network device 304B, a current signal-to-noise ratio (SNR) for the communication between the first user device 332A and the first network device 304B, and/or one or more forms of current channel state information, such as the current amplitude attenuation for the first user device 332A.

At 620, an indication of a BSS color collision may be received from the second user device 318A. For example, the indication may be sent by the user device 318A and may be received by a second network device (e.g., the access point 304A). For example, the second network device 304A may provide wireless network coverage area 302A and the second user device 318A may be within the second wireless network coverage area 302A. For example, the second user device 318A may receive or detect communication from first user device 332A. The communication may or may not have been intended for the second user device 318A. For example, the first user device 332A may be communicating with the first network device 304B. Based on receiving or detecting the communication from the first user device 332A, the second user device 318A may determine the first BSS color identifier within that communication and associated with the first network device 304B and/or the first network 302B. The second user device 318A may know the second BSS color identifier associated with the second network device 304A and/or the second network 302A. The second user device 318A may determine the first BSS color identifier and the second BSS color identifier are the same BSS color identifier and send the indication of the BSS color collision to the second network device 304A.

For example, the indication sent by the second user device 318A to the second network device 304A may comprise a message indicating the BSS color collision. For example, the message may be or comprise an autonomous report that is sent by the second user device 318A to second network device 304A indicating the BSS color collision. For example, the autonomous report may comprise BSS color identifiers for one or more (e.g., all) other network devices and/or networks (e.g., the first network device 304B) from which the second user device 318A is able to detect frames in order to assist or help the second network device 304A to determine a new BSS color identifier when the second network device 304A determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the first network device 304B) that the second user device 318A is able to detect, for example through communication with first user device 332A. The autonomous report or another message sent by the second user device 318A to the second network device 304A may include one or more of an identifier of the first user device 332A (e.g., a MAC address), an identifier of the first network device 304B (e.g., a MAC address), an identifier of the first network 302B (e.g., a service set identifier (SSID)), an indicator of the first BSS color identifier, an indicator of the second BSS color identifier, and/or one or more current network parameters associated with the second user device 318A (e.g., a current signal strength (e.g., RSSI) of communication between the second user device 318A and the second network device 304A, a current signal-to-noise ratio (SNR) for the communication between the second user device 318A and the second network device 304A, and/or one or more forms of current channel state information, such as the current amplitude attenuation for the second user device 318A.

The second network device 304A may determine if the second network device 304A needs to change the first BSS color identifier associated with the second network device 304A and/or the second network 302A. For example, this determination may be based on the indication of the color collision from the second user device 318A and/or the determination that the first BSS color identifier is the same as the second BSS color identifier. For example, the determination may be based on whether the second user device 318A moved from a first location to a second location prior to sending the indication of the color collision to the second network device 304A.

At 630, a determination may be made that the first user device 332A moved. For example, the determination may be made by the first network device 304B. For example, the first network device 304B may determine that the first user device 332A moved prior to the first user device sending the indication of the color collision. For example, the first network device 304B may determine if the first user device 332A moved based on one or more of the one or more network parameters received with the indication of the color collision by the first network device 304B. For example, the first network device 304B may determine a prior or historical value for the one or more network parameters for the first user device 332A. The prior or historical value for the one or more network parameters for the first user device 332A may be accessed or received from a database or memory local or remote from the first network device 304B. For example, the prior or historical value for the one or more network parameters may be associated with a communication between the first network device 304B and the first user device 332A prior to the first user device 332A sending the indication of the color collision (e.g., the most recent communication from the first user device 332A to the access point 304B prior to the indication of the color collision being sent). For example, the first network device 304B may determine a current value for the one or more network parameters for the first user device 332A. For example, the current value for the one or more network parameters may be determined from the indication of the color collision or another recent communication from the first user device 332A to the first network device 304B.

The first network device 304B may compare the one of the one or more current network parameters for the user device 332A to a corresponding one of the one or more historical network parameters for the first user device 332A to determine a difference between the current network parameter and the historical network parameter. The first network device 304B may compare the difference between the current network parameter and the historical network parameter to a first parameter threshold to determine if the difference between the current network parameter and the historical network parameter satisfies the first parameter threshold (e.g., is greater than or greater than or equal to the first parameter threshold). The first network device 304B may compare the difference between the current network parameter and the historical network parameter to a second parameter threshold to determine if the difference between the current network parameter and the historical network parameter satisfies the second parameter threshold (e.g., is less than or less than or equal to the second parameter threshold). The first network device 304B may determine that the difference between the current network parameter and the historical network parameter satisfies first parameter threshold. Based on the difference between the current network parameter and the historical network parameter satisfying the first parameter threshold, the first network device 304B may determine the first user device 332A moved from the first location (as shown in FIG. 3) to a second location (as shown in FIG. 5) prior (e.g., within the previous 1, 3, 5, 10, 20 or any other number of minutes) to the first user device 332A sending the indication of the color collision to the first network device 304B. For example, the first network device 304B may determine if the first user device 332A did or did not move prior to sending the indication of the color collision based on a plurality of network parameters (e.g., 2, 3, 4, or more) of the one or more network parameters associated with the first user device 332A having differences (as described above) between current and historical values that do satisfy a corresponding first parameter threshold for each of those particular network parameters.

For example, the one or more network parameters may comprise a signal strength (e.g., RSSI) associated with a communication between the first user device 332A and the first network device 304B. The first network device 304B may compare the current signal strength for the first user device 332A to the historical signal strength for the first user device 332A to determine a difference between the current signal strength and the historical signal strength (e.g., a signal strength difference). The first network device 304B may compare the difference between the current signal strength and the historical signal strength to the first signal strength threshold to determine if the difference satisfies the first signal strength threshold (e.g., is greater than or greater than or equal to the first signal strength threshold). For example, the first signal strength threshold may be 5 dBm. The first signal strength threshold may be any other amount greater or less than 5 dBm in other examples. The first network device 304B may determine the difference between the current signal strength and the historical signal strength satisfies the first signal strength threshold. Based on the difference between the current signal strength and the historical signal strength satisfying the first signal strength threshold, the first network device 304B may determine the first user device 332A did move from the first location to the second location prior (e.g., within the previous 1, 3, 5, 10, 20 or any other number of minutes) to the first user device 332A sending the indication of the color collision.

For example, the one or more network parameters may comprise a signal-to-noise ratio (SNR) associated with a communication between the first user device 332A and the first network device 304B. The first network device 304B may compare the current SNR for the first user device 332A to the historical SNR for the first user device 332A to determine a difference between the current SNR and the historical SNR (e.g., a SNR difference). The first network device 304B may compare the difference between the current SNR and the historical SNR to a first SNR threshold to determine if the difference satisfies the first SNR threshold (e.g., is greater than or greater than or equal to the first SNR threshold). For example, the first SNR threshold may be 5 dB (e.g., a 5 dB decrease in SNR). The first SNR threshold may be any other amount greater or less than 5 dB in other examples. The first network device 304B may determine at least the difference between the current SNR and the historical SNR satisfies the first SNR threshold. Based on the difference between the current SNR and the historical SNR satisfying the first SNR threshold, the first network device 304B may determine the first user device 332A moved from the first location to the second location prior (e.g., within the previous 1, 3, 5, 10, 20 or any other number of minutes) to the first user device 332A sending the indication of the color collision.

For example, the first network device 304B may determine one or both of at least the difference between the current SNR and the historical SNR satisfies the first SNR threshold, and at least the difference between the current signal strength and the historical signal strength satisfies the first signal strength threshold. Based on one or both of the difference between the current SNR and the historical SNR satisfying the first SNR threshold, and at least the difference between the current signal strength and the historical signal strength satisfying the first signal strength threshold, the first network device 304B may determine the first user device 332A moved from the first location to the second location prior (e.g., within the previous 1, 3, 5, 10, 20 or any other number of minutes) to the first user device 332A sending the indication of the color collision.

For example, the one or more network parameters may comprise amplitude attenuation or other channel state information associated with a communication between the first user device 332A and the first network device 304B. The first network device 304B may compare the current amplitude attenuation for the first user device 332A to the historical amplitude attenuation for the first user device 332A to determine a difference between the current amplitude attenuation and the historical amplitude attenuation (e.g., an attenuation difference). The first network device 304B may compare the difference between the current amplitude attenuation and the historical amplitude attenuation to a first amplitude attenuation threshold to determine if the difference satisfies the first amplitude attenuation threshold (e.g., is greater than or greater than or equal to the first amplitude attenuation threshold). For example, the first amplitude attenuation threshold may be 3 decibels (dB). The first amplitude attenuation threshold may be any other amount greater or less than 3 dB in other examples.

The first network device 304B may determine at least the difference between the current amplitude attenuation and the historical amplitude attenuation satisfies the first attenuation threshold. Based on the difference between the current amplitude attenuation and the historical amplitude attenuation satisfying the first attenuation threshold, the first network device 304B may determine the first user device 332A moved from the first location to the second location prior (e.g., within the previous 1, 3, 5, 10, 20 or any other number of minutes) to the first user device 332A sending the indication of the color collision.

The first network device 304B may determine one or more of at least the difference between the current SNR and the historical SNR satisfies the first SNR threshold, at least the difference between the current signal strength and the historical signal strength satisfies the first signal strength threshold, and at least the difference between the current amplitude attenuation and the historical amplitude attenuation satisfies the first amplitude attenuation threshold. Based on one or more of the difference between the current SNR and the historical SNR satisfying the first SNR threshold, at least the difference between the current signal strength and the historical signal strength satisfying the first signal strength threshold, and the difference between the current amplitude attenuation and the historical amplitude attenuation satisfying the first amplitude attenuation threshold, the first network device 304B may determine the first user device 332A moved from the first location to the second location prior (e.g., within the previous 1, 3, 5, 10, 20 or any other number of minutes) to the first user device 332A sending the indication of the color collision.

At 640, a determination may be made that the second user device 318A did not move. For example, the determination may be made by the second network device 304A. For example, the second network device 304A may determine that the second user device 318A did not move prior to the second user device 318A sending the indication of the color collision. For example, the second network device 304A may determine the second user device 318A did not move based on one or more of the one or more network parameters received with the indication of the color collision by the second network device 304A. For example, the one or more network parameters may comprise one or more of a signal strength (e.g., RSSI) of communication between the second user device 318A and the second network device 304A, a signal-to-noise ratio (SNR) for the communication between the second user device 318A and the second network device 304A, and/or one or more forms of channel state information (e.g., amplitude attenuation).

For example, the second network device 304A may determine a prior or historical value for the one or more network parameters for the second user device 318A. The prior or historical value for the one or more network parameters for the second user device 318A may be accessed or received from a database or memory local or remote from the access point 304A. For example, the prior or historical value for the one or more network parameters may be associated with a communication between the second network device 304A and the second user device 318A prior to the second user device 318A sending the indication of the color collision (e.g., the most recent communication from the second user device 318A to the second network device 304A prior to the indication of the color collision being sent). For example, the second network device 304A may determine a current value for the one or more network parameters for the second user device 318A. For example, the current value for the one or more network parameters may be determined from the indication of the color collision or another recent communication from the second user device 318A.

The second network device 304A may compare the one of the one or more current network parameters for the second user device 318A to a corresponding one of the one or more historical network parameters for the second user device 318A to determine a difference between the current network parameter and the historical network parameter. The second network device 304A may compare the difference between the current network parameter and the historical network parameter to a first parameter threshold to determine if the difference between the current network parameter and the historical network parameter satisfies the first parameter threshold (e.g., is greater than or greater than or equal to the first parameter threshold). The second network device 304A may compare the difference between the current network parameter and the historical network parameter to a second parameter threshold to determine if the difference between the current network parameter and the historical network parameter satisfies the second parameter threshold (e.g., is less than or less than or equal to the second parameter threshold). For example, the second network device 304A may determine the second user device 318A did not move prior to the second user device 318A sending the indication of the color collision if the difference between the current network parameter and the historical network parameter does not satisfy the first parameter threshold. For example, the second network device 304A may determine the second user device 318A did not move prior to the second user device 318A sending the indication of the color collision if the difference between the current network parameter and the historical network parameter does not satisfy the first parameter threshold and the difference between the current network parameter and the historical network parameter does satisfy the second parameter threshold. For example, each of the one or more network parameters may have a first parameter threshold that is the same or different from the first parameter threshold for other network parameters. For example, each of the one or more network parameters may also have a second parameter threshold that is the same or different from the second parameter threshold for the other network parameters. The second network device 304A may determine at least the difference between the current network parameter and the historical network parameter does not satisfy the first parameter threshold and optionally does satisfy the second parameter threshold.

Based on the difference between the current network parameter and the historical network parameter not satisfying the first parameter threshold and optionally satisfying the second parameter threshold, the second network device 304A may determine the second user device 318A did not move from one location to another location prior (e.g., within the previous 1, 3, 5, 10, 20 or any other number of minutes) to the second user device 318A sending the indication of the color collision. For example, the second network device 304A may determine the second user device 318 did not move prior to sending the indication of the color collision based on a plurality of network parameters (e.g., 2, 3, 4, or more) of the one or more network parameters associated with the second user device 318A having differences (as described above) between current and historical values that do not satisfy a corresponding first parameter threshold and/or that satisfy a corresponding second parameter threshold for each of those particular network parameters.

For example, the one or more network parameters may comprise a signal strength (e.g., RSSI) associated with a communication between the second user device 318A and the second network device 304A. The second network device 304A may compare the current signal strength for the second user device 318A to the historical signal strength for the second user device 318A to determine a difference between the current signal strength and the historical signal strength (e.g., a signal strength difference). The second network device 304A may compare the difference between the current signal strength and the historical signal strength to the first signal strength threshold to determine if the difference satisfies the first signal strength threshold (e.g., is greater than or greater than or equal to the first signal strength threshold). The second network device 304A may compare the difference between the current signal strength and the historical signal strength to a second signal strength threshold to determine if the difference satisfies the second signal strength threshold (e.g., is less than or less than or equal to the second signal strength threshold). For example, the second signal strength threshold may be 2 dBm. The second signal strength threshold may be any other amount greater or less than 2 dBm in other examples. The second network device 304A may determine at least the difference between the current signal strength and the historical signal strength does not satisfy the first signal strength threshold and optionally does satisfy the second signal strength threshold. Based on the difference between the current signal strength and the historical signal strength not satisfying the first signal strength threshold and optionally satisfying the second signal strength threshold, the second network device 304A may determine the second user device 318A did not move from one location to another location prior (e.g., within the previous 1, 3, 5, 10, 20 or any other number of minutes) to the second user device 318A sending the indication of the color collision. The second network device 304A may determine that the second network device 304A will not change the BSS color identifier (e.g., the second BSS color identifier) associated with the second network device 304A and/or the second network 302A based on the difference between the current signal strength and the historical signal strength not satisfying the first signal strength threshold and optionally satisfying the second signal strength threshold.

For example, the one or more network parameters may comprise a signal-to-noise ratio (SNR) associated with a communication between the second user device 318A and the second network device 304A. The second network device 304A may compare the current SNR for the second user device 318A to the historical SNR for the second user device 318A to determine a difference between the current SNR and the historical SNR (e.g., a SNR difference). The second network device 304A may compare the difference between the current SNR and the historical SNR to the first SNR threshold to determine if the difference satisfies the first SNR threshold (e.g., is greater than or greater than or equal to the first SNR threshold). The second network device 304A may compare the difference between the current SNR and the historical SNR to a second SNR threshold to determine if the difference satisfies the second SNR threshold (e.g., is less than or less than or equal to the second SNR threshold). For example, the second SNR threshold may be 2 dB. The second SNR threshold may be any other amount greater or less than 2 dB in other examples. The second network device 304A may determine at least the difference between the current SNR and the historical SNR does not satisfy the first SNR threshold and optionally does satisfy the second SNR threshold. Based on the difference between the current SNR and the historical SNR not satisfying the first SNR threshold and optionally satisfying the second SNR threshold, the second network device 304A may determine the second user device 318A did not move from one location to another location prior (e.g., within the previous 1, 3, 5, 10, 20 or any other number of minutes) to the second user device 318A sending the indication of the color collision. The second network device 304A may determine that the second network device 304A will not change the BSS color identifier (e.g., the second BSS color identifier) associated with the second network device 304A and/or the second network 302A based on the difference between the current SNR and the historical SNR not satisfying the first SNR threshold and optionally satisfying the second SNR threshold.

The access point 304A may determine one or both of at least the difference between the current SNR and the historical SNR does not satisfy the first SNR threshold and optionally does satisfy the second SNR threshold, and at least the difference between the current signal strength and the historical signal strength does not satisfy the first signal strength threshold and optionally does satisfy the second signal strength threshold. Based on one or both of the difference between the current SNR and the historical SNR not satisfying the first SNR threshold and optionally satisfying the second SNR threshold, and at least the difference between the current signal strength and the historical signal strength not satisfying the first signal strength threshold and optionally satisfying the second signal strength threshold, the second network device 304A may determine the second user device 318A did not move from one location to another location prior (e.g., within the previous 1, 3, 5, 10, 20 or any other number of minutes) to the second user device 318A sending the indication of the color collision. The second network device 304A may determine that the second network device 304A will not change the BSS color identifier (e.g., the second BSS color identifier) associated with the second network device 304A and/or the second network 302A based on one or both of the difference between the current signal strength and the historical signal strength not satisfying the first signal strength threshold and optionally satisfying the second signal strength threshold, and the difference between the current SNR and the historical SNR not satisfying the first SNR threshold and optionally satisfying the second SNR threshold.

For example, the one or more network parameters may comprise amplitude attenuation or other channel state information associated with a communication between the second user device 318A and the second network device 304A. The second network device 304A may compare the current amplitude attenuation for the second user device 318A to the historical amplitude attenuation for the second user device 318A to determine a difference between the current amplitude attenuation and the historical amplitude attenuation (e.g., an attenuation difference). The second network device 304A may compare the difference between the current amplitude attenuation and the historical amplitude attenuation to the first amplitude attenuation threshold to determine if the difference satisfies the first amplitude attenuation threshold (e.g., is greater than or greater than or equal to the first amplitude attenuation threshold). The second network device 304A may compare the difference between the current amplitude attenuation and the historical amplitude attenuation to a second amplitude attenuation threshold to determine if the difference satisfies the second amplitude attenuation threshold (e.g., is less than or less than or equal to the second amplitude attenuation threshold). For example, the second amplitude attenuation threshold may be 1 dB. The second amplitude attenuation threshold may be any other amount greater or less than 1 dB in other examples. For example, the second network device 304A may determine the second user device 318A did not move prior to the second user device 318A sending the indication of the color collision if the difference between the current amplitude attenuation and the historical amplitude attenuation does not satisfy the first amplitude attenuation threshold. For example, the second network device 304A may determine the second user device 318A did not move prior to the second user device 318A sending the indication of the color collision if the difference between the current amplitude attenuation and the historical amplitude attenuation does not satisfy the first amplitude attenuation threshold and the difference between the current amplitude attenuation and the historical amplitude attenuation does satisfy the second amplitude attenuation threshold.

The second network device 304A may determine one or more of at least the difference between the current SNR and the historical SNR does not satisfy the first SNR threshold and optionally does satisfy the second SNR threshold, at least the difference between the current signal strength and the historical signal strength does not satisfy the first signal strength threshold and optionally does satisfy the second signal strength threshold, and at least the difference between the current amplitude attenuation and the historical amplitude attenuation does not satisfy the first amplitude attenuation threshold and optionally does satisfy the second amplitude attenuation threshold. Based on one or more of the difference between the current SNR and the historical SNR not satisfying the first SNR threshold and optionally satisfying the second SNR threshold, at least the difference between the current signal strength and the historical signal strength not satisfying the first signal strength threshold and optionally satisfying the second signal strength threshold, and the difference between the current amplitude attenuation and the historical amplitude attenuation not satisfying the first amplitude attenuation threshold and optionally satisfying the second amplitude attenuation threshold, the second network device 304A may determine the second user device 318A did not move from one location to another location prior (e.g., within the previous 1, 3, 5, 10, 20 or any other number of minutes) to the second user device 318A sending the indication of the color collision. The second network device 304A may determine that the second network device 304A will maintain or will not change the BSS color identifier (e.g., the second BSS color identifier) associated with the second network device 304A and/or the second network 302A based on one or more of the difference between the current signal strength and the historical signal strength not satisfying the first signal strength threshold and optionally satisfying the second signal strength threshold, the difference between the current SNR and the historical SNR not satisfying the first SNR threshold and optionally satisfying the second SNR threshold, and the difference between the current amplitude attenuation and the historical amplitude attenuation not satisfying the first signal strength threshold and optionally satisfying the second amplitude attenuation threshold.

At 650, the first BSS color identifier associated with the first network device 304B may be changed to a third BSS color identifier. For example, the BSS color identifier may be changed by the first network device 304B. For example, the third BSS color identifier may be different from the first BSS color identifier and the second BSS color identifier. For example, the first BSS color identifier may be changed based on the determination that the first user device 332A moved prior to sending the indication of the BSS color collision to the first network device 304B. Based on the change from the first BSS color identifier to the third BSS color identifier, the first network device 304B may send an indication of the third BSS color identifier associated with the first network device 304B to the first user device 332A and any other user devices communicating with the first network device 304B.

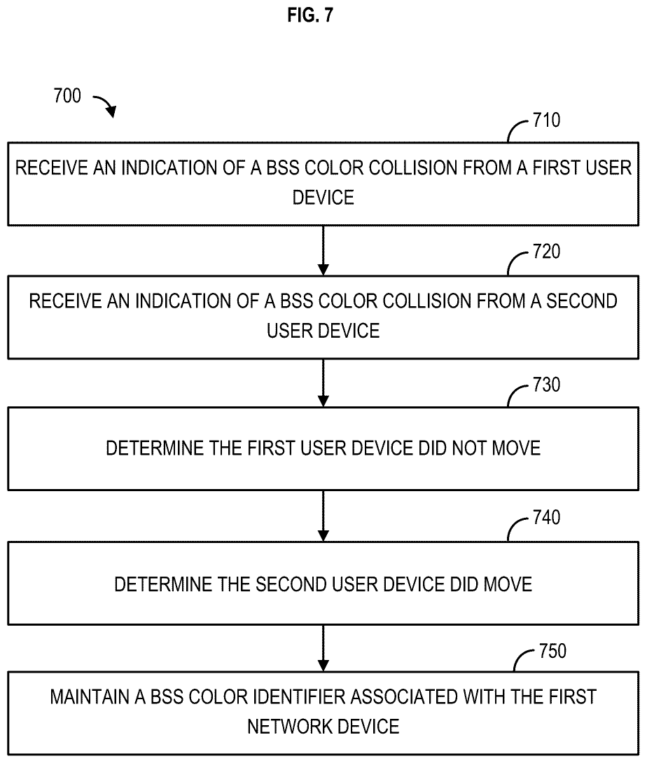

FIG. 7 shows an example method 700 for determining actions to take during a BSS color collision. The method 700 may be completed by any of the computing devices of FIGS. 1, 3, and 5. For example, the method 700 may be completed by one or more network devices, such as the access points 304A-B. For example, each of the first network device 304A and the second network device 304B may determine each network device's initial BSS color identifier in the manner described in FIG. 4 above.

At 710, an indication of a BSS color collision may be received from a first user device 318A. For example, the indication may be sent by the first user device 318A and may be received by a first network device (e.g., the access point 304A). For example, the first network device 304A may provide the first wireless network coverage area 302A and the first user device 318A may be within the first wireless network coverage area 302A. For example, the first user device 318A may receive or detect communication from a second user device 332A. The communication may or may not have been intended for the first user device 318A. For example, the second user device 332A may be communicating with a second network device 304B and be within a second wireless network coverage area 302B, and the first user device 318A may be communicating with a first network device 304A. However, the second user device 332A and the first user device 318A may be in an overlapping region (e.g., overlapping region 336) with one another, such that each user device 318A, 332A may receive or detect communications from the other user device 318A, 332A. Based on receiving or detecting the communication from the second user device 332A, the first user device 318A may determine a second BSS color identifier within that communication and associated with the second network device 304B and/or the second network 302B. The first user device 318A may know the first BSS color identifier associated with the first network device 304A and/or the first network 302A. The first user device 318A may determine the first BSS color identifier and the second BSS color identifier are the same BSS color identifier and send an indication of the BSS color collision to the first network device 304A.

For example, the indication sent by the first user device 318A to the first network device 304A may comprise a message indicating the BSS color collision. For example, the message may be or comprise an autonomous report that is sent by the first user device 318A to first network device 304A indicating the BSS color collision. For example, the autonomous report may comprise BSS color identifiers for one or more (e.g., all) other network devices and/or networks (e.g., the second network device 304B) from which the first user device 318A is able to detect frames (e.g., via the second user device 332A) in order to assist or help the first network device 304A to determine a new BSS color identifier when the first network device 304A determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the second network device 304B) that the first user device 318A is able to detect, for example through communication with second user device 332A. The autonomous report or another message sent by the first user device 318A to the first network device 304A may include one or more of an identifier of the second user device 332A (e.g., a MAC address), an identifier of the second network device 304B (e.g., a MAC address), an identifier of the second network 302B (e.g., a service set identifier (SSID)), an indicator of the second BSS color identifier, an indicator of the first BSS color identifier, and/or one or more current network parameters associated with the first user device 318A (e.g., a current signal strength (e.g., RSSI) of communication between the first user device 318A and the first network device 304A, a current signal-to-noise ratio (SNR) for the communication between the first user device 318A and the first network device 304A, and/or one or more forms of current channel state information, such as the current amplitude attenuation for the first user device 318A.

The first network device 304A may determine if the first network device 304A needs to change the first BSS color identifier associated with the first network device 304B and/or the first network 302A. For example, this determination may be based on the indication of the color collision from the first user device 318A and/or the determination that the first BSS color identifier is the same as the second BSS color identifier. For example, the determination may be based on whether the first user device 318A moved from a first location to a second location prior to sending the indication of the color collision to the first network device 304A.

At 720, an indication of a BSS color collision may be received from a second user device. For example, the indication may be sent by the second user device 332A and may be received by a second network device (e.g., the access point 304B). For example, the second network device 304B may provide second wireless network coverage area 302B and the second user device 332A may be within the second wireless network coverage area 302B. For example, the second user device 332A may receive or detect communication from another user device (e.g., the first user device 318A). The communication may or may not have been intended for the second user device 332A. Based on receiving or detecting the communication from the first user device 318A, the second user device 332A may determine the first BSS color identifier within that communication and associated with the first network device 304A and/or the first network 302A. The second user device 332A may know the second BSS color identifier associated with the second network device 304B and/or the second network 302B.

The second user device 332A may determine the first BSS color identifier and the second BSS color identifier are the same BSS color identifier and send an indication of the BSS color collision to the second network device 304B. For example, the indication sent by the second user device 332A to the second network device 304B may comprise a message indicating the BSS color collision. For example, the message may be or comprise an autonomous report that is sent by the second user device 332A to the second network device 304B indicating the BSS color collision. For example, the autonomous report may comprise BSS color identifiers for one or more (e.g., all) other network devices and/or networks (e.g., the first network device 304A) from which the second user device 332A is able to detect frames (e.g., via communication with the first user device 318A) in order to assist or help the second network device 304B to determine a new BSS color identifier when the second network device 304B determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the first network device 304A) that the second user device 332A is able to detect, for example through communication with the first user device 318A. The autonomous report or another message sent by the second user device 332A to the second network device 304B may include one or more of an identifier of the first user device 318A (e.g., a MAC address), an identifier of the first network device 304A (e.g., a MAC address), an identifier of the first network 302A (e.g., a service set identifier (SSID)), an indicator of the first BSS color identifier, an indicator of the second BSS color identifier, and/or one or more current network parameters associated with the second user device 332A (e.g., a current signal strength (e.g., RSSI) of communication between the second user device 332A and the second network device 304B, a current signal-to-noise ratio (SNR) for the communication between the second user device 332A and the second network device 304B, and/or one or more forms of current channel state information, such as the current amplitude attenuation for the second user device 332A.

At 730, a determination may be made that the first user device 318A did not move. For example, the determination may be made by the first network device 304A. For example, the first network device 304A may determine that the first user device 318A did not move prior to the first user device 318A sending the indication of the color collision. For example, the first network device 304A may determine the first user device 318A did not move based on one or more of the one or more network parameters received with the indication of the color collision by the first network device 304A. For example, the one or more network parameters may comprise one or more of a signal strength (e.g., RSSI) of communication between the first user device 318A and the first network device 304A, a signal-to-noise ratio (SNR) for the communication between the first user device 318A and the first network device 304A, and/or one or more forms of channel state information (e.g., amplitude attenuation).

For example, the first network device 304A may determine a prior or historical value for the one or more network parameters for the first user device 318A. The prior or historical value for the one or more network parameters for the first user device 318A may be accessed or received from a database or memory local or remote from the first network device 304A. For example, the prior or historical value for the one or more network parameters may be associated with a communication between the first network device 304A and the first user device 318A prior to the first user device 318A sending the indication of the color collision (e.g., the most recent communication from the first user device 318A to the first network device 304A prior to the indication of the color collision being sent). For example, the first network device 304A may determine a current value for the one or more network parameters for the first user device 318A. For example, the current value for the one or more network parameters may be determined from the indication of the color collision or another recent communication from the first user device 318A.

The first network device 304A may compare the one of the one or more current network parameters for the first user device 318A to a corresponding one of the one or more historical network parameters for the first user device 318A to determine a difference between the current network parameter and the historical network parameter. The first network device 304A may compare the difference between the current network parameter and the historical network parameter to a first parameter threshold to determine if the difference between the current network parameter and the historical network parameter satisfies the first parameter threshold (e.g., is greater than or greater than or equal to the first parameter threshold). The first network device 304A may compare the difference between the current network parameter and the historical network parameter to a second parameter threshold to determine if the difference between the current network parameter and the historical network parameter satisfies the second parameter threshold (e.g., is less than or less than or equal to the second parameter threshold). For example, the first network device 304A may determine the first user device 318A did not move prior to the first user device 318A sending the indication of the color collision if the difference between the current network parameter and the historical network parameter does not satisfy the first parameter threshold. For example, the first network device 304A may determine the first user device 318A did not move prior to the first user device 318A sending the indication of the color collision if the difference between the current network parameter and the historical network parameter does not satisfy the first parameter threshold and the difference between the current network parameter and the historical network parameter does satisfy the second parameter threshold. For example, each of the one or more network parameters may have a first parameter threshold that is the same or different from the first parameter threshold for other network parameters. For example, each of the one or more network parameters may also have a second parameter threshold that is the same or different from the second parameter threshold for the other network parameters. The first network device 304A may determine at least the difference between the current network parameter and the historical network parameter does not satisfy the first parameter threshold and optionally does satisfy the second parameter threshold.

Based on the difference between the current network parameter and the historical network parameter not satisfying the first parameter threshold and optionally satisfying the second parameter threshold, the first network device 304A may determine the first user device 318A did not move from one location to another location prior (e.g., within the previous 1, 3, 5, 10, 20 or any other number of minutes) to the first user device 318A sending the indication of the color collision. For example, the first network device 304A may determine the first user device 318 did not move prior to sending the indication of the color collision based on a plurality of network parameters (e.g., 2, 3, 4, or more) of the one or more network parameters associated with the first user device 318A having differences (as described above) between current and historical values that do not satisfy a corresponding first parameter threshold and/or that satisfy a corresponding second parameter threshold for each of those particular network parameters.

For example, the one or more network parameters may comprise a signal strength (e.g., RSSI) associated with a communication between the first user device 318A and the first network device 304A. The first network device 304A may compare the current signal strength for the first user device 318A to the historical signal strength for the first user device 318A to determine a difference between the current signal strength and the historical signal strength (e.g., a signal strength difference). The first network device 304A may compare the difference between the current signal strength and the historical signal strength to the first signal strength threshold to determine if the difference satisfies the first signal strength threshold (e.g., is greater than or greater than or equal to the first signal strength threshold). For example, the first signal strength threshold may be 5 dBm. The first signal strength threshold may be any other amount greater or less than 5 dBm in other examples. The first network device 304A may compare the difference between the current signal strength and the historical signal strength to a second signal strength threshold to determine if the difference satisfies the second signal strength threshold (e.g., is less than or less than or equal to the second signal strength threshold). For example, the second signal strength threshold may be 2 dBm. The second signal strength threshold may be any other amount greater or less than 2 dBm in other examples. The first network device 304A may determine at least the difference between the current signal strength and the historical signal strength does not satisfy the first signal strength threshold and optionally does satisfy the second signal strength threshold. Based on the difference between the current signal strength and the historical signal strength not satisfying the first signal strength threshold and optionally satisfying the second signal strength threshold, the first network device 304A may determine the first user device 318A did not move from one location to another location prior (e.g., within the previous 1, 3, 5, 10, 20 or any other number of minutes) to the first user device 318A sending the indication of the color collision.

For example, the one or more network parameters may comprise a signal-to-noise ratio (SNR) associated with a communication between the first user device 318A and the first network device 304A. The first network device 304A may compare the current SNR for the first user device 318A to the historical SNR for the first user device 318A to determine a difference between the current SNR and the historical SNR (e.g., a SNR difference). The first network device 304A may compare the difference between the current SNR and the historical SNR to the first SNR threshold to determine if the difference satisfies the first SNR threshold (e.g., is greater than or greater than or equal to the first SNR threshold). For example, the first SNR threshold may be 5 dB (e.g., a 5 dB decrease in SNR). The first SNR threshold may be any other amount greater or less than 5 dB in other examples. The first network device 304A may compare the difference between the current SNR and the historical SNR to a second SNR threshold to determine if the difference satisfies the second SNR threshold (e.g., is less than or less than or equal to the second SNR threshold). For example, the second SNR threshold may be 2 dB. The second SNR threshold may be any other amount greater or less than 2 dB in other examples. The first network device 304A may determine at least the difference between the current SNR and the historical SNR does not satisfy the first SNR threshold and optionally does satisfy the second SNR threshold. Based on the difference between the current SNR and the historical SNR not satisfying the first SNR threshold and optionally satisfying the second SNR threshold, the first network device 304A may determine the first user device 318A did not move from one location to another location prior (e.g., within the previous 1, 3, 5, 10, 20 or any other number of minutes) to the first user device 318A sending the indication of the color collision.

The first network device 304A may determine one or both of at least the difference between the current SNR and the historical SNR does not satisfy the first SNR threshold and optionally does satisfy the second SNR threshold, and at least the difference between the current signal strength and the historical signal strength does not satisfy the first signal strength threshold and optionally does satisfy the second signal strength threshold. Based on one or both of the difference between the current SNR and the historical SNR not satisfying the first SNR threshold and optionally satisfying the second SNR threshold, and at least the difference between the current signal strength and the historical signal strength not satisfying the first signal strength threshold and optionally satisfying the second signal strength threshold, the first network device 304A may determine the first user device 318A did not move from one location to another location prior (e.g., within the previous 1, 3, 5, 10, 20 or any other number of minutes) to the first user device 318A sending the indication of the color collision.

For example, the one or more network parameters may comprise amplitude attenuation or other channel state information associated with a communication between the first user device 318A and the first network device 304A. The first network device 304A may compare the current amplitude attenuation for the first user device 318A to the historical amplitude attenuation for the first user device 318A to determine a difference between the current amplitude attenuation and the historical amplitude attenuation (e.g., an attenuation difference). The first network device 304A may compare the difference between the current amplitude attenuation and the historical amplitude attenuation to the first amplitude attenuation threshold to determine if the difference satisfies the first amplitude attenuation threshold (e.g., is greater than or greater than or equal to the first amplitude attenuation threshold). For example, the first amplitude attenuation threshold may be 3 decibels (dB). The first amplitude attenuation threshold may be any other amount greater or less than 3 dB in other examples. The first network device 304A may compare the difference between the current amplitude attenuation and the historical amplitude attenuation to a second amplitude attenuation threshold to determine if the difference satisfies the second amplitude attenuation threshold (e.g., is less than or less than or equal to the second amplitude attenuation threshold). For example, the second amplitude attenuation threshold may be 1 dB. The second amplitude attenuation threshold may be any other amount greater or less than 1 dB in other examples. For example, the first network device 304A may determine the first user device 318A did not move prior to the first user device 318A sending the indication of the color collision if the difference between the current amplitude attenuation and the historical amplitude attenuation does not satisfy the first amplitude attenuation threshold. For example, the first network device 304A may determine the first user device 318A did not move prior to the first user device 318A sending the indication of the color collision if the difference between the current amplitude attenuation and the historical amplitude attenuation does not satisfy the first amplitude attenuation threshold and the difference between the current amplitude attenuation and the historical amplitude attenuation does satisfy the second amplitude attenuation threshold.

The first network device 304A may determine one or more of at least the difference between the current SNR and the historical SNR does not satisfy the first SNR threshold and optionally does satisfy the second SNR threshold, at least the difference between the current signal strength and the historical signal strength does not satisfy the first signal strength threshold and optionally does satisfy the second signal strength threshold, and at least the difference between the current amplitude attenuation and the historical amplitude attenuation does not satisfy the first amplitude attenuation threshold and optionally does satisfy the second amplitude attenuation threshold. Based on one or more of the difference between the current SNR and the historical SNR not satisfying the first SNR threshold and optionally satisfying the second SNR threshold, at least the difference between the current signal strength and the historical signal strength not satisfying the first signal strength threshold and optionally satisfying the second signal strength threshold, and the difference between the current amplitude attenuation and the historical amplitude attenuation not satisfying the first amplitude attenuation threshold and optionally satisfying the second amplitude attenuation threshold, the first network device 304A may determine the first user device 318A did not move from one location to another location prior (e.g., within the previous 1, 3, 5, 10, 20 or any other number of minutes) to the first user device 318A sending the indication of the color collision.

At 740, a determination may be made that the second user device 332A moved. For example, the determination may be made by the second network device 304B. For example, the second network device 304B may determine that the second user device 332A moved prior to the second user device 332A sending the indication of the color collision. For example, the second network device 304B may determine if the second user device 332A moved based on one or more of the one or more network parameters received with the indication of the color collision by the second network device 304B. For example, the second network device 304B may determine a prior or historical value for the one or more network parameters for the second user device 332A. The prior or historical value for the one or more network parameters for the second user device 332A may be accessed or received from a database or memory local or remote from the second network device 304B. For example, the prior or historical value for the one or more network parameters may be associated with a communication between the second network device 304B and the second user device 332A prior to the second user device 332A sending the indication of the color collision (e.g., the most recent communication from the second user device 332A to the second network device 304B prior to the indication of the color collision being sent). For example, the second network device 304B may determine a current value for the one or more network parameters for the second user device 332A. For example, the current value for the one or more network parameters may be determined from the indication of the color collision or another recent communication from the second user device 332A to the second network device 304B.

The second network device 304B may compare the one of the one or more current network parameters for the second user device 332A to a corresponding one of the one or more historical network parameters for the second user device 332A to determine a difference between the current network parameter and the historical network parameter. The second network device 304B may compare the difference between the current network parameter and the historical network parameter to a first parameter threshold to determine if the difference between the current network parameter and the historical network parameter satisfies the first parameter threshold (e.g., is greater than or greater than or equal to the first parameter threshold). The second network device 304B may compare the difference between the current network parameter and the historical network parameter to a second parameter threshold to determine if the difference between the current network parameter and the historical network parameter satisfies the second parameter threshold (e.g., is less than or less than or equal to the second parameter threshold). The second network device 304B may determine that the difference between the current network parameter and the historical network parameter satisfies first parameter threshold. Based on the difference between the current network parameter and the historical network parameter satisfying the first parameter threshold, the second network device 304B may determine the second user device 332A moved from the first location (as shown in FIG. 3) to a second location (as shown in FIG. 5) prior (e.g., within the previous 1, 3, 5, 10, 20 or any other number of minutes) to the second user device 332A sending the indication of the color collision to the second network device 304B. For example, the second network device 304B may determine if the second user device 332A did or did not move prior to sending the indication of the color collision based on a plurality of network parameters (e.g., 2, 3, 4, or more) of the one or more network parameters associated with the second user device 332A having differences (as described above) between current and historical values that do satisfy a corresponding first parameter threshold for each of those particular network parameters.

The second network device 304B may determine that the second network device 304B will change the BSS color identifier (e.g., the second BSS color identifier) associated with the second network device 304B and/or the second network 302B. For example, the second network device 304B may determine to change the second BSS color identifier to a third BSS color identifier different from the first and second BSS color identifiers based on the difference between the current network parameter and the historical network parameter satisfying the first parameter threshold. Based on the change from the second BSS color identifier to the third BSS color identifier, the second network device 304B may send an indication of the third BSS color identifier associated with the second network device 304B to the second user device 332A and any other user devices communicating with the second network device 304B.

For example, the one or more network parameters may comprise a signal strength (e.g., RSSI) associated with a communication between the second user device 332A and the second network device 304B. The second network device 304B may compare the current signal strength for the second user device 332A to the historical signal strength for the second user device 332A to determine a difference between the current signal strength and the historical signal strength (e.g., a signal strength difference). The second network device 304B may compare the difference between the current signal strength and the historical signal strength to the first signal strength threshold to determine if the difference satisfies the first signal strength threshold (e.g., is greater than or greater than or equal to the first signal strength threshold). The second network device 304B may determine the difference between the current signal strength and the historical signal strength satisfies the first signal strength threshold. Based on the difference between the current signal strength and the historical signal strength satisfying the first signal strength threshold, the second network device 304B may determine the second user device 332A did move from the first location to the second location prior (e.g., within the previous 1, 3, 5, 10, 20 or any other number of minutes) to the second user device 332A sending the indication of the color collision. The second network device 304B may determine that the second network device 304B will change the BSS color identifier (e.g., the second BSS color identifier) associated with the second network device 304B and/or the second network 302B from the second BSS color identifier to a third BSS color identifier different from the first and second BSS color identifiers based on the difference between the current signal strength and the historical signal strength satisfying the first signal strength threshold. Based on the change from the second BSS color identifier to the third BSS color identifier, the second network device 304B may send an indication of the third BSS color identifier associated with the second network device 304B to the second user device 332A and any other user devices communicating with the second network device 304B.

For example, the one or more network parameters may comprise a signal-to-noise ratio (SNR) associated with a communication between the second user device 332A and the second network device 304B. The second network device 304B may compare the current SNR for the second user device 332A to the historical SNR for the second user device 332A to determine a difference between the current SNR and the historical SNR (e.g., a SNR difference). The second network device 304B may compare the difference between the current SNR and the historical SNR to a first SNR threshold to determine if the difference satisfies the first SNR threshold (e.g., is greater than or greater than or equal to the first SNR threshold). The second network device 304B may determine at least the difference between the current SNR and the historical SNR satisfies the first SNR threshold. Based on the difference between the current SNR and the historical SNR satisfying the first SNR threshold, the second network device 304B may determine the first user device 332A moved from the first location to the second location prior (e.g., within the previous 1, 3, 5, 10, 20 or any other number of minutes) to the second user device 332A sending the indication of the color collision.

For example, the second network device 304B may determine one or both of at least the difference between the current SNR and the historical SNR satisfies the first SNR threshold, and at least the difference between the current signal strength and the historical signal strength satisfies the first signal strength threshold. Based on one or both of the difference between the current SNR and the historical SNR satisfying the first SNR threshold, and at least the difference between the current signal strength and the historical signal strength satisfying the first signal strength threshold, the second network device 304B may determine the second user device 332A moved from the first location to the second location prior (e.g., within the previous 1, 3, 5, 10, 20 or any other number of minutes) to the second user device 332A sending the indication of the color collision. The second network device 304B may determine that the second network device 304B will change the BSS color identifier (e.g., the second BSS color identifier) associated with the second network device 304B and/or the second network 302B from the second BSS color identifier to a third BSS color identifier different from the first and second BSS color identifiers based on one or both of the difference between the current signal strength and the historical signal strength satisfying the first signal strength threshold, and the difference between the current SNR and the historical SNR satisfying the first SNR threshold. Based on the change from the second BSS color identifier to the third BSS color identifier, the second network device 304B may send an indication of the third BSS color identifier associated with the second network device 304B to the second user device 332A and any other user devices communicating with the second network device 304B.

For example, the one or more network parameters may comprise amplitude attenuation or other channel state information associated with a communication between the second user device 332A and the second network device 304B. The second network device 304B may compare the current amplitude attenuation for the second user device 332A to the historical amplitude attenuation for the second user device 332A to determine a difference between the current amplitude attenuation and the historical amplitude attenuation (e.g., an attenuation difference). The second network device 304B may compare the difference between the current amplitude attenuation and the historical amplitude attenuation to a first amplitude attenuation threshold to determine if the difference satisfies the first amplitude attenuation threshold (e.g., is greater than or greater than or equal to the first amplitude attenuation threshold).

The second network device 304B may determine at least the difference between the current amplitude attenuation and the historical amplitude attenuation satisfies the first attenuation threshold. Based on the difference between the current amplitude attenuation and the historical amplitude attenuation satisfying the first attenuation threshold, the second network device 304B may determine the second user device 332A moved from the first location to the second location prior (e.g., within the previous 1, 3, 5, 10, 20 or any other number of minutes) to the second user device 332A sending the indication of the color collision.

The second network device 304B may determine one or more of at least the difference between the current SNR and the historical SNR satisfies the first SNR threshold, at least the difference between the current signal strength and the historical signal strength satisfies the first signal strength threshold, and at least the difference between the current amplitude attenuation and the historical amplitude attenuation satisfies the first amplitude attenuation threshold. Based on one or more of the difference between the current SNR and the historical SNR satisfying the first SNR threshold, at least the difference between the current signal strength and the historical signal strength satisfying the first signal strength threshold, and the difference between the current amplitude attenuation and the historical amplitude attenuation satisfying the first amplitude attenuation threshold, the second network device 304B may determine the second user device 332A moved from the first location to the second location prior (e.g., within the previous 1, 3, 5, 10, 20 or any other number of minutes) to the second user device 332A sending the indication of the color collision. The second network device 304B may determine that the second network device 304B will change the BSS color identifier (e.g., the second BSS color identifier) associated with the second network device 304B and/or the second network 302B from the second BSS color identifier to a third BSS color identifier different from the first and second BSS color identifiers based on one or more of the difference between the current signal strength and the historical signal strength satisfying the first signal strength threshold, the difference between the current SNR and the historical SNR satisfying the first SNR threshold, and the difference between the current amplitude attenuation and the historical amplitude attenuation satisfying the first signal strength threshold. Based on the change from the second BSS color identifier to the third BSS color identifier, the second network device 304B may send an indication of the third BSS color identifier associated with the second network device 304B to the second user device 332A and any other user devices communicating with the second network device 304B.

At 750, the first BSS color identifier associated with the first network device 304A may be may be maintained or not changed to a different BSS color identifier. For example, the first network device 304A may determine to not change the first BSS color identifier. For example, the determination may be based on the determination that the first user device 318A did not move prior to the first user device 318A sending the indication of the color collision to the first network device 304A.

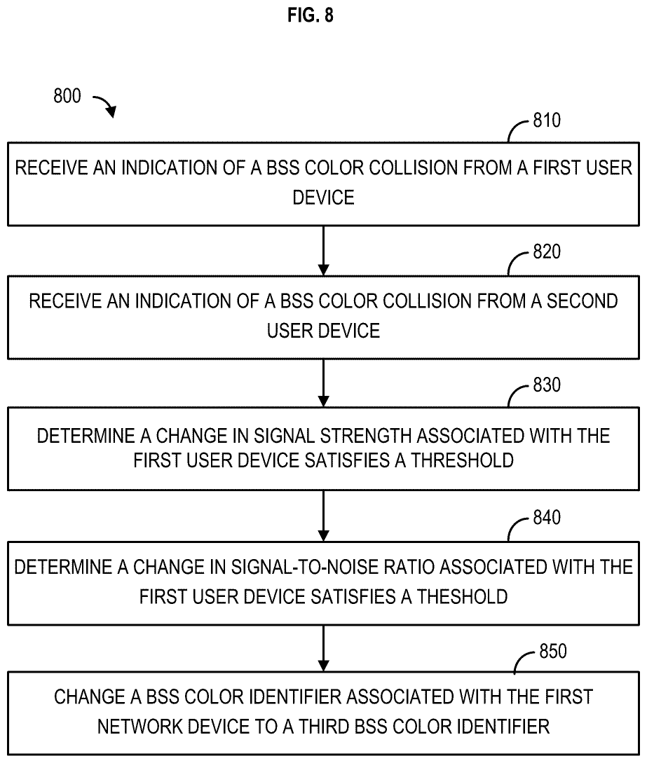

FIG. 8 shows an example method 800 for determining actions to take during a BSS color collision. The method 800 may be completed by any of the computing devices of FIGS. 1, 3, and 5. For example, the method 600 may be completed by one or more network devices, such as the access points 304A-B or the network management device 134, 334. For example, each of the first network device 304B and the second network device 304A may determine each network device's initial BSS color identifier in the manner described in FIG. 4 above.

At 810, an indication of a BSS color collision may be received from a first user device. For example, the indication may be sent by the first user device 332A and may be received by a first network device (e.g., the access point 304B). For example, the first network device 304B may provide first wireless network coverage area 302B and the first user device 332A may be within the first wireless network coverage area 302B. For example, the first user device 332A may receive or detect communication from a second user device (e.g., user device 318A). The communication may or may not have been intended for the first user device 332A. For example, the second user device 318A may be communicating with a second network device (e.g., the access point 304A) and be within a second wireless network coverage area 302A. However, the first user device 332A and the second user device 318A may be in an overlapping region (e.g., overlapping region 336) with one another, such that each user device 318A, 332A may receive or detect communications from the other user device 318A, 332A. Based on receiving or detecting the communication from the second user device 318A, the first user device 332A may determine a second BSS color identifier within that communication and associated with the second network device 304A and/or the second network 302A. The first user device 332A may know the first BSS color identifier associated with the first network device 304B and/or the first network 302B.

The first user device 332A may determine the first BSS color identifier and the second BSS color identifier are the same BSS color identifier and send the indication of a BSS color collision to the first network device 304B. For example, the indication sent by the first user device 332A to the first network device 304B may comprise a message indicating the BSS color collision. For example, the message may be or comprise an autonomous report that is sent by the first user device 332A to the first network device 304B indicating the BSS color collision. For example, the autonomous report may comprise BSS color identifiers for one or more (e.g., all) other network devices and/or networks (e.g., the second network device 304A) from which the first user device 332A is able to detect frames in order to assist or help the first network device 304B to determine a new BSS color identifier when the first network device 304B determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the second network device 304A) that the first user device 332A is able to detect, for example through communication with the second user device 318A. The autonomous report or another message sent by the first user device 332A to the first network device 304B may include one or more of an identifier of the second user device 318A (e.g., a MAC address), an identifier of the second network device 304A (e.g., a MAC address), an identifier of the second network 302A (e.g., a service set identifier (SSID)), an indicator of the first BSS color identifier, an indicator of the second BSS color identifier, and/or one or more current network parameters associated with the first user device 332A (e.g., a current signal strength (e.g., RSSI) of communication between the first user device 332A and the first network device 304B, a current signal-to-noise ratio (SNR) for the communication between the first user device 332A and the first network device 304B, and/or one or more forms of current channel state information, such as the current amplitude attenuation for the first user device 332A.

At 820, an indication of a BSS color collision may be received from the second user device 318A. For example, the indication may be sent by the second user device 318A and may be received by the second network device 304A. For example, the second network device 304A may provide second wireless network coverage area 302A and the second user device 318A may be within the second wireless network coverage area 302A. For example, the second user device 318A may receive or detect communication from first user device 332A. The communication may or may not have been intended for the second user device 318A. For example, the first user device 332A may be communicating with the first network device 304B. Based on receiving or detecting the communication from the first user device 332A, the second user device 318A may determine the first BSS color identifier within that communication and associated with the first network device 304B and/or the first network 302B. The second user device 318A may know the second BSS color identifier associated with the second network device 304A and/or the second network 302A.

The second user device 318A may determine the first BSS color identifier and the second BSS color identifier are the same BSS color identifier and send the indication of the BSS color collision to the second network device 304A. For example, the indication sent by the second user device 318A to the second network device 304A may comprise a message indicating the BSS color collision. For example, the message may be or comprise an autonomous report that is sent by the second user device 318A to second network device 304A indicating the BSS color collision. For example, the autonomous report may comprise BSS color identifiers for one or more (e.g., all) other network devices and/or networks (e.g., the first network device 304B) from which the second user device 318A is able to detect frames in order to assist or help the second network device 304A to determine a new BSS color identifier when the second network device 304A determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the first network device 304B) that the second user device 318A is able to detect, for example through communication with first user device 332A. The autonomous report or another message sent by the second user device 318A to the second network device 304A may include one or more of an identifier of the first user device 332A (e.g., a MAC address), an identifier of the first network device 304B (e.g., a MAC address), an identifier of the first network 302B (e.g., a service set identifier (SSID)), an indicator of the first BSS color identifier, an indicator of the second BSS color identifier, and/or one or more current network parameters associated with the second user device 318A (e.g., a current signal strength (e.g., RSSI) of communication between the second user device 318A and the second network device 304A, a current signal-to-noise ratio (SNR) for the communication between the second user device 318A and the second network device 304A, and/or one or more forms of current channel state information, such as the current amplitude attenuation for the second user device 318A.

The second network device 304A may determine if the second network device 304A needs to change the first BSS color identifier associated with the second network device 304A and/or the second network 302A. For example, this determination may be based on the indication of the color collision from the second user device 318A and/or the determination that the first BSS color identifier is the same as the second BSS color identifier. For example, the determination may be based on whether the second user device 318A moved from a first location to a second location prior to sending the indication of the color collision to the second network device 304A.

At 830, a change in signal strength (e.g., RSSI) associated with the first user device 332A may be determined to satisfy a first threshold (e.g., a signal strength threshold). For example, the determination may be made by the first network device 304B. For example, the first network device 304B may determine a prior or historical value for the signal strength for the first user device 332A. The prior or historical signal strength value for the first user device 332A may be accessed or received from a database or memory local or remote from the first network device 304B. For example, the prior or historical signal strength value may be associated with a communication between the first network device 304B and the first user device 332A prior to the first user device 332A sending the indication of the color collision (e.g., the most recent communication from the first user device 332A to the first network device 304B prior to the indication of the color collision being sent). For example, the first network device 304B may determine a current value for the signal strength for the first user device 332A. For example, the current signal strength value may be determined from the indication of the color collision or a communication after that between the first user device 332A and the first network device 304B.

The first network device 304B may compare the current signal strength for the first user device 332A to the historical signal strength for the first user device 332A to determine a difference between or change from the historical signal strength and the current signal strength (e.g., a signal strength difference). The first network device 304B may compare the difference or change between the historical signal strength and the current signal strength to the first signal strength threshold to determine if the difference or change satisfies the first signal strength threshold (e.g., is greater than or greater than or equal to the first signal strength threshold). For example, the first signal strength threshold may be 5 dBm. The first signal strength threshold may be any other amount greater or less than 5 dBm in other examples. The first network device 304B may determine the difference or change between the historical signal strength and the current signal strength satisfies the first signal strength threshold.

At 840, a change in signal-to-noise ratio (SNR) associated with the first user device 332A may be determined to satisfy a first threshold (e.g., a SNR threshold). For example, the determination may be made by the first network device 304B. For example, the first network device 304B may determine a prior or historical value for the SNR for the first user device 332A. The prior or historical SNR for the first user device 332A may be accessed or received from a database or memory local or remote from the first network device 304B. For example, the prior or historical SNR may be associated with a communication between the first network device 304B and the first user device 332A prior to the first user device 332A sending the indication of the color collision (e.g., the most recent communication from the first user device 332A to the first network device 304B prior to the indication of the color collision being sent). For example, the first network device 304B may determine a current value for the SNR for the first user device 332A. For example, the current SNR may be determined from the indication of the color collision or a communication after that between the first user device 332A and the first network device 304B.

The first network device 304B may compare the historical SNR for the first user device 332A to the current SNR for the first user device 332A to determine a difference between or change of the historical SNR and current SNR (e.g., a SNR difference). The first network device 304B may compare the difference or change between the historical SNR and current SNR to a first SNR threshold to determine if the difference satisfies the first SNR threshold (e.g., is greater than or greater than or equal to the first SNR threshold). For example, the first SNR threshold may be 5 dB (e.g., a 5 dB decrease in SNR). The first SNR threshold may be any other amount greater or less than 5 dB in other examples. The first network device 304B may determine at least the difference or change between the historical SNR and current SNR satisfies the first SNR threshold. Based on one or both of at least the difference or change between the historical SNR and current SNR satisfying the first SNR threshold, and the difference or change between the historical signal strength and the current signal strength satisfying the first signal strength threshold, the first network device 304B may determine the first user device 332A moved from the first location to the second location prior (e.g., within the previous 1, 3, 5, 10, 20 or any other number of minutes) to the first user device 332A sending the indication of the color collision.

At 850, the BSS color identifier associated with the first network device 304B (e.g., the first BSS color identifier) may be changed to a third BSS color identifier. For example, the change may be made by the first network device 304B. For example, the first network device 304B may determine the third BSS color identifier. For example, the third BSS color identifier may be different from the first BSS color identifier and the second BSS color identifier. The first network device 304B may change the first BSS color identifier to the third BSS color identifier based on one or both of at least the difference or change between the historical SNR and current SNR satisfying the first SNR threshold, and the difference or change between the historical signal strength and the current signal strength satisfying the first signal strength threshold. The first network device 304B may change the first BSS color identifier to the third BSS color identifier based on a determination that the first user device 332A moved from the first location to the second location prior (e.g., within the previous 1, 3, 5, 10, 20 or any other number of minutes) to the first user device 332A sending the indication of the color collision. Based on the change from the first BSS color identifier to the third BSS color identifier, the first network device 304B may send an indication of the third BSS color identifier associated with the first network device 304B to the first user device 332A and any other user devices communicating with the first network device 304B.

A change in amplitude attenuation associated with the first user device 332A may be determined to satisfy a first threshold (e.g., an amplitude attenuation threshold). For example, the determination may be made by the first network device 304B. For example, the first network device 304B may determine a prior or historical value for the amplitude attenuation for the first user device 332A. The prior or historical amplitude attenuation for the first user device 332A may be accessed or received from a database or memory local or remote from the first network device 304B. For example, the prior or historical amplitude attenuation may be associated with a communication between the first network device 304B and the first user device 332A prior to the first user device 332A sending the indication of the color collision (e.g., the most recent communication from the first user device 332A to the first network device 304B prior to the indication of the color collision being sent). For example, the first network device 304B may determine a current value for the amplitude attenuation for the first user device 332A. For example, the current amplitude attenuation may be determined from the indication of the color collision or a communication after that between the first user device 332A and the first network device 304B.

The first network device 304B may compare the historical amplitude attenuation for the first user device 332A to the current amplitude attenuation for the first user device 332A to determine a difference between or change of the historical amplitude attenuation and current amplitude attenuation (e.g., a SNR difference). The first network device 304B may compare the difference or change between the historical amplitude attenuation and current amplitude attenuation to the first amplitude attenuation threshold to determine if the difference satisfies the first amplitude attenuation threshold (e.g., is greater than or greater than or equal to the first SNR threshold). For example, the first amplitude attenuation threshold may be 3 dB. The first amplitude attenuation threshold may be any other amount greater or less than 3 dB in other examples. The first network device 304B may determine at least the difference or change between the historical amplitude attenuation and current amplitude attenuation satisfies the first amplitude attenuation threshold.

Based on one or more of the difference or change between the current SNR and the historical SNR satisfying the first SNR threshold, the difference or change between the current signal strength and the historical signal strength satisfying the first signal strength threshold, and the difference or change between the current amplitude attenuation and the historical amplitude attenuation satisfying the first amplitude attenuation threshold, the first network device 304B may determine the first user device 332A moved from the first location to the second location prior (e.g., within the previous 1, 3, 5, 10, 20 or any other number of minutes) to the first user device 332A sending the indication of the color collision. The first network device 304B may change the first BSS color identifier to the third BSS color identifier based on one or more of the difference or change between the current SNR and the historical SNR satisfying the first SNR threshold, the difference or change between the current signal strength and the historical signal strength satisfying the first signal strength threshold, and the difference or change between the current amplitude attenuation and the historical amplitude attenuation satisfying the first amplitude attenuation threshold. Based on the change from the first BSS color identifier to the third BSS color identifier, the first network device 304B may send an indication of the third BSS color identifier associated with the first network device 304B to the first user device 332A and any other user devices communicating with the first network device 304B.

For example, a determination may be made that the second user device 318A did not move prior to the second user device 318A sending the indication of the color collision. For example, the determination may be made by the second network device 304A. For example, the second network device 304A may determine the second user device 318A did not move based on one or more of the one or more network parameters received with the indication of the color collision by the second network device 304A. For example, the one or more network parameters may comprise one or more of a signal strength (e.g., RSSI) of communication between the second user device 318A and the second network device 304A, a signal-to-noise ratio (SNR) for the communication between the second user device 318A and the second network device 304A, and/or one or more forms of channel state information (e.g., amplitude attenuation).

For example, the second network device 304A may determine a prior or historical value for the signal strength for the second user device 318A. The prior or historical signal strength value for the second user device 318A may be accessed or received from a database or memory local or remote from the second network device 304A. For example, the prior or historical signal strength value may be associated with a communication between the second network device 304A and the second user device 318A prior to the second user device 318A sending the indication of the color collision (e.g., the most recent communication from the second user device 318A to the second network device 304A prior to the indication of the color collision being sent). For example, the second network device 304A may determine a current value for the signal strength for the second user device 318A. For example, the current signal strength value may be determined from the indication of the color collision or a communication after that between the second user device 318A and the second network device 304A.

The second network device 304A may compare the current signal strength for the second user device 318A to the historical signal strength for the second user device 318A to determine a change or difference between the current signal strength and the historical signal strength (e.g., a signal strength difference). The second network device 304A may compare the difference or change between the current signal strength and the historical signal strength to the first signal strength threshold to determine if the difference satisfies the first signal strength threshold (e.g., is greater than or greater than or equal to the first signal strength threshold). The second network device 304A may compare the difference or change between the current signal strength and the historical signal strength to a second signal strength threshold to determine if the difference satisfies the second signal strength threshold (e.g., is less than or less than or equal to the second signal strength threshold). For example, the second signal strength threshold may be 2 dBm. The second signal strength threshold may be any other amount greater or less than 2 dBm in other examples. The second network device 304A may determine the difference or change between the current signal strength and the historical signal strength does not satisfy the first signal strength threshold and optionally does satisfy the second signal strength threshold.

For example, the second network device 304A may determine a prior or historical value for the SNR for the second user device 318A. The prior or historical SNR for the second user device 318A may be accessed or received from a database or memory local or remote from the second network device 304A. For example, the prior or historical SNR may be associated with a communication between the second network device 304A and the second user device 318A prior to the second user device 318A sending the indication of the color collision (e.g., the most recent communication from the second user device 318A to the second network device 304A prior to the indication of the color collision being sent). For example, the second network device 304A may determine a current value for the SNR for the second user device 318A. For example, the current SNR may be determined from the indication of the color collision or a communication after that between the second user device 318A and the second network device 304A.

The second network device 304A may compare the current SNR for the second user device 318A to the historical SNR for the second user device 318A to determine a difference or change between the current SNR and the historical SNR (e.g., a SNR difference). The second network device 304A may compare the difference or change between the current SNR and the historical SNR to the first SNR threshold to determine if the difference or change satisfies the first SNR threshold (e.g., is greater than or greater than or equal to the first SNR threshold). The second network device 304A may compare the difference or change between the current SNR and the historical SNR to a second SNR threshold to determine if the difference or change satisfies the second SNR threshold (e.g., is less than or less than or equal to the second SNR threshold). For example, the second SNR threshold may be 2 dB. The second SNR threshold may be any other amount greater or less than 2 dB in other examples. The second network device 304A may determine at least the difference between the current SNR and the historical SNR does not satisfy the first SNR threshold and optionally does satisfy the second SNR threshold.

Based on one or both of the difference between the current SNR and the historical SNR not satisfying the first SNR threshold and optionally satisfying the second SNR threshold, and the difference between the current signal strength and the historical signal strength not satisfying the first signal strength threshold and optionally satisfying the second signal strength threshold, the second network device 304A may determine the second user device 318A did not move from one location to another location prior (e.g., within the previous 1, 3, 5, 10, 20 or any other number of minutes) to the second user device 318A sending the indication of the color collision. The second network device 304A may determine that the second network device 304A will not change the BSS color identifier (e.g., the second BSS color identifier) associated with the second network device 304A and/or the second network 302A based on one or both of the difference between the current signal strength and the historical signal strength not satisfying the first signal strength threshold and optionally satisfying the second signal strength threshold, and the difference between the current SNR and the historical SNR not satisfying the first SNR threshold and optionally satisfying the second SNR threshold.

For example, the second network device 304A may determine a prior or historical value for the amplitude attenuation for the second user device 318A. The prior or historical amplitude attenuation for the second user device 318A may be accessed or received from a database or memory local or remote from the second network device 304A. For example, the prior or historical amplitude attenuation value may be associated with a communication between the second network device 304A and the second user device 318A prior to the second user device 318A sending the indication of the color collision (e.g., the most recent communication from the second user device 318A to the second network device 304A prior to the indication of the color collision being sent). For example, the second network device 304A may determine a current value for the amplitude attenuation for the second user device 318A. For example, the current amplitude attenuation value may be determined from the indication of the color collision or a communication after that between the second user device 318A and the second network device 304A.

The second network device 304A may compare the current amplitude attenuation for the second user device 318A to the historical amplitude attenuation for the second user device 318A to determine a difference or change between the current amplitude attenuation and the historical amplitude attenuation (e.g., an attenuation difference). The second network device 304A may compare the difference or change between the current amplitude attenuation and the historical amplitude attenuation to the first amplitude attenuation threshold to determine if the difference or change satisfies the first amplitude attenuation threshold (e.g., is greater than or greater than or equal to the first amplitude attenuation threshold). The second network device 304A may compare the difference or change between the current amplitude attenuation and the historical amplitude attenuation to a second amplitude attenuation threshold to determine if the difference or change satisfies the second amplitude attenuation threshold (e.g., is less than or less than or equal to the second amplitude attenuation threshold). For example, the second amplitude attenuation threshold may be 1 dB. The second amplitude attenuation threshold may be any other amount greater or less than 1 dB in other examples. For example, the second network device 304A may determine the difference or change between the current amplitude attenuation and the historical amplitude attenuation does not satisfy the first amplitude attenuation threshold and optionally does satisfy the second amplitude attenuation threshold.

Based on one or more of the difference or change between the current SNR and the historical SNR not satisfying the first SNR threshold and optionally satisfying the second SNR threshold, the difference or change between the current signal strength and the historical signal strength not satisfying the first signal strength threshold and optionally satisfying the second signal strength threshold, and the difference or change between the current amplitude attenuation and the historical amplitude attenuation not satisfying the first amplitude attenuation threshold and optionally satisfying the second amplitude attenuation threshold, the second network device 304A may determine the second user device 318A did not move from one location to another location prior (e.g., within the previous 1, 3, 5, 10, 20 or any other number of minutes) to the second user device 318A sending the indication of the color collision. The second network device 304A may determine that the second network device 304A will maintain or will not change the BSS color identifier (e.g., the second BSS color identifier) associated with the second network device 304A and/or the second network 302A based on one or more of the difference or change between the current signal strength and the historical signal strength not satisfying the first signal strength threshold and optionally satisfying the second signal strength threshold, the difference or change between the current SNR and the historical SNR not satisfying the first SNR threshold and optionally satisfying the second SNR threshold, and the difference or change between the current amplitude attenuation and the historical amplitude attenuation not satisfying the first signal strength threshold and optionally satisfying the second amplitude attenuation threshold.

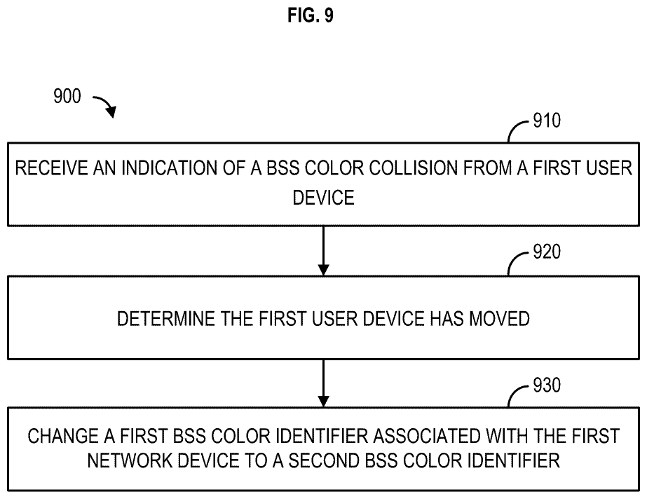

FIG. 9 shows an example method 900 for determining actions to take during a BSS color collision. The method 900 may be completed by any of the computing devices of FIGS. 1, 3, and 5. For example, the method 900 may be completed by one or more network devices, such as the access points 304A-B or the network management device 134, 334. For example, each of the first network device 304B and the second network device 304A may determine each network device's initial BSS color identifier in the manner described in FIG. 4 above.

At 910, an indication of a BSS color collision may be received from a first user device. For example, the indication may be sent by the first user device 332A and may be received by a first network device (e.g., the access point 304B). For example, the first network device 304B may provide the first wireless network coverage area 302B and the first user device 332A may be within the first wireless network coverage area 302B. For example, the first network device 304B may be communicating with the first user device 332A on a first wireless channel and the second network device 304A may be communicating with the second network device 318A on the first wireless channel. For example, the first user device 332A may receive or detect communication from another user device (e.g., a second user device 318A). The communication may or may not have been intended for the first user device 332A. For example, the second user device 318A may be communicating with a second network device (e.g., the access point 304A) and be within a second wireless network coverage area 302A. However, the first user device 332A and the second user device 318A may be in an overlapping region (e.g., overlapping region 336) with one another, such that each user device 318A, 332A may receive or detect communications from the other user device 318A, 332A. Based on receiving or detecting the communication from the second user device 318A, the first user device 332A may determine the second BSS color identifier within that communication and associated with the second network device 304A and/or the second network 302A. The first user device 332A may know the first BSS color identifier associated with the first network device 304B and/or the first network 302B.

The first user device 332A may determine the first BSS color identifier and the second BSS color identifier are the same BSS color identifier. Based on the first BSS color identifier and the second BSS color identifier being the same, the first user device 332A may determine that a color collision is occurring. The first user device 332A may send the indication of the BSS color collision to the first network device 304B. For example, the indication sent by the first user device 332A to the first network device 304B may comprise a message indicating the BSS color collision. For example, the message may be or comprise an autonomous report that is sent by the first user device 332A to the first network device 304B indicating the BSS color collision. For example, the autonomous report may comprise BSS color identifiers for one or more (e.g., all) other network devices and/or networks (e.g., the second network device 304A) from which the first user device 332A is able to detect frames in order to assist or help the first network device 304B to determine a new BSS color identifier when the first network device 304B determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the second network device 304A) that the first user device 332A is able to detect, for example through communication with the second user device 318A. The autonomous report or another message sent by the first user device 332A to the first network device 304B may include one or more of an identifier of the second user device 318A (e.g., a MAC address), an identifier of the second network device 304A (e.g., a MAC address), an identifier of the second network 302A (e.g., a service set identifier (SSID)), an indicator of the first BSS color identifier, an indicator of the second BSS color identifier, and/or one or more current network parameters associated with the first user device 332A (e.g., a current signal strength (e.g., RSSI) of communication between the first user device 332A and the first network device 304B, a current signal-to-noise ratio (SNR) for the communication between the first user device 332A and the first network device 304B, and/or one or more forms of current channel state information, such as the current amplitude attenuation for the first user device 332A.

The first network device 304B may determine if the first network device 304B needs to change the first BSS color identifier associated with the first network device 304B and/or the first network 302B. For example, this determination may be based on the indication of the color collision from the first user device 332A and/or the determination that the first BSS color identifier is the same as the second BSS color identifier. For example, the determination may be based on whether the first user device 332A moved from a first location to a second location prior to sending the indication of the color collision to the first network device 304B.

At 920, a determination may be made that the first user device 332A moved. For example, the determination may be made by the first network device 304B or the network management device 134, 334. For example, the first network device 304B may determine that the first user device 332A moved prior to the first user device sending the indication of the color collision. For example, the first network device 304B may determine if the first user device 332A moved based on one or more of the one or more network parameters received with the indication of the color collision by the first network device 304B. For example, the first network device 304B may determine a prior or historical value for the one or more network parameters for the first user device 332A. The prior or historical value for the one or more network parameters for the first user device 332A may be accessed or received from a database or memory local or remote from the first network device 304B. For example, the prior or historical value for the one or more network parameters may be associated with a communication between the first network device 304B and the first user device 332A prior to the first user device 332A sending the indication of the color collision (e.g., the most recent communication from the first user device 332A to the access point 304B prior to the indication of the color collision being sent). For example, the first network device 304B may determine a current value for the one or more network parameters for the first user device 332A. For example, the current value for the one or more network parameters may be determined from the indication of the color collision or another recent communication from the first user device 332A to the first network device 304B.

The first network device 304B may compare the one of the one or more current network parameters for the user device 332A to a corresponding one of the one or more historical network parameters for the first user device 332A to determine a difference between the current network parameter and the historical network parameter. The first network device 304B may compare the difference between the current network parameter and the historical network parameter to a first parameter threshold to determine if the difference between the current network parameter and the historical network parameter satisfies the first parameter threshold (e.g., is greater than or greater than or equal to the first parameter threshold). The first network device 304B may compare the difference between the current network parameter and the historical network parameter to a second parameter threshold to determine if the difference between the current network parameter and the historical network parameter satisfies the second parameter threshold (e.g., is less than or less than or equal to the second parameter threshold). The first network device 304B may determine that the difference between the current network parameter and the historical network parameter satisfies first parameter threshold. Based on the difference between the current network parameter and the historical network parameter satisfying the first parameter threshold, the first network device 304B may determine the first user device 332A moved from the first location (as shown in FIG. 3) to a second location (as shown in FIG. 5) prior (e.g., within the previous 1, 3, 5, 10, 20 or any other number of minutes) to the first user device 332A sending the indication of the color collision to the first network device 304B. For example, the first network device 304B may determine if the first user device 332A did or did not move prior to sending the indication of the color collision based on a plurality of network parameters (e.g., 2, 3, 4, or more) of the one or more network parameters associated with the first user device 332A having differences (as described above) between current and historical values that do satisfy a corresponding first parameter threshold for each of those particular network parameters.

For example, the one or more network parameters may comprise a signal strength (e.g., RSSI) associated with a communication between the first user device 332A and the first network device 304B. The first network device 304B may compare the current signal strength for the first user device 332A to the historical signal strength for the first user device 332A to determine a difference between the current signal strength and the historical signal strength (e.g., a signal strength difference). The first network device 304B may compare the difference between the current signal strength and the historical signal strength to the first signal strength threshold to determine if the difference satisfies the first signal strength threshold (e.g., is greater than or greater than or equal to the first signal strength threshold). For example, the first signal strength threshold may be 5 dBm. The first signal strength threshold may be any other amount greater or less than 5 dBm in other examples. The first network device 304B may determine the difference between the current signal strength and the historical signal strength satisfies the first signal strength threshold. Based on the difference between the current signal strength and the historical signal strength satisfying the first signal strength threshold, the first network device 304B may determine the first user device 332A did move from the first location to the second location prior (e.g., within the previous 1, 3, 5, 10, 20 or any other number of minutes) to the first user device 332A sending the indication of the color collision.

For example, the one or more network parameters may comprise a signal-to-noise ratio (SNR) associated with a communication between the first user device 332A and the first network device 304B. The first network device 304B may compare the current SNR for the first user device 332A to the historical SNR for the first user device 332A to determine a difference between the current SNR and the historical SNR (e.g., a SNR difference). The first network device 304B may compare the difference between the current SNR and the historical SNR to a first SNR threshold to determine if the difference satisfies the first SNR threshold (e.g., is greater than or greater than or equal to the first SNR threshold). For example, the first SNR threshold may be 5 dB (e.g., a 5 dB decrease in SNR). The first SNR threshold may be any other amount greater or less than 5 dB in other examples. The first network device 304B may determine at least the difference between the current SNR and the historical SNR satisfies the first SNR threshold. Based on the difference between the current SNR and the historical SNR satisfying the first SNR threshold, the first network device 304B may determine the first user device 332A moved from the first location to the second location prior (e.g., within the previous 1, 3, 5, 10, 20 or any other number of minutes) to the first user device 332A sending the indication of the color collision.

For example, the first network device 304B may determine one or both of at least the difference between the current SNR and the historical SNR satisfies the first SNR threshold, and at least the difference between the current signal strength and the historical signal strength satisfies the first signal strength threshold. Based on one or both of the difference between the current SNR and the historical SNR satisfying the first SNR threshold, and at least the difference between the current signal strength and the historical signal strength satisfying the first signal strength threshold, the first network device 304B may determine the first user device 332A moved from the first location to the second location prior (e.g., within the previous 1, 3, 5, 10, 20 or any other number of minutes) to the first user device 332A sending the indication of the color collision.

For example, the one or more network parameters may comprise amplitude attenuation or other channel state information associated with a communication between the first user device 332A and the first network device 304B. The first network device 304B may compare the current amplitude attenuation for the first user device 332A to the historical amplitude attenuation for the first user device 332A to determine a difference between the current amplitude attenuation and the historical amplitude attenuation (e.g., an attenuation difference). The first network device 304B may compare the difference between the current amplitude attenuation and the historical amplitude attenuation to a first amplitude attenuation threshold to determine if the difference satisfies the first amplitude attenuation threshold (e.g., is greater than or greater than or equal to the first amplitude attenuation threshold). For example, the first amplitude attenuation threshold may be 3 decibels (dB). The first amplitude attenuation threshold may be any other amount greater or less than 3 dB in other examples.

The first network device 304B may determine at least the difference between the current amplitude attenuation and the historical amplitude attenuation satisfies the first attenuation threshold. Based on the difference between the current amplitude attenuation and the historical amplitude attenuation satisfying the first attenuation threshold, the first network device 304B may determine the first user device 332A moved from the first location to the second location prior (e.g., within the previous 1, 3, 5, 10, 20 or any other number of minutes) to the first user device 332A sending the indication of the color collision.

The first network device 304B may determine one or more of at least the difference between the current SNR and the historical SNR satisfies the first SNR threshold, at least the difference between the current signal strength and the historical signal strength satisfies the first signal strength threshold, and at least the difference between the current amplitude attenuation and the historical amplitude attenuation satisfies the first amplitude attenuation threshold. Based on one or more of the difference between the current SNR and the historical SNR satisfying the first SNR threshold, at least the difference between the current signal strength and the historical signal strength satisfying the first signal strength threshold, and the difference between the current amplitude attenuation and the historical amplitude attenuation satisfying the first amplitude attenuation threshold, the first network device 304B may determine the first user device 332A moved from the first location to the second location prior (e.g., within the previous 1, 3, 5, 10, 20 or any other number of minutes) to the first user device 332A sending the indication of the color collision.

At 930, the first BSS color identifier associated with the first network device 304B may be changed to a third BSS color identifier. For example, the BSS color identifier may be changed by the first network device 304B. For example, the third BSS color identifier may be different from the first BSS color identifier and the second BSS color identifier. For example, the first BSS color identifier may be changed based on the determination that the first user device 332A moved prior to sending the indication of the BSS color collision to the first network device 304B. Based on the change from the first BSS color identifier to the third BSS color identifier, the first network device 304B may send an indication of the third BSS color identifier associated with the first network device 304B to the first user device 332A and any other user devices communicating with the first network device 304B.

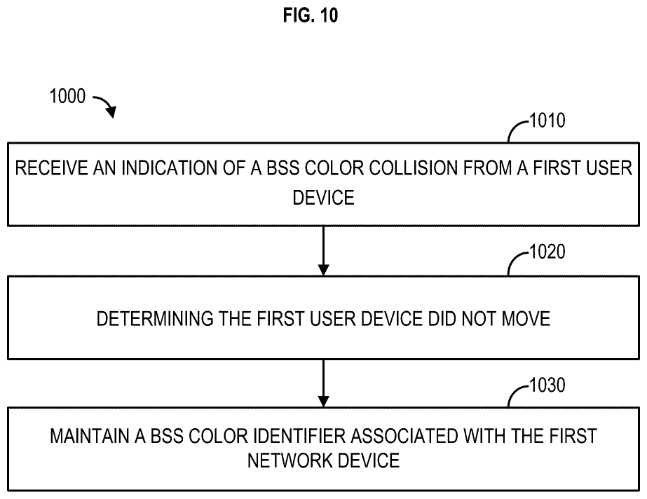

FIG. 10 shows an example method 1000 for determining actions to take during a BSS color collision. The method 1000 may be completed by any of the computing devices of FIGS. 1, 3, and 5. For example, the method 1000 may be completed by one or more network devices, such as the access points 304A-B or the network management device 134, 334. For example, each of the first network device 304A and the second network device 304B may determine each network device's initial BSS color identifier in the manner described in FIG. 4 above.

At 1010, an indication of a BSS color collision may be received from a first user device 318A. For example, the indication may be sent by the first user device 318A and may be received by a first network device (e.g., the access point 304A). For example, the first network device 304A may provide the first wireless network coverage area 302A and the first user device 318A may be within the first wireless network coverage area 302A. For example, the first user device 318A may receive or detect communication from a second user device 332A. The communication may or may not have been intended for the first user device 318A. For example, the second user device 332A may be communicating with a second network device 304B and be within a second wireless network coverage area 302B, and the first user device 318A may be communicating with a first network device 304A. However, the second user device 332A and the first user device 318A may be in an overlapping region (e.g., overlapping region 336) with one another, such that each user device 318A, 332A may receive or detect communications from the other user device 318A, 332A. For example, the first network device 304A may be communicating with the first user device 318A on a first wireless channel and the second network device 304B may be communicating with the second network device 332A on the first wireless channel. Based on receiving or detecting the communication from the second user device 332A, the first user device 318A may determine a second BSS color identifier within that communication and associated with the second network device 304B and/or the second network 302B. The first user device 318A may know the first BSS color identifier associated with the first network device 304A and/or the first network 302A. The first user device 318A may determine the first BSS color identifier and the second BSS color identifier are the same BSS color identifier. Based on the first BSS color identifier and the second BSS color identifier being the same, the first user device 318A may determine a color collision has occurred.

The first user device 318A may send the indication of the BSS color collision to the first network device 304A. For example, the indication sent by the first user device 318A to the first network device 304A may comprise a message indicating the BSS color collision. For example, the message may be or comprise an autonomous report that is sent by the first user device 318A to first network device 304A indicating the BSS color collision. For example, the autonomous report may comprise BSS color identifiers for one or more (e.g., all) other network devices and/or networks (e.g., the second network device 304B) from which the first user device 318A is able to detect frames (e.g., via the second user device 332A) in order to assist or help the first network device 304A to determine a new BSS color identifier when the first network device 304A determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the second network device 304B) that the first user device 318A is able to detect, for example through communication with second user device 332A. The autonomous report or another message sent by the first user device 318A to the first network device 304A may include one or more of an identifier of the second user device 332A (e.g., a MAC address), an identifier of the second network device 304B (e.g., a MAC address), an identifier of the second network 302B (e.g., a service set identifier (SSID)), an indicator of the second BSS color identifier, an indicator of the first BSS color identifier, and/or one or more current network parameters associated with the first user device 318A (e.g., a current signal strength (e.g., RSSI) of communication between the first user device 318A and the first network device 304A, a current signal-to-noise ratio (SNR) for the communication between the first user device 318A and the first network device 304A, and/or one or more forms of current channel state information, such as the current amplitude attenuation for the first user device 318A.

The first network device 304A may determine if the first network device 304A needs to change the first BSS color identifier associated with the first network device 304B and/or the first network 302A. For example, this determination may be based on the indication of the color collision from the first user device 318A and/or the determination that the first BSS color identifier is the same as the second BSS color identifier. For example, the determination may be based on whether the first user device 318A moved from a first location to a second location prior to sending the indication of the color collision to the first network device 304A.

At 1020, a determination may be made that the first user device 318A did not move. For example, the determination may be made by the first network device 304A. For example, the first network device 304A may determine that the first user device 318A did not move prior to the first user device 318A sending the indication of the color collision. For example, the first network device 304A may determine the first user device 318A did not move based on one or more of the one or more network parameters received with the indication of the color collision by the first network device 304A. For example, the one or more network parameters may comprise one or more of a signal strength (e.g., RSSI) of communication between the first user device 318A and the first network device 304A, a signal-to-noise ratio (SNR) for the communication between the first user device 318A and the first network device 304A, and/or one or more forms of channel state information (e.g., amplitude attenuation).

For example, the first network device 304A may determine a prior or historical value for the one or more network parameters for the first user device 318A. The prior or historical value for the one or more network parameters for the first user device 318A may be accessed or received from a database or memory local or remote from the first network device 304A. For example, the prior or historical value for the one or more network parameters may be associated with a communication between the first network device 304A and the first user device 318A prior to the first user device 318A sending the indication of the color collision (e.g., the most recent communication from the first user device 318A to the first network device 304A prior to the indication of the color collision being sent). For example, the first network device 304A may determine a current value for the one or more network parameters for the first user device 318A. For example, the current value for the one or more network parameters may be determined from the indication of the color collision or another recent communication from the first user device 318A.

The first network device 304A may compare the one of the one or more current network parameters for the first user device 318A to a corresponding one of the one or more historical network parameters for the first user device 318A to determine a difference between the current network parameter and the historical network parameter. The first network device 304A may compare the difference between the current network parameter and the historical network parameter to a first parameter threshold to determine if the difference between the current network parameter and the historical network parameter satisfies the first parameter threshold (e.g., is greater than or greater than or equal to the first parameter threshold). The first network device 304A may compare the difference between the current network parameter and the historical network parameter to a second parameter threshold to determine if the difference between the current network parameter and the historical network parameter satisfies the second parameter threshold (e.g., is less than or less than or equal to the second parameter threshold). For example, the first network device 304A may determine the first user device 318A did not move prior to the first user device 318A sending the indication of the color collision if the difference between the current network parameter and the historical network parameter does not satisfy the first parameter threshold. For example, the first network device 304A may determine the first user device 318A did not move prior to the first user device 318A sending the indication of the color collision if the difference between the current network parameter and the historical network parameter does not satisfy the first parameter threshold and the difference between the current network parameter and the historical network parameter does satisfy the second parameter threshold. For example, each of the one or more network parameters may have a first parameter threshold that is the same or different from the first parameter threshold for other network parameters. For example, each of the one or more network parameters may also have a second parameter threshold that is the same or different from the second parameter threshold for the other network parameters. The first network device 304A may determine at least the difference between the current network parameter and the historical network parameter does not satisfy the first parameter threshold and optionally does satisfy the second parameter threshold.

Based on the difference between the current network parameter and the historical network parameter not satisfying the first parameter threshold and optionally satisfying the second parameter threshold, the first network device 304A may determine the first user device 318A did not move from one location to another location prior (e.g., within the previous 1, 3, 5, 10, 20 or any other number of minutes) to the first user device 318A sending the indication of the color collision. For example, the first network device 304A may determine the first user device 318 did not move prior to sending the indication of the color collision based on a plurality of network parameters (e.g., 2, 3, 4, or more) of the one or more network parameters associated with the first user device 318A having differences (as described above) between current and historical values that do not satisfy a corresponding first parameter threshold and/or that satisfy a corresponding second parameter threshold for each of those particular network parameters.

For example, the one or more network parameters may comprise a signal strength (e.g., RSSI) associated with a communication between the first user device 318A and the first network device 304A. The first network device 304A may compare the current signal strength for the first user device 318A to the historical signal strength for the first user device 318A to determine a difference between the current signal strength and the historical signal strength (e.g., a signal strength difference). The first network device 304A may compare the difference between the current signal strength and the historical signal strength to the first signal strength threshold to determine if the difference satisfies the first signal strength threshold (e.g., is greater than or greater than or equal to the first signal strength threshold). For example, the first signal strength threshold may be 5 dBm. The first signal strength threshold may be any other amount greater or less than 5 dBm in other examples. The first network device 304A may compare the difference between the current signal strength and the historical signal strength to a second signal strength threshold to determine if the difference satisfies the second signal strength threshold (e.g., is less than or less than or equal to the second signal strength threshold). For example, the second signal strength threshold may be 2 dBm. The second signal strength threshold may be any other amount greater or less than 2 dBm in other examples. The first network device 304A may determine at least the difference between the current signal strength and the historical signal strength does not satisfy the first signal strength threshold and optionally does satisfy the second signal strength threshold. Based on the difference between the current signal strength and the historical signal strength not satisfying the first signal strength threshold and optionally satisfying the second signal strength threshold, the first network device 304A may determine the first user device 318A did not move from one location to another location prior (e.g., within the previous 1, 3, 5, 10, 20 or any other number of minutes) to the first user device 318A sending the indication of the color collision.

For example, the one or more network parameters may comprise a signal-to-noise ratio (SNR) associated with a communication between the first user device 318A and the first network device 304A. The first network device 304A may compare the current SNR for the first user device 318A to the historical SNR for the first user device 318A to determine a difference between the current SNR and the historical SNR (e.g., a SNR difference). The first network device 304A may compare the difference between the current SNR and the historical SNR to the first SNR threshold to determine if the difference satisfies the first SNR threshold (e.g., is greater than or greater than or equal to the first SNR threshold). For example, the first SNR threshold may be 5 dB (e.g., a 5 dB decrease in SNR). The first SNR threshold may be any other amount greater or less than 5 dB in other examples. The first network device 304A may compare the difference between the current SNR and the historical SNR to a second SNR threshold to determine if the difference satisfies the second SNR threshold (e.g., is less than or less than or equal to the second SNR threshold). For example, the second SNR threshold may be 2 dB. The second SNR threshold may be any other amount greater or less than 2 dB in other examples. The first network device 304A may determine at least the difference between the current SNR and the historical SNR does not satisfy the first SNR threshold and optionally does satisfy the second SNR threshold. Based on the difference between the current SNR and the historical SNR not satisfying the first SNR threshold and optionally satisfying the second SNR threshold, the first network device 304A may determine the first user device 318A did not move from one location to another location prior (e.g., within the previous 1, 3, 5, 10, 20 or any other number of minutes) to the first user device 318A sending the indication of the color collision.

The first network device 304A may determine one or both of at least the difference between the current SNR and the historical SNR does not satisfy the first SNR threshold and optionally does satisfy the second SNR threshold, and at least the difference between the current signal strength and the historical signal strength does not satisfy the first signal strength threshold and optionally does satisfy the second signal strength threshold. Based on one or both of the difference between the current SNR and the historical SNR not satisfying the first SNR threshold and optionally satisfying the second SNR threshold, and at least the difference between the current signal strength and the historical signal strength not satisfying the first signal strength threshold and optionally satisfying the second signal strength threshold, the first network device 304A may determine the first user device 318A did not move from one location to another location prior (e.g., within the previous 1, 3, 5, 10, 20 or any other number of minutes) to the first user device 318A sending the indication of the color collision.

For example, the one or more network parameters may comprise amplitude attenuation or other channel state information associated with a communication between the first user device 318A and the first network device 304A. The first network device 304A may compare the current amplitude attenuation for the first user device 318A to the historical amplitude attenuation for the first user device 318A to determine a difference between the current amplitude attenuation and the historical amplitude attenuation (e.g., an attenuation difference). The first network device 304A may compare the difference between the current amplitude attenuation and the historical amplitude attenuation to the first amplitude attenuation threshold to determine if the difference satisfies the first amplitude attenuation threshold (e.g., is greater than or greater than or equal to the first amplitude attenuation threshold). For example, the first amplitude attenuation threshold may be 3 decibels (dB). The first amplitude attenuation threshold may be any other amount greater or less than 3 dB in other examples. The first network device 304A may compare the difference between the current amplitude attenuation and the historical amplitude attenuation to a second amplitude attenuation threshold to determine if the difference satisfies the second amplitude attenuation threshold (e.g., is less than or less than or equal to the second amplitude attenuation threshold). For example, the second amplitude attenuation threshold may be 1 dB. The second amplitude attenuation threshold may be any other amount greater or less than 1 dB in other examples. For example, the first network device 304A may determine the first user device 318A did not move prior to the first user device 318A sending the indication of the color collision if the difference between the current amplitude attenuation and the historical amplitude attenuation does not satisfy the first amplitude attenuation threshold. For example, the first network device 304A may determine the first user device 318A did not move prior to the first user device 318A sending the indication of the color collision if the difference between the current amplitude attenuation and the historical amplitude attenuation does not satisfy the first amplitude attenuation threshold and the difference between the current amplitude attenuation and the historical amplitude attenuation does satisfy the second amplitude attenuation threshold.

The first network device 304A may determine one or more of at least the difference between the current SNR and the historical SNR does not satisfy the first SNR threshold and optionally does satisfy the second SNR threshold, at least the difference between the current signal strength and the historical signal strength does not satisfy the first signal strength threshold and optionally does satisfy the second signal strength threshold, and at least the difference between the current amplitude attenuation and the historical amplitude attenuation does not satisfy the first amplitude attenuation threshold and optionally does satisfy the second amplitude attenuation threshold. Based on one or more of the difference between the current SNR and the historical SNR not satisfying the first SNR threshold and optionally satisfying the second SNR threshold, at least the difference between the current signal strength and the historical signal strength not satisfying the first signal strength threshold and optionally satisfying the second signal strength threshold, and the difference between the current amplitude attenuation and the historical amplitude attenuation not satisfying the first amplitude attenuation threshold and optionally satisfying the second amplitude attenuation threshold, the first network device 304A may determine the first user device 318A did not move from one location to another location prior (e.g., within the previous 1, 3, 5, 10, 20 or any other number of minutes) to the first user device 318A sending the indication of the color collision.

At 1030, the first BSS color identifier associated with the first network device 304A may be may be maintained or not changed to a different BSS color identifier. For example, the first network device 304A may determine to maintain or not change the first BSS color identifier. For example, the determination may be based on the determination that the first user device 318A did not move prior to the first user device 318A sending the indication of the color collision to the first network device 304A.

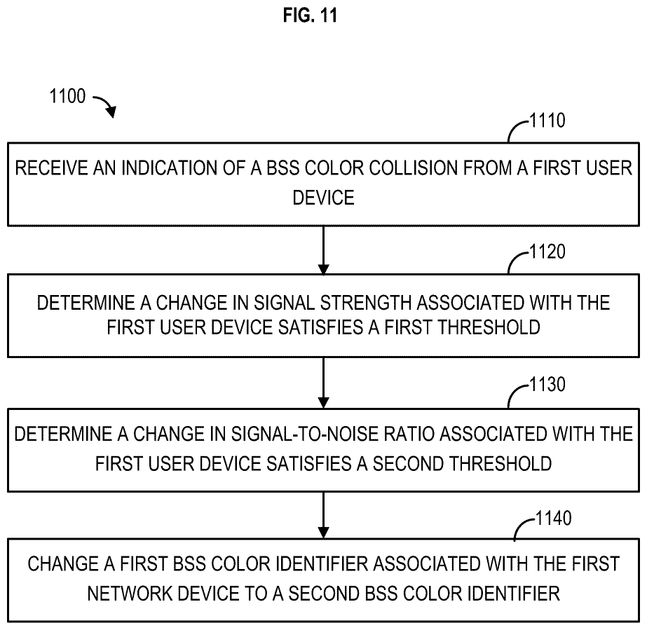

FIG. 11 shows an example method 1100 for determining actions to take during a BSS color collision. The method 1100 may be completed by any of the computing devices of FIGS. 1, 3, and 5. For example, the method 1100 may be completed by one or more network devices, such as the access points 304A-B or the network management device 134, 334. For example, each of the first network device 304B and the second network device 304A may determine each network device's initial BSS color identifier in the manner described in FIG. 4 above.

At 1110, an indication of a BSS color collision may be received from a first user device. For example, the indication may be sent by the first user device 332A and may be received by a first network device (e.g., the access point 304B). For example, the first network device 304B may provide first wireless network coverage area 302B and the first user device 332A may be within the first wireless network coverage area 302B. For example, the first user device 332A may receive or detect communication from a second user device (e.g., user device 318A). The communication may or may not have been intended for the first user device 332A. For example, the second user device 318A may be communicating with a second network device (e.g., the access point 304A) and be within a second wireless network coverage area 302A. However, the first user device 332A and the second user device 318A may be in an overlapping region (e.g., overlapping region 336) with one another, such that each user device 318A, 332A may receive or detect communications from the other user device 318A, 332A. For example, the first network device 304B may be communicating with the first user device 332A on a first wireless channel and the second network device 304A may be communicating with the second network device 318A on the first wireless channel. Based on receiving or detecting the communication from the second user device 318A, the first user device 332A may determine a second BSS color identifier within that communication and associated with the second network device 304A and/or the second network 302A. The first user device 332A may know the first BSS color identifier associated with the first network device 304B and/or the first network 302B.

The first user device 332A may determine the first BSS color identifier and the second BSS color identifier are the same BSS color identifier. Based on the first BSS color identifier and the second BSS color identifier being the same, the first user device 332A may determine that a color collision is occurring. The first user device 332A may send the indication of a BSS color collision to the first network device 304B. For example, the indication sent by the first user device 332A to the first network device 304B may comprise a message indicating the BSS color collision. For example, the message may be or comprise an autonomous report that is sent by the first user device 332A to the first network device 304B indicating the BSS color collision. For example, the autonomous report may comprise BSS color identifiers for one or more (e.g., all) other network devices and/or networks (e.g., the second network device 304A) from which the first user device 332A is able to detect frames in order to assist or help the first network device 304B to determine a new BSS color identifier when the first network device 304B determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the second network device 304A) that the first user device 332A is able to detect, for example through communication with the second user device 318A. The autonomous report or another message sent by the first user device 332A to the first network device 304B may include one or more of an identifier of the second user device 318A (e.g., a MAC address), an identifier of the second network device 304A (e.g., a MAC address), an identifier of the second network 302A (e.g., a service set identifier (SSID)), an indicator of the first BSS color identifier, an indicator of the second BSS color identifier, and/or one or more current network parameters associated with the first user device 332A (e.g., a current signal strength (e.g., RSSI) of communication between the first user device 332A and the first network device 304B, a current signal-to-noise ratio (SNR) for the communication between the first user device 332A and the first network device 304B, and/or one or more forms of current channel state information, such as the current amplitude attenuation for the first user device 332A.

At 1120, a change in signal strength (e.g., RSSI) associated with the first user device 332A may be determined to satisfy a first threshold (e.g., a signal strength threshold). For example, the determination may be made by the first network device 304B or the network management device 134, 334. For example, the first network device 304B may determine a prior or historical value for the signal strength for the first user device 332A. The prior or historical signal strength value for the first user device 332A may be accessed or received from a database or memory local or remote from the first network device 304B. For example, the prior or historical signal strength value may be associated with a communication between the first network device 304B and the first user device 332A prior to the first user device 332A sending the indication of the color collision (e.g., the most recent communication from the first user device 332A to the first network device 304B prior to the indication of the color collision being sent). For example, the first network device 304B may determine a current value for the signal strength for the first user device 332A. For example, the current signal strength value may be determined from the indication of the color collision or a communication after that between the first user device 332A and the first network device 304B.

The first network device 304B may compare the current signal strength for the first user device 332A to the historical signal strength for the first user device 332A to determine a difference between or change from the historical signal strength and the current signal strength (e.g., a signal strength difference). The first network device 304B may compare the difference or change between the historical signal strength and the current signal strength to the first signal strength threshold to determine if the difference or change satisfies the first signal strength threshold (e.g., is greater than or greater than or equal to the first signal strength threshold). For example, the first signal strength threshold may be 5 dBm. The first signal strength threshold may be any other amount greater or less than 5 dBm in other examples. The first network device 304B may determine the difference or change between the historical signal strength and the current signal strength satisfies the first signal strength threshold.

At 1130, a change in signal-to-noise ratio (SNR) associated with the first user device 332A may be determined to satisfy a first threshold (e.g., a SNR threshold). For example, the determination may be made by the first network device 304B or the network management device 134, 334. For example, the first network device 304B may determine a prior or historical value for the SNR for the first user device 332A. The prior or historical SNR for the first user device 332A may be accessed or received from a database or memory local or remote from the first network device 304B. For example, the prior or historical SNR may be associated with a communication between the first network device 304B and the first user device 332A prior to the first user device 332A sending the indication of the color collision (e.g., the most recent communication from the first user device 332A to the first network device 304B prior to the indication of the color collision being sent). For example, the first network device 304B may determine a current value for the SNR for the first user device 332A. For example, the current SNR may be determined from the indication of the color collision or a communication after that between the first user device 332A and the first network device 304B.

The first network device 304B may compare the historical SNR for the first user device 332A to the current SNR for the first user device 332A to determine a difference between or change of the historical SNR and current SNR (e.g., a SNR difference). The first network device 304B may compare the difference or change between the historical SNR and current SNR to a first SNR threshold to determine if the difference satisfies the first SNR threshold (e.g., is greater than or greater than or equal to the first SNR threshold). For example, the first SNR threshold may be 5 dB (e.g., a 5 dB decrease in SNR). The first SNR threshold may be any other amount greater or less than 5 dB in other examples. The first network device 304B may determine at least the difference or change between the historical SNR and current SNR satisfies the first SNR threshold. Based on one or both of at least the difference or change between the historical SNR and current SNR satisfying the first SNR threshold, and the difference or change between the historical signal strength and the current signal strength satisfying the first signal strength threshold, the first network device 304B may determine the first user device 332A moved from the first location to the second location prior (e.g., within the previous 1, 3, 5, 10, 20 or any other number of minutes) to the first user device 332A sending the indication of the color collision.

At 1140, the BSS color identifier associated with the first network device 304B (e.g., the first BSS color identifier) may be changed to a third BSS color identifier. For example, the change may be made by the first network device 304B or the network management device 134, 334. For example, the first network device 304B may determine the third BSS color identifier. For example, the third BSS color identifier may be different from the first BSS color identifier and the second BSS color identifier. The first network device 304B may change the first BSS color identifier to the third BSS color identifier based on one or both of at least the difference or change between the historical SNR and current SNR satisfying the first SNR threshold, and the difference or change between the historical signal strength and the current signal strength satisfying the first signal strength threshold. The first network device 304B may change the first BSS color identifier to the third BSS color identifier based on a determination that the first user device 332A moved from the first location to the second location prior (e.g., within the previous 1, 3, 5, 10, 20 or any other number of minutes) to the first user device 332A sending the indication of the color collision. Based on the change from the first BSS color identifier to the third BSS color identifier, the first network device 304B may send an indication of the third BSS color identifier associated with the first network device 304B to the first user device 332A and any other user devices communicating with the first network device 304B.

A change in amplitude attenuation associated with the first user device 332A may be determined to satisfy a first threshold (e.g., an amplitude attenuation threshold). For example, the determination may be made by the first network device 304B. For example, the first network device 304B may determine a prior or historical value for the amplitude attenuation for the first user device 332A. The prior or historical amplitude attenuation for the first user device 332A may be accessed or received from a database or memory local or remote from the first network device 304B. For example, the prior or historical amplitude attenuation may be associated with a communication between the first network device 304B and the first user device 332A prior to the first user device 332A sending the indication of the color collision (e.g., the most recent communication from the first user device 332A to the first network device 304B prior to the indication of the color collision being sent). For example, the first network device 304B may determine a current value for the amplitude attenuation for the first user device 332A. For example, the current amplitude attenuation may be determined from the indication of the color collision or a communication after that between the first user device 332A and the first network device 304B.

The first network device 304B may compare the historical amplitude attenuation for the first user device 332A to the current amplitude attenuation for the first user device 332A to determine a difference between or change of the historical amplitude attenuation and current amplitude attenuation (e.g., a SNR difference). The first network device 304B may compare the difference or change between the historical amplitude attenuation and current amplitude attenuation to the first amplitude attenuation threshold to determine if the difference satisfies the first amplitude attenuation threshold (e.g., is greater than or greater than or equal to the first SNR threshold). For example, the first amplitude attenuation threshold may be 3 dB. The first amplitude attenuation threshold may be any other amount greater or less than 3 dB in other examples. The first network device 304B may determine at least the difference or change between the historical amplitude attenuation and current amplitude attenuation satisfies the first amplitude attenuation threshold.

Based on one or more of the difference or change between the current SNR and the historical SNR satisfying the first SNR threshold, the difference or change between the current signal strength and the historical signal strength satisfying the first signal strength threshold, and the difference or change between the current amplitude attenuation and the historical amplitude attenuation satisfying the first amplitude attenuation threshold, the first network device 304B may determine the first user device 332A moved from the first location to the second location prior (e.g., within the previous 1, 3, 5, 10, 20 or any other number of minutes) to the first user device 332A sending the indication of the color collision. The first network device 304B may change the first BSS color identifier to the third BSS color identifier based on one or more of the difference or change between the current SNR and the historical SNR satisfying the first SNR threshold, the difference or change between the current signal strength and the historical signal strength satisfying the first signal strength threshold, and the difference or change between the current amplitude attenuation and the historical amplitude attenuation satisfying the first amplitude attenuation threshold. Based on the change from the first BSS color identifier to the third BSS color identifier, the first network device 304B may send an indication of the third BSS color identifier associated with the first network device 304B to the first user device 332A and any other user devices communicating with the first network device 304B.

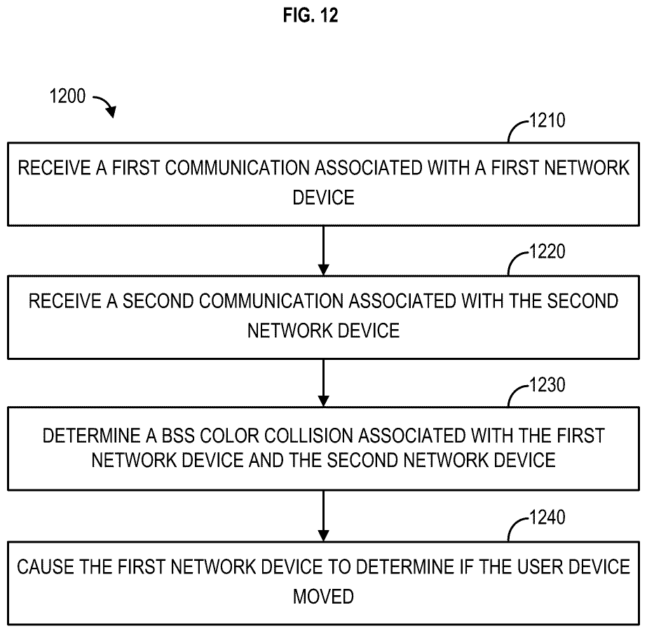

FIG. 12 shows an example method 1200 for determining actions to take during a BSS color collision. The method 1200 may be completed by any of the computing devices of FIGS. 1, 3, and 5. For example, the method 1200 may be completed by one or more user devices, such as the user devices 318A, 332A. For example, each of the first network device 304B and the second network device 304A may determine each network device's initial BSS color identifier in the manner described in FIG. 4 above.

At 1210, a first communication associated with a first network device may be received. For example, the first communication may be received by the first user device 332A. For example, the first network device 304B may comprise a first access point, router, or gateway. For example, the first communication may be sent by the first network device 304B to the first user device 332A. For example, the first network device 304B may provide a first wireless network coverage area 302B and the first user device 332A may be within the first wireless network coverage area 302B and communicating with the first network device 304B via the first wireless network 302B. The first user device 332A may determine a first BSS color identifier associated with the first network device 304B and/or the first network 302B.

At 1220, a second communication associated with a second network device may be received. For example, the second communication may be received by the first user device 332A. For example, the first user device 332A may receive or detect communication from another user device (e.g., a second user device 318A) or another network device (e.g., the second network device 304A). For example, the second network device 304A may comprises a second access point, router, or gateway. The communication may or may not have been intended for the first user device 332A. For example, the second user device 318A may be communicating with the second network device 304A and be within a second wireless network coverage area 302A. However, the first user device 332A and the second user device 318A may be in an overlapping region (e.g., overlapping region 336) with one another, such that each user device 318A, 332A may receive or detect communications from the other user device 318A, 332A. Based on receiving or detecting the communication from the second user device 318A and/or the second network device 304A, the first user device 332A may determine a second BSS color identifier within that communication and associated with the second network device 304A and/or the second network 302A. Based on receiving or detecting the communication from the second user device 318A and/or the second network device 304A, the first user device 332A may determine a wireless channel that the second user device 318A and the second network device 304A are sending communications on.

At 1230, a BSS color collision associated with the first network device 304B and the second network device 304A may be determined. For example, the determination may be made by the first user device 332A. For example, the first user device 332A may determine the first BSS color identifier and the second BSS color identifier are the same BSS color identifier. The first user device 332A may determine the BSS color collision has occurred based on the first BSS color identifier and the second BSS color identifier being the same BSS color identifier. For example, the first user device 332A may further determine the BSS color collision based on the first network device 304B and the second network device 304A communicating via the same wireless channel.

At 1240, the first user device 332A may cause the first network device 304B to determine if the first user device 332A moved prior to determining the BSS color collision. For example, the first user device 332A may cause the first network device 304B to determine if the first user device 332 moved prior to determining the BSS color collision by the first user device 332A sending to the first network device 304B an indication, message, or signal that the BSS color collision has been determined or detected by the first user device 332A.

For example, the indication sent by the first user device 332A to the first network device 304B may comprise a message indicating the BSS color collision. For example, the message may be or comprise an autonomous report that is sent by the first user device 332A to the first network device 304B indicating the BSS color collision. For example, the autonomous report may comprise BSS color identifiers for one or more (e.g., all) other network devices and/or networks (e.g., the second network device 304A) from which the first user device 332A is able to detect frames in order to assist or help the first network device 304B to determine a new BSS color identifier when the first network device 304B determines it needs to change its BSS color identifier based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the second network device 304A) that the first user device 332A is able to detect, for example through communication with the second user device 318A. The autonomous report or another message sent by the first user device 332A to the first network device 304B may include one or more of an identifier of the second user device 318A (e.g., a MAC address), an identifier of the second network device 304A (e.g., a MAC address), an identifier of the second network 302A (e.g., a service set identifier (SSID)), an identifier of the wireless channel that the second network device 304A and/or the second user device 318A are communicating on, an indicator of the first BSS color identifier, an indicator of the second BSS color identifier, and/or one or more current network parameters associated with the first user device 332A (e.g., a current signal strength (e.g., RSSI) of communication between the first user device 332A and the first network device 304B, a current signal-to-noise ratio (SNR) for the communication between the first user device 332A and the first network device 304B, and/or one or more forms of current channel state information, such as the current amplitude attenuation for the first user device 332A.

The first network device 304B may determine if the first user device 332A moved or did not move prior to determining or detecting the BSS color collision. For example, the first network device 304B may determine if the first user device 332A moved or did not move using any of the methods described in 630-640 of FIG. 6, 730-740 of FIG. 7, 830-850 of FIG. 8, 920 of FIG. 9, 1020 of FIGS. 10, and/or 1120-1140 of FIG. 11 above.

For example, based on a determination that the first user device 332A did move prior to determining or detecting the BSS color collision, the first network device 304B may change the BSS color identifier associated with the first network device 304B and/or the first network 302B from the first BSS color identifier to a third BSS color identifier. For example, based on the first network device 304B changing from the first BSS color identifier to the third BSS color identifier, the first user device 332A may receive, from the first network device 304B, an indication that the first network device 304B has changed the BSS color identifier associated with the first network device 304B and/or the first network 302B from the first BSS color identifier to the third BSS color identifier. For example, the indication may be sent by the first network device 304B. For example, the indication may include the third BSS color identifier. For example, based on receiving the indication, the first user device 332A may no longer determine or detect a BSS color collision associated with the second user device 318A and/or the second network device 304A.

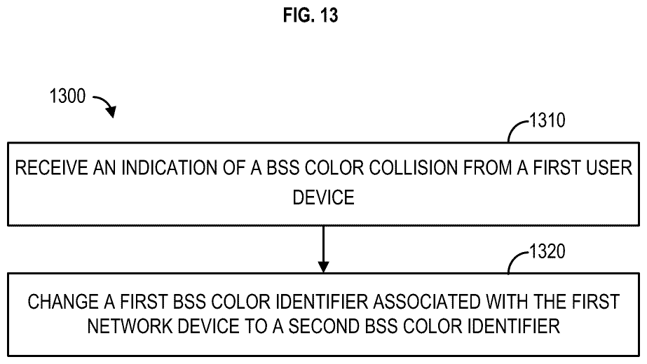

FIG. 13 shows an example method 1300 for determining actions to take during a BSS color collision. The method 1300 may be completed by any of the computing devices of FIGS. 1, 3, and 5. For example, the method 1300 may be completed by one or more network devices, such as the access points 304A-B or the network management device 134, 334. For example, each of the first network device 304B and the second network device 304A may determine each network device's initial BSS color identifier in the manner described in FIG. 4 above.

At 1310, an indication of a BSS color collision may be received from a first user device. For example, the indication may be sent by the first user device 332A and may be received by a first network device (e.g., the access point 304B or network management device 134). For example, the first network device 304B may provide the first wireless network coverage area 302B and the first user device 332A may be within the first wireless network coverage area 302B. For example, the first network device 304B may be communicating with the first user device 332A on a first wireless channel and the second network device 304A may be communicating with the second network device 318A on the first wireless channel. For example, the first user device 332A may receive or detect communication from another user device (e.g., a second user device 318A). The communication may or may not have been intended for the first user device 332A. For example, the second user device 318A may be communicating with a second network device (e.g., the access point 304A) and be within a second wireless network coverage area 302A. However, the first user device 332A and the second user device 318A may be in an overlapping region (e.g., overlapping region 336) with one another, such that each user device 318A, 332A may receive or detect communications from the other user device 318A, 332A. Based on receiving or detecting the communication from the second user device 318A, the first user device 332A may determine the second BSS color identifier within that communication and associated with the second network device 304A and/or the second network 302A. The first user device 332A may know the first BSS color identifier associated with the first network device 304B and/or the first network 302B.

The first user device 332A may determine the first BSS color identifier and the second BSS color identifier are the same BSS color identifier. Based on the first BSS color identifier and the second BSS color identifier being the same, the first user device 332A may determine that a color collision is occurring. The first user device 332A may send the indication of the BSS color collision to the first network device 304B and/or the network management device 134. For example, the indication sent by the first user device 332A to the first network device 304B and/or the network management device 134 may comprise a message indicating the BSS color collision. For example, the message may be or comprise an autonomous report that is sent by the first user device 332A to the first network device 304B and/or the network management device 134 indicating the BSS color collision. For example, the autonomous report may comprise BSS color identifiers for one or more (e.g., all) other network devices and/or networks (e.g., the second network device 304A) from which the first user device 332A is able to detect frames in order to assist or help the first network device 304B or the network management device 134 to determine a new BSS color identifier when the first network device 304B or the network management device 134 determines it needs to change its BSS color identifier for the first network device 304B based on the indicated BSS color collision. For example, the autonomous report may comprise an Event Report frame containing one or more event report elements. The event report element may comprise an event token field value set to zero, indicating the report as an autonomous report. The event report element may comprise an event type field value set to 4, indicating a BSS color collision. The Event Report frame may further comprise an Event Report field that includes information identifying the BSS color identifiers used by the other network devices and/or networks (e.g., the second network device 304A) that the first user device 332A is able to detect, for example through communication with the second user device 318A. The autonomous report or another message sent by the first user device 332A to the first network device 304B and/or the network management device 134 may include one or more of an identifier of the second user device 318A (e.g., a MAC address), an identifier of the second network device 304A (e.g., a MAC address), an identifier of the second network 302A (e.g., a service set identifier (SSID)), an indicator of the first BSS color identifier, an indicator of the second BSS color identifier, and/or one or more current network parameters associated with the first user device 332A (e.g., a current signal strength (e.g., RSSI) of communication between the first user device 332A and the first network device 304B, a current signal-to-noise ratio (SNR) for the communication between the first user device 332A and the first network device 304B, and/or one or more forms of current channel state information, such as the current amplitude attenuation for the first user device 332A.

The first network device 304B and/or the network management device 134 may determine if the first network device 304B needs to change the first BSS color identifier associated with the first network device 304B and/or the first network 302B. For example, this determination may be based on the indication of the color collision from the first user device 332A and/or the determination that the first BSS color identifier is the same as the second BSS color identifier.

At 1320, the first BSS color identifier associated with the first network device 304B may be changed to a third BSS color identifier. For example, the BSS color identifier may be changed by the first network device 304B. For example, the network management device 134 may cause the first network device 304B to change its BSS color identifier. For example, the BSS color identifier may be changed based on an instruction received from the network management device 134. For example, the third BSS color identifier may be different from the first BSS color identifier and the second BSS color identifier. For example, the first BSS color identifier may be changed based on the determination of the BSS color collision by the first user device 332A and/or receipt of the indication of the BSS color collision from the first user device 332A. Based on the change from the first BSS color identifier to the third BSS color identifier, the first network device 304B may send an indication of the third BSS color identifier associated with the first network device 304B to the first user device 332A and any other user devices communicating with the first network device 304B.

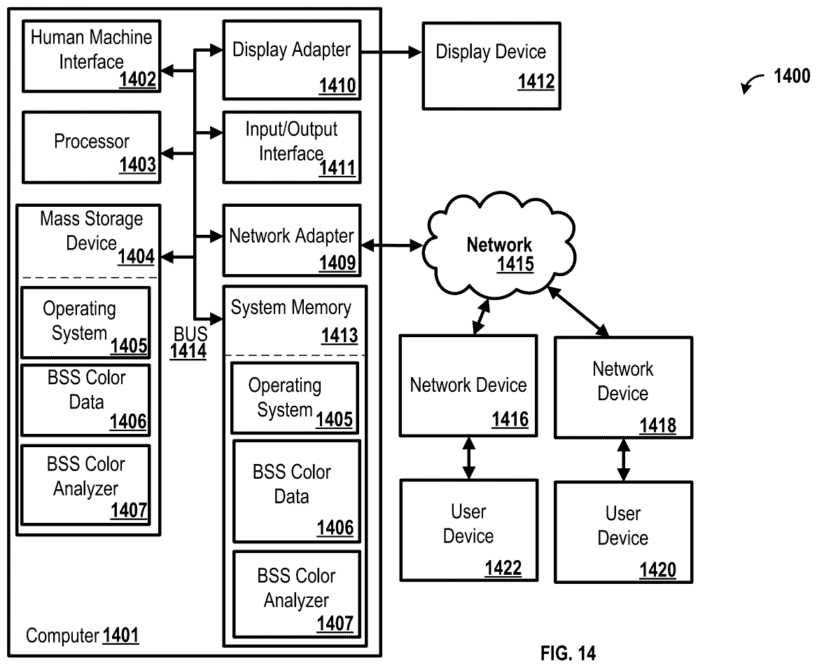

FIG. 14 shows a system 1400 comprising a computer 1401 for implementing identification of BSS color collisions and determining how to response to color collisions. Any computing device/component described herein may be the computer 1401 as shown in FIG. 14, including the network devices 104A-B, 304A-B, the user devices 118A, 132A-B, 318A, 332A, and the network management device 134, 334.

The computer 1401 may include one or more processors 1403, a system memory 1413, and a bus 1414 that couples various components of the computer 1401 including the one or more processors 1403 to the system memory 1413. In the case of multiple processors 1403, the computer 1401 may utilize parallel computing.

The bus 1414 may include one or more of several possible types of bus structures, such as a memory bus, memory controller, a peripheral bus, an accelerated graphics port, and a processor or local bus using any of a variety of bus architectures.

The computer 1401 may operate on and/or include a variety of computer readable media (e.g., non-transitory). Computer readable media may be any available media that is accessible by the computer 1401 and includes, non-transitory, volatile and/or non-volatile media, removable and non-removable media. The system memory 1413 has computer readable media in the form of volatile memory, such as random access memory (RAM), and/or non-volatile memory, such as read-only memory (ROM). The system memory 1413 may store data such as BSS color data 1406 and/or program modules such as an operating system 1405 and color collision analyzer 1407 that are accessible to and/or are operated on by the one or more processors 1403.

The computer 1401 may also include other removable/non-removable, volatile/non-volatile computer storage media. The mass storage device 1404 may provide non-volatile storage of computer code, computer readable instructions, data structures, program modules, and other data for the computer 1401. The mass storage device 1404 may be a hard disk, a removable magnetic disk, a removable optical disk, magnetic cassettes or other magnetic storage devices, flash memory cards, CD-ROM, digital versatile disks (DVD) or other optical storage, random access memories (RAM), read-only memories (ROM), electrically erasable programmable read-only memory (EEPROM), and the like.

Any number of program modules may be stored on the mass storage device 1404. An operating system 1405 and BSS color analyzer 1407 may be stored on the mass storage device 1404. One or more of the operating system 1405 and color collision analyzer 1407 (or some combination thereof) may include program modules. BSS color data 1406 may also be stored on the mass storage device 1404. The BSS color data 1406 may be stored in any of one or more databases known in the art. The databases may be centralized or distributed across multiple locations within the network 1415.

A user may enter commands and information into the computer 1401 via an input device (not shown). Such input devices comprise, but are not limited to, a keyboard, pointing device (e.g., a computer mouse, remote control), a microphone, a joystick, a scanner, tactile input devices such as gloves, and other body coverings, motion sensor, and the like These and other input devices may be connected to the one or more processors 1403 via a human machine interface 1402 that is coupled to the bus 1414, but may be connected by other interface and bus structures, such as a parallel port, game port, an IEEE 1394 Port (also known as a Firewire port), a serial port, network adapter 1409, and/or a universal serial bus (USB).

A display device 1412 may also be connected to the bus 1414 via an interface, such as a display adapter 1410. It is contemplated that the computer 1401 may have more than one display adapter 1410 and the computer 1401 may have more than one display device 1412. A display device 1412 may be a monitor, an LCD (Liquid Crystal Display), light-emitting diode (LED) display, television, smart lens, smart glass, and/or a projector. In addition to the display device 1412, other output peripheral devices may comprise components such as speakers (not shown) and a printer (not shown) which may be connected to the computer 1401 via Input/Output Interface 1411. Any step and/or result of the methods may be output (or caused to be output) in any form to an output device. Such output may be any form of visual representation, including, but not limited to, textual, graphical, animation, audio, tactile, and the like. The display device 1412 and computer 1401 may be part of one device, or separate devices.

The computer 1401 may operate in a networked environment using logical connections to one or more remote computing devices, such as network devices 1416 and 1418 and user devices 1420 and 1422. Each of the network devices 1416 and 1418 may be a server, a router, a gateway, an access point, a network computer, a cache device, a peer device, an edge device, other common network node, and so on. The user devices 1420, 1422 may be a personal computer, computing station (e.g., workstation), portable computer (e.g., laptop, mobile phone, tablet device), smart device (e.g., smartphone, smartwatch, activity tracker, smart apparel, smart accessory), security and/or monitoring device, and so on. Logical connections between the computer 1401 and the network devices 1416, 1418 and/or user devices 1420, 1422 may be made via a network 1415, such as a local area network (LAN) and/or a general wide area network (WAN). Such network connections may be through a network adapter 1409. A network adapter 1409 may be implemented in both wired and wireless environments. Such networking environments are conventional and commonplace in dwellings, offices, enterprise-wide computer networks, intranets, and the Internet.

Application programs and other executable program components such as the operating system 1405 are shown herein as discrete blocks, although it is recognized that such programs and components may reside at various times in different storage components of the computing device 1401, and are executed by the one or more processors 1403 of the computer 1401. An implementation of BSS color analyzer 1407 may be stored on or sent across some form of computer readable media. Any of the disclosed methods may be performed by processor-executable instructions embodied on computer readable media.

The methods and systems can employ artificial intelligence techniques, such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with specific examples, it is not intended that the scope be limited to the particular examples set forth, as the examples herein are intended in all respects to be illustrative rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of examples described in the specification.

It will be apparent to those skilled in the art that various modifications and variations can be made without departing from the scope or spirit. Other examples will be apparent to those skilled in the art from consideration of the specification and practice described herein. It is intended that the specification and examples be considered as exemplary only, with a true scope and spirit being indicated by the following claims.

What is claimed is:

1. A method comprising:
receiving, by a first network device, an indication of a Basic Service Set (BSS) color collision from a first user device;
receiving, by a second network device, an indication of the BSS color collision from a second user device;
determining, based on one or more network parameters associated with the first user device, the first user device moved prior to the indication of the BSS color collision from the first user device;
determining, based on one or more network parameters associated with the second user device, the second user device did not move prior to the indication of the BSS color collision from the second user device; and
changing, based on the first user device having moved prior to the indication of the BSS color collision from the first user device, a BSS color identifier associated with the first network device to a second BSS color identifier.

2. The method of claim 1, further comprising maintaining, based on the second user device not having moved prior to the indication of the BSS color collision, a first BSS color identifier associated with the second network device.

3. The method of claim 1, further comprising determining, based on a communication between the first network device and the first user device, the one or more network parameters.

4. The method of claim 1, wherein the one or more network parameters comprise a current value for a first network parameter and wherein determining that the first user device moved prior to the indication of the BSS color collision from the first user device comprises:
determining a prior value for the first network parameter for the first user device; and
determining, based on a difference between the current value and the prior value satisfying a threshold, the first user device moved prior to the indication of the BSS color collision from the first user device.

5. The method of claim 1, wherein the one or more network parameters comprise one or more of a signal strength, a signal-to-noise ratio, or channel state information.

6. The method of claim 1, wherein the one or more network parameters associated with the first user device comprise a current signal-to-noise ratio associated with the first user device and a current signal strength associated with the first user device and wherein determining the first user device moved prior to the indication of the BSS color collision from the first user device comprises:
determining a prior signal-to-noise ratio and a prior signal strength associated with the first user device; and
determining, based on a difference between the current signal-to-noise ratio and the prior signal-to-noise ratio satisfying a first threshold and a difference between the current signal strength and the prior signal strength satisfying a second threshold, the first user device moved prior to the indication of the BSS color collision from the first user device.

7. The method of claim 1, wherein the one or more network parameters associated with the second user device comprise a current signal-to-noise ratio associated with the second user device and a current signal strength associated with the second user device and wherein determining the second user device did not move prior to the indication of the BSS color collision comprises:
determining a prior signal-to-noise ratio and a prior signal strength associated with the second user device; and
determining, based on at least one of a difference between the current signal-to-noise ratio and the prior signal-to-noise ratio not satisfying a first threshold and the difference between the current signal strength and the prior signal strength not satisfying a second threshold, the second user device did not move prior to the indication of the BSS color collision.

8. A method comprising:
receiving, by a first network device, an indication of a Basic Service Set (BSS) color collision from a first user device;
receiving, by a second network device, an indication of the BSS color collision from a second user device;
determining, based on one or more network parameters associated with the first user device, the first user device did not move prior to the indication of the BSS color collision from the first user device;
determining, based on one or more network parameters associated with the second user device, the second user device moved prior to the indication of the BSS color collision from the second user device; and
maintaining, based on the first user device not moving prior to the indication of the BSS color collision from the first user device, a BSS color identifier associated with the first network device.

9. The method of claim 8, further comprising changing, based on the second user device moving prior to the indication of the BSS color collision from the second user device, a first BSS color identifier associated with the second network device to a second BSS color identifier associated with the second network device.

10. The method of claim 8, further comprising determining, based on a communication between the first network device and the first user device, the one or more network parameters.

11. The method of claim 8, wherein the one or more network parameters comprise a current value for a first network parameter and wherein determining that the first user device did not move prior to the indication of the BSS color collision from the first user device comprises:
determining a prior value for the first network parameter associated with the first network device; and
determining, based on a difference between the current value and the prior value not satisfying a threshold, the first user device did not move prior to the indication of the BSS color collision from the first user device.

12. The method of claim 8, wherein the indication of the BSS color collision from the first user device comprises the BSS color identifier associated with the first network device and a BSS color identifier associated with the second network device.

13. The method of claim 8, wherein the one or more network parameters associated with the first user device comprise a current signal-to-noise ratio associated with the first user device and a current signal strength associated with the first user device and wherein determining the first user device did not move prior to the indication of the BSS color collision from the first user device comprises:
determining a prior signal-to-noise ratio and a prior signal strength associated with the first user device; and
determining, based on at least one of a difference between the current signal-to-noise ratio and the prior signal-to-noise ratio not satisfying a first threshold or a difference between the current signal strength and the prior signal strength not satisfying a second threshold, the first user device did not move prior to the indication of the BSS color collision from the first user device.

14. The method of claim 8, wherein the one or more network parameters associated with the second user device comprise a current signal-to-noise ratio associated with the second user device and a current signal strength associated with the second user device and wherein determining the second user device moved prior to the indication of the BSS color collision from the second user device comprises:
determining a prior signal-to-noise ratio and a prior signal strength associated with the second user device; and
determining, based on a difference between the current signal-to-noise ratio and the prior signal-to-noise ratio satisfying a first threshold and the difference between the current signal strength and the prior signal strength satisfying a second threshold, the second user device moved prior to the indication of the BSS color collision from the second user device.

15. A method comprising:
receiving, by a first network device, an indication of a Basic Service Set (BSS) color collision from a first user device;
receiving, by a second network device, an indication of the BSS color collision from a second user device;
determining a change in signal strength associated with the first user device satisfies a first threshold;
determining a change in signal-to-noise ratio associated with the first user device satisfies a second threshold; and
changing, based on the change in signal strength satisfying the first threshold and the change in signal-to-noise ratio satisfying the second threshold, a BSS color identifier associated with the first network device to a second BSS color identifier.

16. The method of claim 15, further comprising:
determining one or more of a change in signal strength associated with the second user device does not satisfy the first threshold or a change in signal-to-noise ratio associated with the second user device does not satisfy the second threshold; and
maintaining, based on the one or more of the change in signal strength associated with the second user device not satisfying the first threshold or the change in signal-to-noise ratio associated with the second user device not satisfying the second threshold, a first BSS color identifier associated with the second network device.

17. The method of claim 15, further comprising:
determining, based on a communication between the first network device and the first user device, a current signal strength associated with the first user device; and
accessing a prior signal strength associated with the first user device, wherein the change in signal strength is based on a difference between the current signal strength and the prior signal strength.

18. The method of claim 17, wherein the communication occurs at or after the indication of the BSS color collision from the first user device and the prior signal strength is associated with another communication occurring before the indication of the BSS color collision from the first user device.

19. The method of claim 15, further comprising:
determining, based on a communication between the first network device and the first user device, a current signal-to-noise ratio associated with the first user device; and
accessing a prior signal-to-noise ratio associated with the first user device, wherein the change in signal-to-noise ratio is based on a difference between the current signal-to-noise ratio and the prior signal-to-noise ratio.

20. The method of claim 19, wherein the communication occurs at or after the indication of the BSS color collision from the first user device and the prior signal-to-noise ratio is associated with another communication between the first network device and the first user device occurring before the indication of the BSS color collision from the first user device.

21. The method of claim 15, further comprising determining, based on the change in signal strength satisfying the first threshold and the change in signal-to-noise ratio satisfying the second threshold, the first user device moved prior to the indication of the BSS color collision from the first user device.
